(19) United States
(12) Patent Application Publication
(10) Pub. No.: US 2026/0266553 A1
(43) Pub. Date: Sep. 10, 2026

(54) SYSTEMS AND METHODS FOR HEAT RECOVERY

(71) Applicant: Mantel Capture, Inc., Cambridge, MA (US)

(72) Inventors: Cameron Halliday, Boston, MA (US); Sean Robertson, Cambridge, MA (US)

(21) Appl. No.: 19/457,769

(22) Filed: Jan. 23, 2026

Related U.S. Application Data
(63) Continuation of application No. PCT/US2024/039436, filed on Jul. 24, 2024.
(60) Provisional application No. 63/515,561, filed on Jul. 25, 2023.
(60) Provisional application No. 63/652,899, filed on May 29, 2024.

(51) Int. Cl. F28D 15/00; F28F 23/00

(52) U.S. Cl. CPC F28D 15/00; F28F 23/00

(57) ABSTRACT

Provided herein are systems and methods for using intermediate heat transfer fluids to recover heat from molten borates.

### CROSS-REFERENCE TO RELATED APPLICATIONS

This application is a continuation application of International Patent Application No. PCT/US2024/039436, filed Jul. 24, 2024, which claims the benefit of U.S. Provisional Application No. 63/652,899, filed May 29, 2024, and U.S. Provisional Application No. 63/515,561, filed Jul. 25, 2023, each of which is entirely incorporated herein by reference.

### BACKGROUND

Heat recovery from industrial processes is critical to their economic viability. Often heat may be directly transferred from a hot fluid to a cold fluid. When this is not possible an intermediate fluid may be used to transfer heat from the hot fluid to the cold fluid.

### SUMMARY

Industrial processes often utilize molten salts to capture and manage carbon dioxide emissions, aiming to reduce the carbon footprint and optimize efficiency. This strategy leverages internally-generated heat to regenerate the molten salts and liberate captured carbon dioxide. However, significant challenges arise with the use of traditional methods. For instance, some methods involve the use of high volumes of thermal energy carriers or gases, leading to difficulties in system handling and the potential need for redesigning system components. Other approaches involve the combustion of fuels in an oxygen-rich environment to achieve the necessary temperatures, a process that may often be both energy and cost-inefficient. Furthermore, electrolysis-based methods often require prohibitive amounts of electrical energy. Recognized herein is a clear need for more effective alternatives to address these challenges.

Provided herein are systems, methods, and techniques that utilize an intermediate heat transfer fluid, such as, for example, CO2, steam, or flue gas, in the heat transfer system, thereby minimizing external energy or heat input, reducing costs, and lessening detrimental effects on the climate and environment. Moreover, the proposed systems, methods, and techniques comprise heat transfer units comprising conduits that allow for the efficient management of these streams.

In one aspect, disclosed herein is a heat transfer system, comprising: a heat transfer unit; a first conduit configured to direct a first stream at a first temperature to the heat transfer unit, wherein the first stream comprises a molten salt; a second conduit configured to direct a second stream at a second temperature to the heat transfer unit; and a third conduit configured to receive an intermediate heat transfer fluid, wherein the intermediate heat transfer fluid is configured to: (i) receive a first heat from the first stream and direct at least a portion of the first heat to the second stream, or (ii) receive a second heat from the second stream and direct at least a portion of the second heat to the first stream, and wherein the intermediate heat transfer fluid comprises carbon dioxide (CO₂), steam, or a flue gas, or a combination thereof.

In some embodiments, the second temperature is less than the first temperature. In some embodiments, the intermediate heat transfer fluid comprises a thermal conductivity of 10 mW/m·K to 1,000 mW/m·K. In some embodiments, the intermediate heat transfer fluid comprises a heat transfer coefficient of 1 W/m²·K to 100,000 W/m²·K. In some embodiments, the intermediate heat transfer fluid comprises a specific heat capacity of 0.2 kJ/kg·K to 5.0 kJ/kg·K. In some embodiments, the intermediate heat transfer fluid comprises a density of 0.1 kg/m³ to 2000 kg/m³. In some embodiments, the intermediate heat transfer fluid comprises a viscosity of 0.01 cP to 0.1 cP. In some embodiments, the intermediate heat transfer fluid comprises a supercritical CO₂. In some embodiments, the molten salt comprises athermal conductivity of 100 mW/m·K to 2,000 mW/m·K.

In some embodiments, the molten salt comprises a heat transfer coefficient of 1 W/m²·K to 100,000 W/m²·K. In some embodiments, the molten salt comprises a specific heat capacity of 0.5 kJ/kg·K to 5 kJ/kg·K. In some embodiments, the molten salt comprises a density of 500 kg/m3 to 5000 kg/m³. In some embodiments, the molten salt comprises a viscosity of 1 cP to 100 cP. In some embodiments, the molten salt comprises a velocity of 0.01 m/s to 2 m/s. In some embodiments, the molten salt comprises molten borate. In some embodiments, the first temperature is between about 300° C. to about 1,000° C. In some embodiments, the second temperature is between about 100° C. to about 600° C. In some embodiments, the first stream transfers the first heat to the intermediate heat transfer fluid at a first heat transfer zone of the heat transfer unit, wherein in the first heat transfer zone, the first conduit and the third conduit are in thermal contact. In some embodiments, prior to entering the first heat transfer zone, the intermediate heat transfer fluid is at a fifth temperature. In some embodiments, the fifth temperature is between about 100° C. to about 600° C. In some embodiments, after exiting the first heat transfer zone, the intermediate heat transfer fluid is at a sixth temperature, wherein the sixth temperature is greater than the fifth temperature. In some embodiments, the sixth temperature is between about 100° C. to about 600° C. In some embodiments, after exiting the first heat transfer zone, the first stream is at a third temperature, wherein the third temperature is less than the first temperature. In some embodiments, the third temperature is between about 100° C. to about 1000° C. In some embodiments, the second stream at the second temperature comprises saturated water. In some embodiments, the intermediate heat transfer fluid transfers the first heat to the second stream at a second heat transfer zone of the heat transfer unit, wherein in the second heat transfer zone, the second conduit and the third conduit are in thermal contact. In some embodiments, prior to entering the second heat transfer zone, the intermediate heat transfer fluid is at a seventh temperature. In some embodiments, the seventh temperature is between about 100° C. to about 600° C. In some embodiments, after exiting the second heat transfer zone, the intermediate heat transfer fluid is at an eighth temperature, wherein the eighth temperature is less than the seventh temperature. In some embodiments, after exiting the second heat transfer zone, the second stream is at a fourth temperature, wherein the fourth temperature is greater than the second temperature. In some embodiments, the second stream at the fourth temperature comprises saturated steam. In some embodiments, the fourth temperature is between about 100° C. to about 600° C. In some embodiments, the eighth temperature is between about 100° C. to about 600° C.

In some embodiments, the first stream travels in a first direction. In some embodiments, the second stream travels in a second direction. In some embodiments, the second direction is a direction opposite the first direction. In some embodiments, the intermediate heat transfer fluid travels around the third conduit in a clockwise or counterclockwise direction.

In some embodiments, the second direction is a same direction as the first direction. In some embodiments, the intermediate heat transfer fluid travels around the third conduit in a clockwise direction. In some embodiments, the third conduit alternates between a proximal position to the first conduit and a proximal position to the second conduit. In some embodiments, the third conduit alternation between a proximal position to the first conduit and a proximal position to the second conduit optimizes a temperature difference between the intermediate heat transfer fluid and the second stream. In some embodiments, the temperature difference between the intermediate heat transfer fluid and the second stream comprises 0° C. to 500° C.

In some embodiments, the intermediate heat transfer fluid at the fifth temperature comprises saturated steam. In some embodiments, the intermediate heat transfer fluid at the sixth temperature comprises superheated steam. In some embodiments, the third conduit is in fluidic communication with the second conduit. In some embodiments, the second conduit and the third conduit are in fluidic communication via one or more connection points. In some embodiments, the second heat transfer zone comprises the one or more connection points. In some embodiments, the second stream and the intermediate heat transfer fluid mix at the one or more connection points to create a second stream-intermediate heat transfer fluid mixture. In some embodiments, the third conduit comprises the second stream-intermediate heat transfer fluid mixture. In some embodiments, the second stream comprises saturated water. In some embodiments, the intermediate heat transfer fluid comprises steam. In some embodiments, the intermediate heat transfer fluid comprises saturated steam. In some embodiments, the intermediate heat transfer fluid comprises superheated steam.

In some embodiments, the second stream-intermediate heat transfer fluid mixture comprises a saturated steam-saturated water mixture. In some embodiments, the saturated water is injected into the superheated steam to de-superheat the steam. In some embodiments, the system further comprises directing the second stream-intermediate heat transfer fluid mixture to a unit separate from the heat transfer unit. In some embodiments, the system further comprises the unit separate from the heat transfer unit. In some embodiments, the heat transfer unit is configured to export, or exhaust the first stream, the second stream, the third stream, or a combination thereof.

In some embodiments, the first stream and the second stream mix. In some embodiments, the mixing the first stream and the second stream occurs after a recovery of heat from the intermediate heat transfer fluid. In some embodiments, a heat transfer coefficient on the second stream (e.g., coolant) is reduced by 5% to 99.9% when compared to direct heat transfer. In some embodiments, a pressure drop through the heat transfer unit comprises less than 25 bar. In some embodiments, the steam comprises a sweep gas to drive desorption. In some embodiments, the second stream and the first stream do not make physical contact.

In some embodiments, the system further comprises an introduction of additives to the first stream configured to alter a thermal property. In some embodiments, the additive comprises a nanoparticle. In some embodiments, the intermediate heat transfer fluid comprises a pressure of between about 0.1 bar absolute to about 400 bar absolute. In some embodiments, the molten salt comprises formula AₓB₁₋ₓO_{1.5-x}. In some embodiments, x is between 0 and 1. In some embodiments, a comprises an alkali metal. In some embodiments, the molten salt comprises formula (A¹_{y}A²_{1-y})ₓB₁₋ₓO_{1.5-x}. In some embodiments, the molten salt comprises a formula A₃BO₃. In some embodiments, the molten salt comprises formula A₅BO₄. In some embodiments, the molten salt comprises an impurity/contaminant.

In another aspect, disclosed herein are heat transfer units, the heat transfer units comprising a first conduit configured for directing a first stream at a first temperature, wherein the first stream comprises a molten salt; a second conduit configured for directing a second stream at a second temperature, wherein the second temperature is less than the first temperature; and a recycle conduit fluidically connected to the first conduit, wherein the recycle conduit is configured to divert at least a portion of the first stream from the first conduit. The heat transfer unit of any of the preceding claims, wherein the first conduit is configured to raise a mass flow through the heat transfer unit by up to about 1000× compared to a flow of the first stream coming into the heat transfer unit. In some embodiments, the first stream in the first conduit is configured to raise a heat transfer coefficient relative to the second stream in the second conduit. In some embodiments, the first stream velocity increases as it travels toward a first heat transfer zone exit first without altering a duty.

In another aspect, disclosed herein are method comprising directing (i) a first stream at a first temperature through a first conduit and (ii) a second stream at a second temperature through a second conduit, wherein the first stream comprises a molten salt, and wherein the second temperature is less than the first temperature; transferring heat from (i) the first stream to the second stream, or (ii) the second stream to the first stream using an intermediate heat transfer fluid in thermal communication with the first stream and the second stream, wherein the intermediate heat transfer fluid comprises carbon dioxide (CO₂), steam, or a flue gas, or a combination thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the systems and methods described herein are set forth with particularity in the appended claims. A better understanding of the features and advantages of the systems and methods described herein will be obtained by reference to the following detailed description that sets forth illustrative embodiments and the accompanying drawings (also “Figure” and “FIG.” herein) of which:

FIG. 1 shows a single stage closed loop configuration for the use of an intermediate heat transfer fluid (e.g., such as fluid 3) to transfer heat from molten borate salts (e.g., such as fluid 1) to a cold fluid (e.g., such as fluid 2), in accordance with some embodiments. T Q symbolizes heat flow in the direction of hot to cold.

FIG. 2 shows a multistage closed loop configuration for the use of an intermediate heat transfer fluid (e.g., such as fluid 3) to transfer heat from molten borate salts (e.g., such as fluid 1) to a cold fluid (e.g., such as fluid 2), in accordance with some embodiments. T Q symbolizes heat flow in the direction of hot to cold.

FIG. 3 shows a first single stage once through configuration for the use of an intermediate heat transfer fluid (e.g., such as fluid 3) to transfer heat from molten borate salts (e.g., such as fluid 1) to a cold fluid (e.g., such as fluid 2), in accordance with some embodiments. T Q symbolizes heat flow in the direction of hot to cold.

FIG. 4 shows a second single stage once through configuration for the use of an intermediate heat transfer fluid (e.g., such as fluid 3) to transfer heat from molten borate salts (e.g., such as fluid 1) to a cold fluid (e.g., such as fluid 2), in accordance with some embodiments. T Q symbolizes heat flow in the direction of hot to cold.

FIG. 5 shows a multistage once through configuration for the use of an intermediate heat transfer fluid (e.g., such as fluid 3) to transfer heat from molten borate salts (e.g., such as fluid 1) to a cold fluid (e.g., such as fluid 2), in accordance with some embodiments. T Q symbolizes heat flow in the direction of hot to cold.

FIG. 6 shows a first single stage once through configuration whereby Fluid 3 and Fluid 2 are mixed following recovery of the heat from the molten borate salts (Fluid 1), in accordance with some embodiments.

FIG. 7 show a second single stage once through configuration whereby Fluid 3 and Fluid 2 are mixed following recovery of the heat from the molten borate salts (Fluid 1), in accordance with some embodiments. T Q symbolizes heat flow in the direction of hot to cold.

FIG. 8 shows a multistage once through configuration whereby Fluid 3 and Fluid 2 are mixed following recovery of the heat from the molten borate salts (Fluid 1), in accordance with some embodiments. T Q symbolizes heat flow in the direction of hot to cold.

FIG. 9 show a bypass line configuration where the Fluid 1 velocity through the primary heat exchanger has been increased without altering the duty, in accordance with some embodiments. 1′ Q symbolizes heat flow in the direction of hot to cold.

FIG. 10 shows a computer system that is programmed or otherwise configured to implement methods provided herein.

### DETAILED DESCRIPTION

While various embodiments of the systems and methods described herein have been shown and described herein, it will be obvious to those skilled in the art that such embodiments are provided by way of example only. Numerous variations, changes, and substitutions may occur to those skilled in the art without departing from the systems and methods described herein. It may be understood that various alternatives to the embodiments described herein may be utilized. Unless the context requires otherwise, throughout the specification and claims which follow, the word “comprise” and variations thereof, such as, “comprises” and “comprising” are to be construed in an open, inclusive sense, that is, as “including, but not limited to.”

Whenever the term “at least,” “greater than” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “about” as used herein referring to a number or a numerical range means that the number or numerical range referred to is an approximation within experimental variability (or within statistical experimental error). The number or numerical range may vary between 1% and 15% of the stated number or numerical range.

As used in this specification and the appended claims, the singular forms “a,” “an,” and “the” such as plural referents unless the content clearly dictates otherwise. It may also be noted that the term “or” is generally utilized in its sense including “and/or” unless the content clearly dictates otherwise.

As used herein, the term “high purity” generally refers to a composition with low levels of impurities. In some cases, high purity refers to a mixture with a concentration of a component of about 80% to about 99.99%. In some cases, high purity refers to a mixture with a concentration of a component of about 80% to about 85%, about 80% to about 90%, about 80% to about 95%, about 80% to about 97%, about 80% to about 99%, about 80% to about 99.9%, about 80% to about 99.99%, about 85% to about 90%, about 85% to about 95%, about 85% to about 97%, about 85% to about 99%, about 85% to about 99.9%, about 85% to about 99.99%, about 90% to about 95%, about 90% to about 97%, about 90% to about 99%, about 90% to about 99.9%, about 90% to about 99.99%, about 95% to about 97%, about 95% to about 99%, about 95% to about 99.9%, about 95% to about 99.99%, about 97% to about 99%, about 97% to about 99.9%, about 97% to about 99.99%, about 99% to about 99.9%, about 99% to about 99.99%, or about 99.9% to about 99.99%. In some cases, high purity refers to a mixture with a concentration of a component of about 80%, about 85%, about 90%, about 95%, about 97%, about 99%, about 99.9%, or about 99.99%. In some cases, high purity refers to a mixture with a concentration of a component of at least about 80%, about 85%, about 90%, about 95%, about 97%, about 99%, or about 99.9%, or more.

The term “in proximity to,” as used herein, generally refers to a distance of at most 20 meters between a A and B. For example, if it is stated that the absorber is positioned in proximity to the boiler, it is understood to mean that a boundary of the absorber is at a distance of at most 20 meters from a boundary of the boiler. In some embodiments, the distance may be at most 20 meters (m), 15 m, 10 m, 9 m, 8 m, 7 m, 6 m, 5 m, 4 m, 3 m, 2 m, 1 m, or less.

The term “industrial process,” as used herein, generally refers to a process that extracts, transports, or processes raw materials to manufacture end products using physical, mechanical and/or chemical processes. An industrial process may generate electricity, steam, water, heat, cement, steel, hydrogen, pulp, paper, carbon dioxide, or a combination thereof. In some examples, an industrial process may refer to any process which generates a product of value. In some embodiments, the industrial process may generate carbon dioxide as a by-product (e.g., by-product of combustion). In some embodiments, the industrial process may generate heat (e.g., thermal energy). Examples of industrial processes such as coal fired power plants, oil fired power plants, gas fired power plants, or any other fossil-fuel fired power plants. A fossil fuel may comprise coal, petroleum, natural gas, oil shales, bitumens, tar sands, and heavy oils.

The term “high temperature system” as used herein generally refers to an entire system or a portion of a system where high temperatures (e.g., exceeding 300° C.) may be reached. An industrial process may comprise one or more high temperature systems. The capture and release of carbon dioxide using molten salts, as described herein, may occur within or in proximity to a high temperature system (e.g., a portion of a system reaching temperatures of at least 300° C.). A high temperature system may comprise a boiler.

The term “carbon capture system” as used herein generally refers to a system comprising at least an absorber or at least a desorber to capture and release carbon dioxide. A carbon capture system may be a closed-loop system for streams comprising molten salt to move within (e.g., from the absorber to the desorber and back to the absorber). A carbon capture system may be separate from the high temperature system or the system where an industrial process is occurring. A carbon capture system may be integrated directly into a high temperature system (e.g., boiler). A carbon capture system may be positioned near to (e.g., adjacent to) a high temperature system. A carbon capture system may be retroactively fitted (retrofitted) into a pre-existing high temperature system.

### Systems and Methods for Heat Recovery

Provided herein are systems and methods for using intermediate heat transfer fluids to recover heat from molten borates.

The systems, methods, and techniques disclosed herein offer improvements over conventional systems and methods by providing in certain embodiments heat recovery from molten salts. In some cases, an intermediate fluid (IHTF) is provided. In some instances, IHTF may effectively recover heat from molten salts. For example, the IHTF may be configured to minimize the freezing risk associated with high melting point molten salts. In some instances, by using an intermediate heat transfer fluid (e.g., such as fluid 3), the temperature of the coolant may be raised when compared to direct heat transfer (e.g., fluid 1 to fluid 2). In some instances, by using an intermediate heat transfer fluid (e.g., such as fluid 3) the heat transfer coefficient on the coolant side may be reduced when compared to direct heat transfer (e.g., fluid 1 to fluid 2). In further examples, by using an intermediate heat transfer fluid (e.g., such as fluid 3), the temperature of the wall facing the molten salt may be effectively increased. For example, this may reduce the extent of salt freezing.

In some embodiments, mitigating freezing may also be achieved by raising the heat transfer coefficient of the molten borates relative to the coolant. In some instances, adjustment to the heat transfer coefficient may be achieved either through additives that alter the thermal physical properties of the salt (e.g., nanoparticles), changes in the heat exchanger geometry, or by increasing the velocity of the molten borates irrespective of geometry. In some instances, geometry independent changes in fluid velocity are correlated with higher amounts of heat transfer. For example, geometry independent changes in fluid velocity are correlated with corresponding changes in the coolant side conditions.

In some cases, the temperature difference between the molten salt and the intermediate fluid is smaller (e.g., lower driving force for heat transfer) compared to the salt and the ultimate heat sink. In some instances, an absence of freezing may reduce heat transfer resistance while also lowering the pressure drop through a heat exchanger. For example, the coupled effect of reduced heat transfer resistance and pressure drop may reduce heat exchanger and pump size. In further examples, the coupled effect of reduced heat transfer resistance and pressure drop may reduce system cost.

In some embodiments, a plurality of intermediate heat transfer fluids (IHTF) are provided for the purpose of molten salt heat recovery. In some cases, the IHTF may comprise carbon dioxide, steam, flue gas, or a combination thereof. In some cases, the intermediate fluid is configured for compatibility between the fluid and molten salt in the event of a leak or breach. In some cases, the molten salt comprises a molten borate. In some instances, the molten borate is exposure to both flue gas and CO₂. For example, the molten borate may already be exposed to both flue gas and CO₂ occur within a carbon capture process. In further examples, substantially no risk of contamination or compatibility exists.

In some cases, the choice of the IHTF's state may significantly influence the efficiency and performance of the heat transfer process, depending on the system's specific requirements. In some instances, by choosing the optimal state of the IHTF, the performance and efficiency of the heat transfer process is enhanced, offering a flexible solution for a broad array of applications. In some embodiments, the different states of IHTFs optimizes heat transfer processes, improving energy efficiency, and minimizing the environmental footprint of various industrial processes.

In some cases, the IHTF may comprise flue gas. In some instances, the flue gas may be produced via a combustion process. For example, as a result of combustion processes, flue gas, typically found in a gaseous state, may vary significantly in temperature based on the combustion process and fuel used. In further examples, the temperature of the flue gas may comprise between about 100° C. to about 600° C. In further examples, the temperature of the flue gas may comprise a maximum temperature of about 100° C. In further examples, the temperature of the flue gas may comprise a minimum temperature of about 600° C.

In some cases, the IHTF may comprise hot flue gas. In some instances, the hot flue gas may be utilized in heating applications or to generate steam. In some cases, the IHTF may comprise cool flue gas. In some instances, cool flue gas may be utilized in heat recovery processes to preheat combustion air or raw materials.

In some cases, the IHTF comprises an exhausted low-temperature flue gas. In some instances, the cold flue gas is configured to cool a molten salt before the molten salt re-enters the absorption stage. In some instances, the cold flue gas, following the absorption stage, is redirected for the cooling of the molten borate. For example, the low thermal mass of the flue gas may necessitate the implementation of staged heating and cooling (e.g., discussed in more detail below).

In some embodiments, the intermediate heat transfer fluid (IHTF) may comprise steam. In some cases, the intermediate heat transfer fluid (IHTF) may comprise steam in various states. In some instances, the steam may comprise saturated steam, superheated steam, or wet steam.

In some cases, the IHTF may comprise saturated steam. For instance, saturated steam may be utilized in heating applications where maintaining a consistent temperature is crucial due to its temperature corresponding to its pressure.

In some cases, the IHTF may comprise superheated steam. For instances, superheated steam, heated beyond its boiling point for a given pressure, may be utilized in applications demanding higher temperatures. In some instances, IHTF comprises a steam that is superheated to generate superheated steam. For example, the superheating of stream may subsequently heat recovery or de-superheating. In some instances, de-superheating process may be achieved through the injection of water. (e.g., which is a lower cost component compared to a classic shell and tube heat exchanger). In some instances, the de-superheating process may be achieved through a classic shell and tube heat exchanger.

In some cases, the IHTF may comprise wet steam. In some instances, the wet steam may comprise a combination of steam and liquid water. For example, the wet stream may be utilized in applications requiring substantial amounts of heat at a moderate temperature.

In some cases, steam may be used as a sweep gas to drive desorption. In some instances, no direct contact between the steam and a salt is expected during normal operation of a temperature swing. For example, the absence of direct contact between steam and salt may be expected during normal operation of a temperature swing. In further examples, the absence of direct contact between steam and salt may be expected during normal operation of a temperature swing reduces operational risks.

In some embodiments, the intermediate heat transfer fluid (IHTF) may comprise carbon dioxide (CO₂). In some cases, the intermediate heat transfer fluid (IHTF) may comprise carbon dioxide (CO₂) in various states. In some instances, the state of the carbon dioxide (CO₂) depends on the temperature and pressure conditions. In some cases, the IHTF may comprise a supercritical CO₂. In some cases, the IHTF may comprise CO₂ in gaseous or liquid states. In some instances, the IHTF may comprise CO₂ in the liquid state. For example, liquid CO₂ may be used for cooling applications at relatively low temperatures. In some instances, the IHTF may comprise CO₂ in the gaseous state. For example, gaseous CO₂ may be used for heating applications. In further examples, gaseous CO₂ may comprise a high specific heat capacity. In even further examples, the gaseous CO₂ may comprise a high specific heat capacity of about 0.84 J/g° C. at room temperature and constant pressure.

In some embodiments, the first stream may comprise any fluid. In some embodiments, the first stream may comprise any cold fluid. In some embodiments, the first stream may comprise any hot fluid. In some cases, the first stream may comprise any fluid configured to receive heat from an intermediate heat transfer fluid. In some cases, the first stream may comprise any intermediate heat transfer fluid described herein. In some cases, the first stream may comprise any salt stream described herein. In some cases, the first stream may comprise any molten borate stream described herein. In some cases, the first stream may comprise a third stream-first stream mixture. In some cases, the first stream may comprise a first stream-second stream mixture. In some cases, the first stream may comprise a second stream-third stream mixture.

In some embodiments, the second stream may comprise any fluid. In some embodiments, the second stream may comprise any cold fluid. In some embodiments, the second stream may comprise any hot fluid. In some cases, the second stream may comprise any fluid configured to receive heat from an intermediate heat transfer fluid. In some cases, the second stream may comprise any intermediate heat transfer fluid described herein. In some cases, the second stream may comprise any salt stream described herein. In some cases, the second stream may comprise any molten borate stream described herein. In some instances, the second stream may comprise any molten borate salt stream described herein

In some embodiments, the second stream may comprise water. In some embodiments, the second stream may comprise saturated water. In some cases, the second stream may comprise one or more of distilled water, deionized water, tap water, spring water, mineral water, carbonated water, brackish water, sea water, rainwater, snow or ice melt, greywater, effluent, hard water, soft water, demineralized water, alkaline water, artesian water, saline water, pond water, river water, groundwater, or freshwater.

In some cases, the second stream may comprise steam. In some cases, the second stream may comprise saturated steam. In some cases, the second stream may comprise one or more of superheated steam, wet steam, dry steam, unsaturated steam, low pressure steam, high pressure steam, waste steam, low temperature steam, high temperature steam, clean steam, flash steam, process steam, or induced steam.

In some cases, the second stream may comprise any solid. In some cases, the second stream may comprise solid water. In some cases, the second stream may comprise one or more of ice cubes, hail, sleet, snow, frost, ice crystals, ice pellets, glacier ice, or frozen rain. In some cases, the second stream may comprise a third stream-first stream mixture. In some cases, the second stream may comprise a first stream-second stream mixture. In some cases, the second stream may comprise a second stream-third stream mixture.

In some embodiments, the third stream may comprise any fluid. In some embodiments, the third stream may comprise any cold fluid. In some cases, the third stream may comprise any hot fluid. In some cases, the third stream may comprise any fluid configured to receive heat from an intermediate heat transfer fluid. In some cases, the third stream may comprise any intermediate heat transfer fluid described herein. In some cases, the third stream may comprise any salt stream described herein. In some cases, the third stream may comprise any molten borate stream described herein. In some cases, the third stream may comprise a third stream-first stream mixture. In some cases, the third stream may comprise a first stream-second stream mixture. In some cases, the third stream may comprise a second stream-third stream mixture.

In some embodiments, a first stream comprises a hot fluid (e.g., such as fluid 1). In some cases, the hot fluid (e.g., such as fluid 1) is at a temperature of about 300° C. to about 1,000° C. In some cases, the hot fluid (e.g., such as fluid 1) is at a temperature of between about 300° C. to about 500° C., about 300° C. to about 750° C., about 300° C. to about 1,000° C., about 500° C. to about 750° C., about 500° C. to about 1,000° C., or about 750° C. to about 1,000° C. In some cases, the hot fluid (e.g., such as fluid 1) is at a temperature of about 300° C., about 500° C., about 750° C., or about 1,000° C. In some cases, the hot fluid (e.g., such as fluid 1) is at a temperature of at least about 300° C., about 500° C., about 750° C., or about 1,000° C. In some cases, the hot fluid (e.g., such as fluid 1) is at a temperature of at most about 500° C., about 750° C., or about 1,000° C.

In some embodiments, a second stream comprises a cold fluid (e.g., such as fluid 2). In some cases, the cold fluid (e.g., such as fluid 2) is at a temperature of about 100° C. to about 600° C. In some cases, the cold fluid (e.g., such as fluid 2) is at a temperature of about 100° C. to about 200° C., about 100° C. to about 300° C., about 100° C. to about 400° C., about 100° C. to about 500° C., about 100° C. to about 600° C., about 200° C. to about 300° C., about 200° C. to about 400° C., about 200° C. to about 500° C., about 200° C. to about 600° C., about 300° C. to about 400° C., about 300° C. to about 500° C., about 300° C. to about 600° C., about 400° C. to about 500° C., about 400° C. to about 600° C., or about 500° C. to about 600° C. In some cases, the cold fluid (e.g., such as fluid 2) is at a temperature of about 100° C., about 200° C., about 300° C., about 400° C., about 500° C., or about 600° C. In some cases, the cold fluid (e.g., such as fluid 2) is at a temperature of at least about 100° C., about 200° C., about 300° C., about 400° C., or about 500° C. In some cases, the cold fluid (e.g., such as fluid 2) is at a temperature of at most about 200° C., about 300° C., about 400° C., about 500° C., or about 600° C.

In some embodiments, a third stream comprises an intermediate fluid (e.g., such as fluid 3). In some cases, the intermediate fluid (e.g., such as fluid 3) is at a temperature of about 100° C. to about 600° C. In some cases, the intermediate fluid (e.g., such as fluid 3) is at a temperature of between about 100° C. to about 200° C., about 100° C. to about 300° C., about 100° C. to about 400° C., about 100° C. to about 500° C., about 100° C. to about 600° C., about 200° C. to about 300° C., about 200° C. to about 400° C., about 200° C. to about 500° C., about 200° C. to about 600° C., about 300° C. to about 400° C., about 300° C. to about 500° C., about 300° C. to about 600° C., about 400° C. to about 500° C., about 400° C. to about 600° C., or about 500° C. to about 600° C. In some cases, the intermediate fluid (e.g., such as fluid 3) is at a temperature of about 100° C., about 200° C., about 300° C., about 400° C., about 500° C., or about 600° C. In some cases, the intermediate fluid (e.g., such as fluid 3) is at a temperature of at least about 100° C., about 200° C., about 300° C., about 400° C., or about 500° C. In some cases, the intermediate fluid (e.g., such as fluid 3) is at a temperature of at most about 200° C., about 300° C., about 400° C., about 500° C., or about 600° C.

In some cases, the steam is at a pressure of about 1 bar absolute to about 400 bar absolute. In some cases, steam is at a pressure of about 1 bar absolute to about 10 bar absolute, about 1 bar absolute to about 50 bar absolute, about 1 bar absolute to about 100 bar absolute, about 1 bar absolute to about 200 bar absolute, about 1 bar absolute to about 400 bar absolute, about 10 bar absolute to about 50 bar absolute, about 10 bar absolute to about 100 bar absolute, about 10 bar absolute to about 200 bar absolute, about 10 bar absolute to about 400 bar absolute, about 50 bar absolute to about 100 bar absolute, about 50 bar absolute to about 200 bar absolute, about 50 bar absolute to about 400 bar absolute, about 100 bar absolute to about 200 bar absolute, about 100 bar absolute to about 400 bar absolute, or about 200 bar absolute to about 400 bar absolute. In some cases, the steam is utilized as a first stream, second stream, or third stream fluid. In some instances, the steam is used as an intermediate fluid. In some cases, the steam is at a pressure of about 1 bar absolute, about 10 bar absolute, about 50 bar absolute, about 100 bar absolute, about 200 bar absolute, or about 400 bar absolute. In some cases, steam is at a pressure of at least about 1 bar absolute, about 10 bar absolute, about 50 bar absolute, about 100 bar absolute, or about 200 bar absolute. In some cases, the steam is at a pressure of at most about 10 bar absolute, about 50 bar absolute, about 100 bar absolute, about 200 bar absolute, or about 400 bar absolute. In some cases, the steam is utilized as a first stream, second stream, or third stream fluid. In some instances, the steam is utilized as an intermediate fluid.

In some cases, carbon dioxide is at a pressure of about 1 bar absolute to about 400 bar absolute. In some cases, carbon dioxide is at a pressure of about 1 bar absolute to about 10 bar absolute, about 1 bar absolute to about 50 bar absolute, about 1 bar absolute to about 100 bar absolute, about 1 bar absolute to about 200 bar absolute, about 1 bar absolute to about 400 bar absolute, about 10 bar absolute to about 50 bar absolute, about 10 bar absolute to about 100 bar absolute, about 10 bar absolute to about 200 bar absolute, about 10 bar absolute to about 400 bar absolute, about 50 bar absolute to about 100 bar absolute, about 50 bar absolute to about 200 bar absolute, about 50 bar absolute to about 400 bar absolute, about 100 bar absolute to about 200 bar absolute, about 100 bar absolute to about 400 bar absolute, or about 200 bar absolute to about 400 bar absolute. In some cases, carbon dioxide is at a pressure of about 1 bar absolute, about 10 bar absolute, about 50 bar absolute, about 100 bar absolute, about 200 bar absolute, or about 400 bar absolute. In some cases, carbon dioxide is at a pressure of at least about 1 bar absolute, about 10 bar absolute, about 50 bar absolute, about 100 bar absolute, or about 200 bar absolute. In some cases, carbon dioxide is at a pressure of at most about 10 bar absolute, about 50 bar absolute, about 100 bar absolute, about 200 bar absolute, or about 400 bar absolute. In some cases, the carbon dioxide is utilized as a first stream, second stream, or third stream fluid. In some instances, the carbon dioxide is utilized as an intermediate fluid.

In some cases, flue gas is at a pressure of about 0.1 bar absolute to about 100 bar absolute. In some cases, flue gas is at a pressure of about 0.1 bar absolute to about 1 bar absolute, about 0.1 bar absolute to about 10 bar absolute, about 0.1 bar absolute to about 100 bar absolute, about 1 bar absolute to about 10 bar absolute, about 1 bar absolute to about 100 bar absolute, or about 10 bar absolute to about 100 bar absolute. In some cases, flue gas is at a pressure of about 0.1 bar absolute, about 1 bar absolute, about 10 bar absolute, or about 100 bar absolute. In some cases, flue gas is at a pressure of at least about 0.1 bar absolute, about 1 bar absolute, or about 10 bar absolute. In some cases, flue gas is at a pressure of at most about 1 bar absolute, about 10 bar absolute, or about 100 bar absolute. In some cases, the flue gas is utilized as a first stream, second stream, or third stream fluid. In some instances, the flue gas is utilized as an intermediate fluid.

The intermediate fluid may be utilized in one or more stages. In some embodiments, the intermediate fluid may be utilized in one or more cooling stages. For example, the intermediate fluid may be configured to transfer heat to the one or more other fluid streams.

In some embodiments, the intermediate fluid may be utilized in one or more heating stages. For example, the intermediate fluid may be configured to receive heat from one or more other fluid streams.

In some cases, the intermediate fluid (e.g., such as fluid 3) is used in one heating or one cooling stage. In some cases, the intermediate fluid (e.g., such as fluid 3) is used in one heating and one cooling stage. In some cases, the intermediate fluid (e.g., such as fluid 3) is used in more than one heating and one cooling stage. In some instances, the intermediate fluid (e.g., such as fluid 3) is used in about 5, about 10, about 15, about 50, or about 100 heating and cooling stages. In some instances, the intermediate fluid (e.g., such as fluid 3) is used in about 5, about 10, about 15, about 50, or about 100 heating stages, cooling stages, or a combination thereof. In some instances, the intermediate fluid (e.g., such as fluid 3) is used in between about 1 and about 100 heating stages, cooling stages, or a combination thereof.

In some cases, the method comprises exhausting/exporting one or more of the first stream, the second stream, the third stream. In some cases, the method comprises exhausting/exporting the intermediate fluid. In some instances, the method comprises exhausting/exporting the intermediate fluid following use in first stream heat recovery. In some instances, the method comprises exhausting/exporting the intermediate fluid following use in first stream heat recovery at temperatures between about 100° C. to about 600° C. In some instances, the method comprises exhausting/exporting the intermediate fluid following use in first stream heat recovery at temperatures less than about 600° C. In some instances, the method comprises exhausting/exporting the intermediate fluid following use in first stream heat recovery at temperatures greater than about 100° C.

In some embodiments, a bypass line for one or more stream is used to raise the mass flow of one or more streams through the heat exchanger. In some cases, a bypass line for the first stream (e.g., such as fluid 1) is used to raise the first stream mass flow through the heat exchanger. In some instances, a bypass line may raise the first stream mass flow through the heat exchanger by at least about 1×, 5×, 10×, 100×, 500×, up to 1000×, or more compared to the mass flow of the first stream flow coming into the heat exchanger. In some instances, a bypass line may raise the first stream mass flow through the heat exchanger by at most about 1×, 5×, 10×, 100×, 500×, up to 1000×, or less compared to the mass flow of the first stream flow coming into the heat exchanger. In some instances, a bypass line may reduce the first stream mass flow through the heat exchanger by at least about 1×, 5×, 10×, 100×, 500×, up to 1000×, or more compared to the mass flow of the first stream flow coming into the heat exchanger. In some instances, a bypass line may reduce the first stream mass flow through the heat exchanger by at most about 1×, 5×, 10×, 100×, 500×, up to 1000×, or more compared to the mass flow of the first stream flow coming into the heat exchanger.

In some cases, a bypass line for the second stream (e.g., such as fluid 2) is used to raise the second stream mass flow through the heat exchanger. In some instances, a bypass line may raise the second stream mass flow through the heat exchanger by at most about 1×, 5×, 10×, 100×, 500×, up to 1000×, or less compared to the mass flow of the second stream flow coming into the heat exchanger. In some instances, a bypass line may reduce the second stream mass flow through the heat exchanger by at least about 1×, 5×, 10×, 100×, 500×, up to 1000×, or more compared to the mass flow of the second stream flow coming into the heat exchanger. In some instances, a bypass line may reduce the second stream mass flow through the heat exchanger by at most about 1×, 5×, 10×, 100×, 500×, up to 1000×, or more compared to the mass flow of the second stream flow coming into the heat exchanger.

In some cases, a bypass line for the third stream (e.g., such as fluid 2) is used to raise the third stream mass flow through the heat exchanger. In some instances, a bypass line may raise the third stream mass flow through the heat exchanger by at most about 1×, 5×, 10×, 100×, 500×, up to 1000×, or less compared to the mass flow of the third stream flow coming into the heat exchanger. In some instances, a bypass line may reduce the third stream mass flow through the heat exchanger by at least about 1×, 5×, 10×, 100×, 500×, up to 1000×, or more compared to the mass flow of the third stream flow coming into the heat exchanger. In some instances, a bypass line may reduce the third stream mass flow through the heat exchanger by at most about 1×, 5×, 10×, 100×, 500×, up to 1000×, or more compared to the mass flow of the third stream flow coming into the heat exchanger.

In some embodiments, a fluid stream may comprise any fluid. In some cases, the fluid stream may comprise one or more of the first fluid stream, a second fluid stream or a third fluid stream. In some cases, the fluid stream may comprise saturated stream. In some cases, the fluid stream may comprise saturated water.

In some instances, the fluid stream may comprise a thermal conductivity between about 0.1 watts per meter kelvin (W/m·K) and 100 W/m·K. In some instances, the fluid stream may comprise a thermal conductivity less than about 0.1 watts per meter kelvin (W/m·K). In some instances, the fluid stream may comprise a thermal conductivity greater than about 0.1 watts per meter kelvin (W/m·K). In some instances, the fluid stream may comprise a thermal conductivity greater than about 100 W/m·K. In some instances, the fluid stream may comprise a thermal conductivity less than about 100 W/m·K.

In some embodiments, the fluid stream comprises a thermal conductivity of between about 0 W/m·K to about 2,500 W/m·K. In some embodiments, the fluid stream comprises a thermal conductivity of between about 0 W/m·K to about 5 W/m·K, about 0 W/m·K to about 10 W/m·K, about 0 W/m·K to about 50 W/m·K, about 0 W/m·K to about 100 W/m·K, about 0 W/m·K to about 350 W/m·K, about 0 W/m·K to about 500 W/m·K, about 0 W/m·K to about 750 W/m·K, about 0 W/m·K to about 1,000 W/m·K, about 0 W/m·K to about 1,500 W/m·K, about 0 W/m·K to about 2,000 W/m·K, about 0 W/m·K to about 2,500 W/m·K, about 5 W/m·K to about 10 W/m·K, about 5 W/m·K to about 50 W/m·K, about 5 W/m·K to about 100 W/m·K, about 5 W/m·K to about 350 W/m·K, about 5 W/m·K to about 500 W/m·K, about 5 W/m·K to about 750 W/m·K, about 5 W/m·K to about 1,000 W/m·K, about 5 W/m·K to about 1,500 W/m·K, about 5 W/m·K to about 2,000 W/m·K, about 5 W/m·K to about 2,500 W/m·K, about 10 W/m·K to about 50 W/m·K, about 10 W/m·K to about 100 W/m·K, about 10 W/m·K to about 350 W/m·K, about 10 W/m·K to about 500 W/m·K, about 10 W/m·K to about 750 W/m·K, about 10 W/m·K to about 1,000 W/m·K, about 10 W/m·K to about 1,500 W/m·K, about 10 W/m·K to about 2,000 W/m·K, about 10 W/m·K to about 2,500 W/m·K, about 50 W/m·K to about 100 W/m·K, about 50 W/m·K to about 350 W/m·K, about 50 W/m·K to about 500 W/m·K, about 50 W/m·K to about 750 W/m·K, about 50 W/m·K to about 1,000 W/m·K, about 50 W/m·K to about 1,500 W/m·K, about 50 W/m·K to about 2,000 W/m·K, about 50 W/m·K to about 2,500 W/m·K, about 100 W/m·K to about 350 W/m·K, about 100 W/m·K to about 500 W/m·K, about 100 W/m·K to about 750 W/m·K, about 100 W/m·K to about 1,000 W/m·K, about 100 W/m·K to about 1,500 W/m·K, about 100 W/m·K to about 2,000 W/m·K, about 100 W/m·K to about 2,500 W/m·K, about 350 W/m·K to about 500 W/m·K, about 350 W/m·K to about 750 W/m·K, about 350 W/m·K to about 1,000 W/m·K, about 350 W/m·K to about 1,500 W/m·K, about 350 W/m·K to about 2,000 W/m·K, about 350 W/m·K to about 2,500 W/m·K, about 500 W/m·K to about 750 W/m·K, about 500 W/m·K to about 1,000 W/m·K, about 500 W/m·K to about 1,500 W/m·K, about 500 W/m·K to about 2,000 W/m·K, about 500 W/m·K to about 2,500 W/m·K, about 750 W/m·K to about 1,000 W/m·K, about 750 W/m·K to about 1,500 W/m·K, about 750 W/m·K to about 2,000 W/m·K, about 750 W/m·K to about 2,500 W/m·K, about 1,000 W/m·K to about 1,500 W/m·K, about 1,000 W/m·K to about 2,000 W/m·K, about 1,000 W/m·K to about 2,500 W/m·K, about 1,500 W/m·K to about 2,000 W/m·K, about 1,500 W/m·K to about 2,500 W/m·K, or about 2,000 W/m·K to about 2,500 W/m·K. In some embodiments, the fluid stream comprises a thermal conductivity of between about 0 W/m·K, about 5 W/m·K, about 10 W/m·K, about 50 W/m·K, about 100 W/m·K, about 350 W/m·K, about 500 W/m·K, about 750 W/m·K, about 1,000 W/m·K, about 1,500 W/m·K, about 2,000 W/m·K, or about 2,500 W/m·K. In some embodiments, the fluid stream comprises a thermal conductivity of between at least about 0 W/m·K, about 5 W/m·K, about 10 W/m·K, about 50 W/m·K, about 100 W/m·K, about 350 W/m·K, about 500 W/m·K, about 750 W/m·K, about 1,000 W/m·K, about 1,500 W/m·K, or about 2,000 W/m·K. In some embodiments, the fluid stream comprises a thermal conductivity of between at most about 5 W/m·K, about 10 W/m·K, about 50 W/m·K, about 100 W/m·K, about 350 W/m·K, about 500 W/m·K, about 750 W/m·K, about 1,000 W/m·K, about 1,500 W/m·K, about 2,000 W/m·K, or about 2,500 W/m·K.

In some instances, the fluid stream may comprise a density between about 0.1 kilograms per cubic meter (kg/m3) and 1000 kg/m3. In some instances, the fluid stream may comprise a density less than about 0.1 kilograms per cubic meter (kg/m3). In some instances, the fluid stream may comprise a density less than about 0.1 kilograms per cubic meter (kg/m3) less than about 1000 kg/m3. In some instances, the fluid stream may comprise a density less than about 0.1 kilograms per cubic meter (kg/m3) at least about 1000 kg/m3.

In some embodiments, the fluid stream comprises a density of between about 0 kg/m3 to about 3,000 kg/m3. In some embodiments, the fluid stream comprises a density of between about 0 kg/m3 to about 0.1 kg/m3, about 0 kg/m3 to about 0.5 kg/m3, about 0 kg/m3 to about 1 kg/m3, about 0 kg/m3 to about 10 kg/m3, about 0 kg/m3 to about 50 kg/m3, about 0 kg/m3 to about 100 kg/m3, about 0 kg/m3 to about 500 kg/m3, about 0 kg/m3 to about 1,000 kg/m3, about 0 kg/m3 to about 1,500 kg/m3, about 0 kg/m3 to about 2,500 kg/m3, about 0 kg/m3 to about 3,000 kg/m3, about 0.1 kg/m3 to about 0.5 kg/m3, about 0.1 kg/m3 to about 1 kg/m3, about 0.1 kg/m3 to about 10 kg/m3, about 0.1 kg/m3 to about 50 kg/m3, about 0.1 kg/m3 to about 100 kg/m3, about 0.1 kg/m3 to about 500 kg/m3, about 0.1 kg/m3 to about 1,000 kg/m3, about 0.1 kg/m3 to about 1,500 kg/m3, about 0.1 kg/m3 to about 2,500 kg/m3, about 0.1 kg/m3 to about 3,000 kg/m3, about 0.5 kg/m3 to about 1 kg/m3, about 0.5 kg/m3 to about 10 kg/m3, about 0.5 kg/m3 to about 50 kg/m3, about 0.5 kg/m3 to about 100 kg/m3, about 0.5 kg/m3 to about 500 kg/m3, about 0.5 kg/m3 to about 1,000 kg/m3, about 0.5 kg/m3 to about 1,500 kg/m3, about 0.5 kg/m3 to about 2,500 kg/m3, about 0.5 kg/m3 to about 3,000 kg/m3, about 1 kg/m3 to about 10 kg/m3, about 1 kg/m3 to about 50 kg/m3, about 1 kg/m3 to about 100 kg/m3, about 1 kg/m3 to about 500 kg/m3, about 1 kg/m3 to about 1,000 kg/m3, about 1 kg/m3 to about 1,500 kg/m3, about 1 kg/m3 to about 2,500 kg/m3, about 1 kg/m3 to about 3,000 kg/m3, about 10 kg/m3 to about 50 kg/m3, about 10 kg/m3 to about 100 kg/m3, about 10 kg/m3 to about 500 kg/m3, about 10 kg/m3 to about 1,000 kg/m3, about 10 kg/m3 to about 1,500 kg/m3, about 10 kg/m3 to about 2,500 kg/m3, about 10 kg/m3 to about 3,000 kg/m3, about 50 kg/m3 to about 100 kg/m3, about 50 kg/m3 to about 500 kg/m3, about 50 kg/m3 to about 1,000 kg/m3, about 50 kg/m3 to about 1,500 kg/m3, about 50 kg/m3 to about 2,500 kg/m3, about 50 kg/m3 to about 3,000 kg/m3, about 100 kg/m3 to about 500 kg/m3, about 100 kg/m3 to about 1,000 kg/m3, about 100 kg/m3 to about 1,500 kg/m3, about 100 kg/m3 to about 2,500 kg/m3, about 100 kg/m3 to about 3,000 kg/m3, about 500 kg/m3 to about 1,000 kg/m3, about 500 kg/m3 to about 1,500 kg/m3, about 500 kg/m3 to about 2,500 kg/m3, about 500 kg/m3 to about 3,000 kg/m3, about 1,000 kg/m3 to about 1,500 kg/m3, about 1,000 kg/m3 to about 2,500 kg/m3, about 1,000 kg/m3 to about 3,000 kg/m3, about 1,500 kg/m3 to about 2,500 kg/m3, about 1,500 kg/m3 to about 3,000 kg/m3, or about 2,500 kg/m3 to about 3,000 kg/m3. In some embodiments, the fluid stream comprises a density of 0 kg/m3, about 0.1 kg/m3, about 0.5 kg/m3, about 1 kg/m3, about 10 kg/m3, about 50 kg/m3, about 100 kg/m3, about 500 kg/m3, about 1,000 kg/m3, about 1,500 kg/m3, about 2,500 kg/m3, or about 3,000 kg/m3. In some embodiments, the fluid stream comprises a density of at least about 0 kg/m3, about 0.1 kg/m3, about 0.5 kg/m3, about 1 kg/m3, about 10 kg/m3, about 50 kg/m3, about 100 kg/m3, about 500 kg/m3, about 1,000 kg/m3, about 1,500 kg/m3, or about 2,500 kg/m3. In some embodiments, the fluid stream comprises a density of at most about 0.1 kg/m3, about 0.5 kg/m3, about 1 kg/m3, about 10 kg/m3, about 50 kg/m3, about 100 kg/m3, about 500 kg/m3, about 1,000 kg/m3, about 1,500 kg/m3, about 2,500 kg/m3, or about 3,000 kg/m3.

In some instances, the fluid stream may comprise a viscosity between about 0.01 centipoise (cP) to 100 cP. In some instances, the fluid stream may comprise a viscosity at most about 0.01 centipoise (cP). In some instances, the fluid stream may comprise a viscosity at least about 0.01 centipoise (cP). In some instances, the fluid stream may comprise a viscosity at least about 100 cP.

In some embodiments, the fluid stream comprises a viscosity of between about 0 cP to about 1 cP. In some embodiments, the fluid stream comprises a viscosity of between about 0 cP to about 0.005 cP, about 0 cP to about 0.01 cP, about 0 cP to about 0.015 cP, about 0 cP to about 0.02 cP, about 0 cP to about 0.03 cP, about 0 cP to about 0.05 cP, about 0 cP to about 0.1 cP, about 0 cP to about 0.15 cP, about 0 cP to about 0.2 cP, about 0 cP to about 0.5 cP, about 0 cP to about 1 cP, about 0.005 cP to about 0.01 cP, about 0.005 cP to about 0.015 cP, about 0.005 cP to about 0.02 cP, about 0.005 cP to about 0.03 cP, about 0.005 cP to about 0.05 cP, about 0.005 cP to about 0.1 cP, about 0.005 cP to about 0.15 cP, about 0.005 cP to about 0.2 cP, about 0.005 cP to about 0.5 cP, about 0.005 cP to about 1 cP, about 0.01 cP to about 0.015 cP, about 0.01 cP to about 0.02 cP, about 0.01 cP to about 0.03 cP, about 0.01 cP to about 0.05 cP, about 0.01 cP to about 0.1 cP, about 0.01 cP to about 0.15 cP, about 0.01 cP to about 0.2 cP, about 0.01 cP to about 0.5 cP, about 0.01 cP to about 1 cP, about 0.015 cP to about 0.02 cP, about 0.015 cP to about 0.03 cP, about 0.015 cP to about 0.05 cP, about 0.015 cP to about 0.1 cP, about 0.015 cP to about 0.15 cP, about 0.015 cP to about 0.2 cP, about 0.015 cP to about 0.5 cP, about 0.015 cP to about 1 cP, about 0.02 cP to about 0.03 cP, about 0.02 cP to about 0.05 cP, about 0.02 cP to about 0.1 cP, about 0.02 cP to about 0.15 cP, about 0.02 cP to about 0.2 cP, about 0.02 cP to about 0.5 cP, about 0.02 cP to about 1 cP, about 0.03 cP to about 0.05 cP, about 0.03 cP to about 0.1 cP, about 0.03 cP to about 0.15 cP, about 0.03 cP to about 0.2 cP, about 0.03 cP to about 0.5 cP, about 0.03 cP to about 1 cP, about 0.05 cP to about 0.1 cP, about 0.05 cP to about 0.15 cP, about 0.05 cP to about 0.2 cP, about 0.05 cP to about 0.5 cP, about 0.05 cP to about 1 cP, about 0.1 cP to about 0.15 cP, about 0.1 cP to about 0.2 cP, about 0.1 cP to about 0.5 cP, about 0.1 cP to about 1 cP, about 0.15 cP to about 0.2 cP, about 0.15 cP to about 0.5 cP, about 0.15 cP to about 1 cP, about 0.2 cP to about 0.5 cP, about 0.2 cP to about 1 cP, or about 0.5 cP to about 1 cP. In some embodiments, the fluid stream comprises a viscosity of about 0 cP, about 0.005 cP, about 0.01 cP, about 0.015 cP, about 0.02 cP, about 0.03 cP, about 0.05 cP, about 0.1 cP, about 0.15 cP, about 0.2 cP, about 0.5 cP, or about 1 cP. In some embodiments, the fluid stream comprises a viscosity of at least about 0 cP, about 0.005 cP, about 0.01 cP, about 0.015 cP, about 0.02 cP, about 0.03 cP, about 0.05 cP, about 0.1 cP, about 0.15 cP, about 0.2 cP, or about 0.5 cP. In some embodiments, the fluid stream comprises a viscosity of at most about 0.005 cP, about 0.01 cP, about 0.015 cP, about 0.02 cP, about 0.03 cP, about 0.05 cP, about 0.1 cP, about 0.15 cP, about 0.2 cP, about 0.5 cP, or about 1 cP.

In some instances, the fluid stream may comprise a specific heat capacity between about 0.2 kilojoules per kilogram kelvin (kJ/kg·K) to 5.0 kJ/kg·K. In some instances, the fluid stream may comprise a specific heat capacity of at least about 0.2 kilojoules per kilogram kelvin (kJ/kg·K) In some instances, the fluid stream may comprise a specific heat capacity of at most about 0.2 kilojoules per kilogram kelvin (kJ/kg·K). In some instances, the fluid stream may comprise a specific heat capacity of at least about 5.0 kJ/kg·K. In some embodiments, the fluid stream comprises a specific heat capacity of between about 0 (kJ/(kg·K)) at constant pressure (Cp) to about 10 (kJ/(kg·K)) at (Cp). In some embodiments, the fluid stream comprises a specific heat capacity of between about 0 (kJ/(kg·K)) at (Cp) to about 0.1 (kJ/(kg·K)) at (Cp), about 0 (kJ/(kg·K)) at (Cp) to about 0.2 (kJ/(kg·K)) at (Cp), about 0 (kJ/(kg·K)) at (Cp) to about 0.3 (kJ/(kg·K)) at (Cp), about 0 (kJ/(kg·K)) at (Cp) to about 0.5 (kJ/(kg·K)) at (Cp), about 0 (kJ/(kg·K)) at (Cp) to about 1 (kJ/(kg·K)) at (Cp), about 0 (kJ/(kg·K)) at (Cp) to about 2 (kJ/(kg·K)) at (Cp), about 0 (kJ/(kg·K)) at (Cp) to about 3 (kJ/(kg·K)) at (Cp), about 0 (kJ/(kg·K)) at (Cp) to about 5 (kJ/(kg·K)) at (Cp), about 0 (kJ/(kg·K)) at (Cp) to about 7.5 (kJ/(kg·K)) at (Cp), about 0 (kJ/(kg·K)) at (Cp) to about 8 (kJ/(kg·K)) at (Cp), about 0 (kJ/(kg·K)) at (Cp) to about 10 (kJ/(kg·K)) at (Cp), about 0.1 (kJ/(kg·K)) at (Cp) to about 0.2 (kJ/(kg·K)) at (Cp), about 0.1 (kJ/(kg·K)) at (Cp) to about 0.3 (kJ/(kg·K)) at (Cp), about 0.1 (kJ/(kg·K)) at (Cp) to about 0.5 (kJ/(kg·K)) at (Cp), about 0.1 (kJ/(kg·K)) at (Cp) to about 1 (kJ/(kg·K)) at (Cp), about 0.1 (kJ/(kg·K)) at (Cp) to about 2 (kJ/(kg·K)) at (Cp), about 0.1 (kJ/(kg·K)) at (Cp) to about 3 (kJ/(kg·K)) at (Cp), about 0.1 (kJ/(kg·K)) at (Cp) to about 5 (kJ/(kg·K)) at (Cp), about 0.1 (kJ/(kg·K)) at (Cp) to about 7.5 (kJ/(kg·K)) at (Cp), about 0.1 (kJ/(kg·K)) at (Cp) to about 8 (kJ/(kg·K)) at (Cp), about 0.1 (kJ/(kg·K)) at (Cp) to about 10 (kJ/(kg·K)) at (Cp), about 0.2 (kJ/(kg·K)) at (Cp) to about 0.3 (kJ/(kg·K)) at (Cp), about 0.2 (kJ/(kg·K)) at (Cp) to about 0.5 (kJ/(kg·K)) at (Cp), about 0.2 (kJ/(kg·K)) at (Cp) to about 1 (kJ/(kg·K)) at (Cp), about 0.2 (kJ/(kg·K)) at (Cp) to about 2 (kJ/(kg·K)) at (Cp), about 0.2 (kJ/(kg·K)) at (Cp) to about 3 (kJ/(kg·K)) at (Cp), about 0.2 (kJ/(kg·K)) at (Cp) to about 5 (kJ/(kg·K)) at (Cp), about 0.2 (kJ/(kg·K)) at (Cp) to about 7.5 (kJ/(kg·K)) at (Cp), about 0.2 (kJ/(kg·K)) at (Cp) to about 8 (kJ/(kg·K)) at (Cp), about 0.2 (kJ/(kg·K)) at (Cp) to about 10 (kJ/(kg·K)) at (Cp), about 0.3 (kJ/(kg·K)) at (Cp) to about 0.5 (kJ/(kg·K)) at (Cp), about 0.3 (kJ/(kg·K)) at (Cp) to about 1 (kJ/(kg·K)) at (Cp), about 0.3 (kJ/(kg·K)) at (Cp) to about 2 (kJ/(kg·K)) at (Cp), about 0.3 (kJ/(kg·K)) at (Cp) to about 3 (kJ/(kg·K)) at (Cp), about 0.3 (kJ/(kg·K)) at (Cp) to about 5 (kJ/(kg·K)) at (Cp), about 0.3 (kJ/(kg·K)) at (Cp) to about 7.5 (kJ/(kg·K)) at (Cp), about 0.3 (kJ/(kg·K)) at (Cp) to about 8 (kJ/(kg·K)) at (Cp), about 0.3 (kJ/(kg·K)) at (Cp) to about 10 (kJ/(kg·K)) at (Cp), about 0.5 (kJ/(kg·K)) at (Cp) to about 1 (kJ/(kg·K)) at (Cp), about 0.5 (kJ/(kg·K)) at (Cp) to about 2 (kJ/(kg·K)) at (Cp), about 0.5 (kJ/(kg·K)) at (Cp) to about 3 (kJ/(kg·K)) at (Cp), about 0.5 (kJ/(kg·K)) at (Cp) to about 5 (kJ/(kg·K)) at (Cp), about 0.5 (kJ/(kg·K)) at (Cp) to about 7.5 (kJ/(kg·K)) at (Cp), about 0.5 (kJ/(kg·K)) at (Cp) to about 8 (kJ/(kg·K)) at (Cp), about 0.5 (kJ/(kg·K)) at (Cp) to about 10 (kJ/(kg·K)) at (Cp), about 1 (kJ/(kg·K)) at (Cp) to about 2 (kJ/(kg·K)) at (Cp), about 1 (kJ/(kg·K)) at (Cp) to about 3 (kJ/(kg·K)) at (Cp), about 1 (kJ/(kg·K)) at (Cp) to about 5 (kJ/(kg·K)) at (Cp), about 1 (kJ/(kg·K)) at (Cp) to about 7.5 (kJ/(kg·K)) at (Cp), about 1 (kJ/(kg·K)) at (Cp) to about 8 (kJ/(kg·K)) at (Cp), about 1 (kJ/(kg·K)) at (Cp) to about 10 (kJ/(kg·K)) at (Cp), about 2 (kJ/(kg·K)) at (Cp) to about 3 (kJ/(kg·K)) at (Cp), about 2 (kJ/(kg·K)) at (Cp) to about 5 (kJ/(kg·K)) at (Cp), about 2 (kJ/(kg·K)) at (Cp) to about 7.5 (kJ/(kg·K)) at (Cp), about 2 (kJ/(kg·K)) at (Cp) to about 8 (kJ/(kg·K)) at (Cp), about 2 (kJ/(kg·K)) at (Cp) to about 10 (kJ/(kg·K)) at (Cp), about 3 (kJ/(kg·K)) at (Cp) to about 5 (kJ/(kg·K)) at (Cp), about 3 (kJ/(kg·K)) at (Cp) to about 7.5 (kJ/(kg·K)) at (Cp), about 3 (kJ/(kg·K)) at (Cp) to about 8 (kJ/(kg·K)) at (Cp), about 3 (kJ/(kg·K)) at (Cp) to about 10 (kJ/(kg·K)) at (Cp), about 5 (kJ/(kg·K)) at (Cp) to about 7.5 (kJ/(kg·K)) at (Cp), about 5 (kJ/(kg·K)) at (Cp) to about 8 (kJ/(kg·K)) at (Cp), about 5 (kJ/(kg·K)) at (Cp) to about 10 (kJ/(kg·K)) at (Cp), about 7.5 (kJ/(kg·K)) at (Cp) to about 8 (kJ/(kg·K)) at (Cp), about 7.5 (kJ/(kg·K)) at (Cp) to about 10 (kJ/(kg·K)) at (Cp), or about 8 (kJ/(kg·K)) at (Cp) to about 10 (kJ/(kg·K)) at (Cp). In some embodiments, the fluid stream comprises a specific heat capacity of about 0 (kJ/(kg·K)) at (Cp), about 0.1 (kJ/(kg·K)) at (Cp), about 0.2 (kJ/(kg·K)) at (Cp), about 0.3 (kJ/(kg·K)) at (Cp), about 0.5 (kJ/(kg·K)) at (Cp), about 1 (kJ/(kg·K)) at (Cp), about 2 (kJ/(kg·K)) at (Cp), about 3 (kJ/(kg·K)) at (Cp), about 5 (kJ/(kg·K)) at (Cp), about 7.5 (kJ/(kg·K)) at (Cp), about 8 (kJ/(kg·K)) at (Cp), or about 10 (kJ/(kg·K)) at (Cp). In some embodiments, the fluid stream comprises a specific heat capacity of at least about 0 (kJ/(kg·K)) at (Cp), about 0.1 (kJ/(kg·K)) at (Cp), about 0.2 (kJ/(kg·K)) at (Cp), about 0.3 (kJ/(kg·K)) at (Cp), about 0.5 (kJ/(kg·K)) at (Cp), about 1 (kJ/(kg·K)) at (Cp), about 2 (kJ/(kg·K)) at (Cp), about 3 (kJ/(kg·K)) at (Cp), about 5 (kJ/(kg·K)) at (Cp), about 7.5 (kJ/(kg·K)) at (Cp), or about 8 (kJ/(kg·K)) at (Cp). In some embodiments, the fluid stream comprises a specific heat capacity of between at most about 0.1 (kJ/(kg·K)) at (Cp), about 0.2 (kJ/(kg·K)) at (Cp), about 0.3 (kJ/(kg·K)) at (Cp), about 0.5 (kJ/(kg·K)) at (Cp), about 1 (kJ/(kg·K)) at (Cp), about 2 (kJ/(kg·K)) at (Cp), about 3 (kJ/(kg·K)) at (Cp), about 5 (kJ/(kg·K)) at (Cp), about 7.5 (kJ/(kg·K)) at (Cp), about 8 (kJ/(kg·K)) at (Cp), or about 10 (kJ/(kg·K)) at (Cp).

In some embodiments, the intermediate heat transfer fluid comprises a thermal conductivity of between about

$$10 W / m \cdot K ( \frac{Watts}{meter \times Kelvin} )$$

and about

$$1 , 000 W / m \cdot K ( \frac{Watts}{meter \times Kelvin} ) .$$

In some embodiments, the intermediate heat transfer fluid comprises a thermal conductivity of between about 0 W/m·K to about 2,500 W/m·K. In some embodiments, the intermediate heat transfer fluid comprises a thermal conductivity of between about 0 W/m·K to about 5 W/m·K, about 0 W/m·K to about 10 W/m·K, about 0 W/m·K to about 50 W/m·K, about 0 W/m·K to about 100 W/m·K, about 0 W/m·K to about 350 W/m·K, about 0 W/m·K to about 500 W/m·K, about 0 W/m·K to about 750 W/m·K, about 0 W/m·K to about 1,000 W/m·K, about 0 W/m·K to about 1,500 W/m·K, about 0 W/m·K to about 2,000 W/m·K, about 0 W/m·K to about 2,500 W/m·K, about 5 W/m·K to about 10 W/m·K, about 5 W/m·K to about 50 W/m·K, about 5 W/m·K to about 100 W/m·K, about 5 W/m·K to about 350 W/m·K, about 5 W/m·K to about 500 W/m·K, about 5 W/m·K to about 750 W/m·K, about 5 W/m·K to about 1,000 W/m·K, about 5 W/m·K to about 1,500 W/m·K, about 5 W/m·K to about 2,000 W/m·K, about 5 W/m·K to about 2,500 W/m·K, about 10 W/m·K to about 50 W/m·K, about 10 W/m·K to about 100 W/m·K, about 10 W/m·K to about 350 W/m·K, about 10 W/m·K to about 500 W/m·K, about 10 W/m·K to about 750 W/m·K, about 10 W/m·K to about 1,000 W/m·K, about 10 W/m·K to about 1,500 W/m·K, about 10 W/m·K to about 2,000 W/m·K, about 10 W/m·K to about 2,500 W/m·K, about 50 W/m·K to about 100 W/m·K, about 50 W/m·K to about 350 W/m·K, about 50 W/m·K to about 500 W/m·K, about 50 W/m·K to about 750 W/m·K, about 50 W/m·K to about 1,000 W/m·K, about 50 W/m·K to about 1,500 W/m·K, about 50 W/m·K to about 2,000 W/m·K, about 50 W/m·K to about 2,500 W/m·K, about 100 W/m·K to about 350 W/m·K, about 100 W/m·K to about 500 W/m·K, about 100 W/m·K to about 750 W/m·K, about 100 W/m·K to about 1,000 W/m·K, about 100 W/m·K to about 1,500 W/m·K, about 100 W/m·K to about 2,000 W/m·K, about 100 W/m·K to about 2,500 W/m·K, about 350 W/m·K to about 500 W/m·K, about 350 W/m·K to about 750 W/m·K, about 350 W/m·K to about 1,000 W/m·K, about 350 W/m·K to about 1,500 W/m·K, about 350 W/m·K to about 2,000 W/m·K, about 350 W/m·K to about 2,500 W/m·K, about 500 W/m·K to about 750 W/m·K, about 500 W/m·K to about 1,000 W/m·K, about 500 W/m·K to about 1,500 W/m·K, about 500 W/m·K to about 2,000 W/m·K, about 500 W/m·K to about 2,500 W/m·K, about 750 W/m·K to about 1,000 W/m·K, about 750 W/m·K to about 1,500 W/m·K, about 750 W/m·K to about 2,000 W/m·K, about 750 W/m·K to about 2,500 W/m·K, about 1,000 W/m·K to about 1,500 W/m·K, about 1,000 W/m·K to about 2,000 W/m·K, about 1,000 W/m·K to about 2,500 W/m·K, about 1,500 W/m·K to about 2,000 W/m·K, about 1,500 W/m·K to about 2,500 W/m·K, or about 2,000 W/m·K to about 2,500 W/m·K. In some embodiments, the intermediate heat transfer fluid comprises a thermal conductivity of between about 0 W/m·K, about 5 W/m·K, about 10 W/m·K, about 50 W/m·K, about 100 W/m·K, about 350 W/m·K, about 500 W/m·K, about 750 W/m·K, about 1,000 W/m·K, about 1,500 W/m·K, about 2,000 W/m·K, or about 2,500 W/m·K. In some embodiments, the intermediate heat transfer fluid comprises a thermal conductivity of between at least about 0 W/m·K, about 5 W/m·K, about 10 W/m·K, about 50 W/m·K, about 100 W/m·K, about 350 W/m·K, about 500 W/m·K, about 750 W/m·K, about 1,000 W/m·K, about 1,500 W/m·K, or about 2,000 W/m·K. In some embodiments, the intermediate heat transfer fluid comprises a thermal conductivity of between at most about 5 W/m·K, about 10 W/m·K, about 50 W/m·K, about 100 W/m·K, about 350 W/m·K, about 500 W/m·K, about 750 W/m·K, about 1,000 W/m·K, about 1,500 W/m·K, about 2,000 W/m·K, or about 2,500 W/m·K.

In some embodiments, the molten salt comprises a thermal conductivity of between about

$$100 W / m \cdot K ( \frac{Watts}{meter \times Kelvin} )$$

to about

$$2 , 000 W / m \cdot K ( \frac{Watts}{meter \times Kelvin} ) .$$

In some embodiments, the molt n salt comprises a thermal conductivity of between about 0 W/m·K to about 2,500 W/m·K. In some embodiments, the molten salt comprises a thermal conductivity of between about 0 W/m·K to about 5 W/m·K, about 0 W/m·K to about 10 W/m·K, about 0 W/m·K to about 50 W/m·K, about 0 W/m·K to about 100 W/m·K, about 0 W/m·K to about 350 W/m·K, about 0 W/m·K to about 500 W/m·K, about 0 W/m·K to about 750 W/m·K, about 0 W/m·K to about 1,000 W/m·K, about 0 W/m·K to about 1,500 W/m·K, about 0 W/m·K to about 2,000 W/m·K, about 0 W/m·K to about 2,500 W/m·K, about 5 W/m·K to about 10 W/m·K, about 5 W/m·K to about 50 W/m·K, about 5 W/m·K to about 100 W/m·K, about 5 W/m·K to about 350 W/m·K, about 5 W/m·K to about 500 W/m·K, about 5 W/m·K to about 750 W/m·K, about 5 W/m·K to about 1,000 W/m·K, about 5 W/m·K to about 1,500 W/m·K, about 5 W/m·K to about 2,000 W/m·K, about 5 W/m·K to about 2,500 W/m·K, about 10 W/m·K to about 50 W/m·K, about 10 W/m·K to about 100 W/m·K, about 10 W/m·K to about 350 W/m·K, about 10 W/m·K to about 500 W/m·K, about 10 W/m·K to about 750 W/m·K, about 10 W/m·K to about 1,000 W/m·K, about 10 W/m·K to about 1,500 W/m·K, about 10 W/m·K to about 2,000 W/m·K, about 10 W/m·K to about 2,500 W/m·K, about 50 W/m·K to about 100 W/m·K, about 50 W/m·K to about 350 W/m·K, about 50 W/m·K to about 500 W/m·K, about 50 W/m·K to about 750 W/m·K, about 50 W/m·K to about 1,000 W/m·K, about 50 W/m·K to about 1,500 W/m·K, about 50 W/m·K to about 2,000 W/m·K, about 50 W/m·K to about 2,500 W/m·K, about 100 W/m·K to about 350 W/m·K, about 100 W/m·K to about 500 W/m·K, about 100 W/m·K to about 750 W/m·K, about 100 W/m·K to about 1,000 W/m·K, about 100 W/m·K to about 1,500 W/m·K, about 100 W/m·K to about 2,000 W/m·K, about 100 W/m·K to about 2,500 W/m·K, about 350 W/m·K to about 500 W/m·K, about 350 W/m·K to about 750 W/m·K, about 350 W/m·K to about 1,000 W/m·K, about 350 W/m·K to about 1,500 W/m·K, about 350 W/m·K to about 2,000 W/m·K, about 350 W/m·K to about 2,500 W/m·K, about 500 W/m·K to about 750 W/m·K, about 500 W/m·K to about 1,000 W/m·K, about 500 W/m·K to about 1,500 W/m·K, about 500 W/m·K to about 2,000 W/m·K, about 500 W/m·K to about 2,500 W/m·K, about 750 W/m·K to about 1,000 W/m·K, about 750 W/m·K to about 1,500 W/m·K, about 750 W/m·K to about 2,000 W/m·K, about 750 W/m·K to about 2,500 W/m·K, about 1,000 W/m·K to about 1,500 W/m·K, about 1,000 W/m·K to about 2,000 W/m·K, about 1,000 W/m·K to about 2,500 W/m·K, about 1,500 W/m·K to about 2,000 W/m·K, about 1,500 W/m·K to about 2,500 W/m·K, or about 2,000 W/m·K to about 2,500 W/m·K. In some embodiments, the molten salt comprises a thermal conductivity of between about 0 W/m·K, about 5 W/m·K, about 10 W/m·K, about 50 W/m·K, about 100 W/m·K, about 350 W/m·K, about 500 W/m·K, about 750 W/m·K, about 1,000 W/m·K, about 1,500 W/m·K, about 2,000 W/m·K, or about 2,500 W/m·K. In some embodiments, the molten salt comprises a thermal conductivity of at least about 0 W/m·K, about 5 W/m·K, about 10 W/m·K, about 50 W/m·K, about 100 W/m·K, about 350 W/m·K, about 500 W/m·K, about 750 W/m·K, about 1,000 W/m·K, about 1,500 W/m·K, or about 2,000 W/m·K. In some embodiments, the molten salt comprises a thermal conductivity of between at most about 5 W/m·K, about 10 W/m·K, about 50 W/m·K, about 100 W/m·K, about 350 W/m·K, about 500 W/m·K, about 750 W/m·K, about 1,000 W/m·K, about 1,500 W/m·K, about 2,000 W/m·K, or about 2,500 W/m·K.

In some embodiments, the intermediate heat transfer fluid comprises a heat transfer coefficient of between about

$$1 ( W / ( m \hat{} 2 \cdot K ) ) ( \frac{Watts}{{meter}^{2} \times Kelvin} )$$

to about

$$100 , 000 ( \frac{Watts}{{meter}^{2} \times Kelvin} ) .$$

In some embodiments, the intermediate heat transfer fluid comprises a heat transfer coefficient of between about 0 (W/(m\hat{ }2·K)) to about 120,000 (W/(m\hat{ }2·K)). In some embodiments, the intermediate heat transfer fluid comprises a heat transfer coefficient of between about 0 (W/(m\hat{ }2·K)) to about 1 (W/(m\hat{ }2·K)), about 0 (W/(m\hat{ }2·K)) to about 10 (W/(m\hat{ }2·K)), about 0 (W/(m\hat{ }2·K)) to about 100 (W/(m\hat{ }2·K)), about 0 (W/(m\hat{ }2·K)) to about 500 (W/(m\hat{ }2·K)), about 0 (W/(m\hat{ }2·K)) to about 1,000 (W/(m\hat{ }2·K)), about 0 (W/(m\hat{ }2·K)) to about 10,000 (W/(m\hat{ }2·K)), about 0 (W/(m\hat{ }2·K)) to about 25,000 (W/(m\hat{ }2·K)), about 0 (W/(m\hat{ }2·K)) to about 50,000 (W/(m\hat{ }2·K)), about 0 (W/(m\hat{ }2·K)) to about 100,000 (W/(m\hat{ }2·K)), about 0 (W/(m\hat{ }2·K)) to about 110,000 (W/(m\hat{ }2·K)), about 0 (W/(m\hat{ }2·K)) to about 120,000 (W/(m\hat{ }2·K)), about 1 (W/(m\hat{ }2·K)) to about 10 (W/(m\hat{ }2·K)), about 1 (W/(m\hat{ }2·K)) to about 100 (W/(m\hat{ }2·K)), about 1 (W/(m\hat{ }2·K)) to about 500 (W/(m\hat{ }2·K)), about 1 (W/(m\hat{ }2·K)) to about 1,000 (W/(m\hat{ }2·K)), about 1 (W/(m\hat{ }2·K)) to about 10,000 (W/(m\hat{ }2·K)), about 1 (W/(m\hat{ }2·K)) to about 25,000 (W/(m\hat{ }2·K)), about 1 (W/(m\hat{ }2·K)) to about 50,000 (W/(m\hat{ }2·K)), about 1 (W/(m\hat{ }2·K)) to about 100,000 (W/(m\hat{ }2·K)), about 1 (W/(m\hat{ }2·K)) to about 110,000 (W/(m\hat{ }2·K)), about 1 (W/(m\hat{ }2·K)) to about 120,000 (W/(m\hat{ }2·K)), about 10 (W/(m\hat{ }2·K)) to about 100 (W/(m\hat{ }2·K)), about 10 (W/(m\hat{ }2·K)) to about 500 (W/(m\hat{ }2·K)), about 10 (W/(m\hat{ }2·K)) to about 1,000 (W/(m\hat{ }2·K)), about 10 (W/(m\hat{ }2·K)) to about 10,000 (W/(m\hat{ }2·K)), about 10 (W/(m\hat{ }2·K)) to about 25,000 (W/(m\hat{ }2·K)), about 10 (W/(m\hat{ }2·K)) to about 50,000 (W/(m\hat{ }2·K)), about 10 (W/(m\hat{ }2·K)) to about 100,000 (W/(m\hat{ }2·K)), about 10 (W/(m\hat{ }2·K)) to about 110,000 (W/(m\hat{ }2·K)), about 10 (W/(m\hat{ }2·K)) to about 120,000 (W/(m\hat{ }2·K)), about 100 (W/(m\hat{ }2·K)) to about 500 (W/(m\hat{ }2·K)), about 100 (W/(m\hat{ }2·K)) to about 1,000 (W/(m\hat{ }2·K)), about 100 (W/(m\hat{ }2·K)) to about 10,000 (W/(m\hat{ }2·K)), about 100 (W/(m\hat{ }2·K)) to about 25,000 (W/(m\hat{ }2·K)), about 100 (W/(m\hat{ }2·K)) to about 50,000 (W/(m\hat{ }2·K)), about 100 (W/(m\hat{ }2·K)) to about 100,000 (W/(m\hat{ }2·K)), about 100 (W/(m\hat{ }2·K)) to about 110,000 (W/(m\hat{ }2·K)), about 100 (W/(m\hat{ }2·K)) to about 120,000 (W/(m\hat{ }2·K)), about 500 (W/(m\hat{ }2·K)) to about 1,000 (W/(m\hat{ }2·K)), about 500 (W/(m\hat{ }2·K)) to about 10,000 (W/(m\hat{ }2·K)), about 500 (W/(m\hat{ }2·K)) to about 25,000 (W/(m\hat{ }2·K)), about 500 (W/(m\hat{ }2·K)) to about 50,000 (W/(m\hat{ }2·K)), about 500 (W/(m\hat{ }2·K)) to about 100,000 (W/(m\hat{ }2·K)), about 500 (W/(m\hat{ }2·K)) to about 110,000 (W/(m\hat{ }2·K)), about 500 (W/(m\hat{ }2·K)) to about 120,000 (W/(m\hat{ }2·K)), about 1,000 (W/(m\hat{ }2·K)) to about 10,000 (W/(m\hat{ }2·K)), about 1,000 (W/(m\hat{ }2·K)) to about 25,000 (W/(m\hat{ }2·K)), about 1,000 (W/(m\hat{ }2·K)) to about 50,000 (W/(m\hat{ }2·K)), about 1,000 (W/(m\hat{ }2·K)) to about 100,000 (W/(m\hat{ }2·K)), about 1,000 (W/(m\hat{ }2·K)) to about 110,000 (W/(m\hat{ }2·K)), about 1,000 (W/(m\hat{ }2·K)) to about 120,000 (W/(m\hat{ }2·K)), about 10,000 (W/(m\hat{ }2·K)) to about 25,000 (W/(m\hat{ }2·K)), about 10,000 (W/(m\hat{ }2·K)) to about 50,000 (W/(m\hat{ }2·K)), about 10,000 (W/(m\hat{ }2·K)) to about 100,000 (W/(m\hat{ }2·K)), about 10,000 (W/(m\hat{ }2·K)) to about 110,000 (W/(m\hat{ }2·K)), about 10,000 (W/(m\hat{ }2·K)) to about 120,000 (W/(m\hat{ }2·K)), about 25,000 (W/(m\hat{ }2·K)) to about 50,000 (W/(m\hat{ }2·K)), about 25,000 (W/(m\hat{ }2·K)) to about 100,000 (W/(m\hat{ }2·K)), about 25,000 (W/(m\hat{ }2·K)) to about 110,000 (W/(m\hat{ }2·K)), about 25,000 (W/(m\hat{ }2·K)) to about 120,000 (W/(m\hat{ }2·K)), about 50,000 (W/(m\hat{ }2·K)) to about 100,000 (W/(m\hat{ }2·K)), about 50,000 (W/(m\hat{ }2·K)) to about 110,000 (W/(m\hat{ }2·K)), about 50,000 (W/(m\hat{ }2·K)) to about 120,000 (W/(m\hat{ }2·K)), about 100,000 (W/(m\hat{ }2·K)) to about 110,000 (W/(m\hat{ }2·K)), about 100,000 (W/(m\hat{ }2·K)) to about 120,000 (W/(m\hat{ }2·K)), or about 110,000 (W/(m\hat{ }2·K)) to about 120,000 (W/(m\hat{ }2·K)).

In some embodiments, the intermediate heat transfer fluid comprises a heat transfer coefficient of about 1 (W/(m\hat{ }2·K)), about 10 (W/(m\hat{ }2·K)), about 100 (W/(m\hat{ }2·K)), about 500 (W/(m\hat{ }2·K)), about 1,000 (W/(m\hat{ }2·K)), about 10,000 (W/(m\hat{ }2·K)), about 25,000 (W/(m\hat{ }2·K)), about 50,000 (W/(m\hat{ }2·K)), about 100,000 (W/(m\hat{ }2·K)), about 110,000 (W/(m\hat{ }2·K)), or about 120,000 (W/(m\hat{ }2·K)). In some embodiments, the intermediate heat transfer fluid comprises a heat transfer coefficient of between at least about 0 (W/(m\hat{ }2·K)), about 1 (W/(m\hat{ }2·K)), about 10 (W/(m\hat{ }2·K)), about 100 (W/(m\hat{ }2·K)), about 500 (W/(m\hat{ }2·K)), about 1,000 (W/(m\hat{ }2·K)), about 10,000 (W/(m\hat{ }2·K)), about 25,000 (W/(m\hat{ }2·K)), about 50,000 (W/(m\hat{ }2·K)), about 100,000 (W/(m\hat{ }2·K)), or about 110,000 (W/(m\hat{ }2·K)). In some embodiments, the intermediate heat transfer fluid comprises a heat transfer coefficient of between at most about 1 (W/(m\hat{ }2·K)), about 10 (W/(m\hat{ }2·K)), about 100 (W/(m\hat{ }2·K)), about 500 (W/(m\hat{ }2·K)), about 1,000 (W/(m\hat{ }2·K)), about 10,000 (W/(m\hat{ }2·K)), about 25,000 (W/(m\hat{ }2·K)), about 50,000 (W/(m\hat{ }2·K)), about 100,000 (W/(m\hat{ }2·K)), about 110,000 (W/(m\hat{ }2·K)), or about 120,000 (W/(m\hat{ }2·K)).

In some embodiments, the molten salt comprises a heat transfer coefficient of between about

$$1 ( W / ( m \hat{} 2 \cdot K ) ) ( \frac{Watts}{{meter}^{2} \times Kelvin} )$$

to about

$$100 , 000 ( W / ( m \hat{} 2 \cdot K ) ) ( \frac{Watts}{{meter}^{2} \times Kelvin} ) .$$

In some embodiments, the molten salt comprises a heat transfer coefficient of between about 0 (W/(m\hat{ }2·K)) to about 120,000 (W/(m\hat{ }2·K)). In some embodiments, the molten salt comprises a heat transfer coefficient of between about 0 (W/(m\hat{ }2·K)) to about 1 (W/(m\hat{ }2·K)), about 0 (W/(m\hat{ }2·K)) to about 10 (W/(m\hat{ }2·K)), about 0 (W/(m\hat{ }2·K)) to about 100 (W/(m\hat{ }2·K)), about 0 (W/(m\hat{ }2·K)) to about 500 (W/(m\hat{ }2·K)), about 0 (W/(m\hat{ }2·K)) to about 1,000 (W/(m\hat{ }2·K)), about 0 (W/(m\hat{ }2·K)) to about 10,000 (W/(m\hat{ }2·K)), about 0 (W/(m\hat{ }2·K)) to about 25,000 (W/(m\hat{ }2·K)), about 0 (W/(m\hat{ }2·K)) to about 50,000 (W/(m\hat{ }2·K)), about 0 (W/(m\hat{ }2·K)) to about 100,000 (W/(m\hat{ }2·K)), about 0 (W/(m\hat{ }2·K)) to about 110,000 (W/(m\hat{ }2·K)), about 0 (W/(m\hat{ }2·K)) to about 120,000 (W/(m\hat{ }2·K)), about 1 (W/(m\hat{ }2·K)) to about 10 (W/(m\hat{ }2·K)), about 1 (W/(m\hat{ }2·K)) to about 100 (W/(m\hat{ }2·K)), about 1 (W/(m\hat{ }2·K)) to about 500 (W/(m\hat{ }2·K)), about 1 (W/(m\hat{ }2·K)) to about 1,000 (W/(m\hat{ }2·K)), about 1 (W/(m\hat{ }2·K)) to about 10,000 (W/(m\hat{ }2·K)), about 1 (W/(m\hat{ }2·K)) to about 25,000 (W/(m\hat{ }2·K)), about 1 (W/(m\hat{ }2·K)) to about 50,000 (W/(m\hat{ }2·K)), about 1 (W/(m\hat{ }2·K)) to about 100,000 (W/(m\hat{ }2·K)), about 1 (W/(m\hat{ }2·K)) to about 110,000 (W/(m\hat{ }2·K)), about 1 (W/(m\hat{ }2·K)) to about 120,000 (W/(m\hat{ }2·K)), about 10 (W/(m\hat{ }2·K)) to about 100 (W/(m\hat{ }2·K)), about 10 (W/(m\hat{ }2·K)) to about 500 (W/(m\hat{ }2·K)), about 10 (W/(m\hat{ }2·K)) to about 1,000 (W/(m\hat{ }2·K)), about 10 (W/(m\hat{ }2·K)) to about 10,000 (W/(m\hat{ }2·K)), about 10 (W/(m\hat{ }2·K)) to about 25,000 (W/(m\hat{ }2·K)), about 10 (W/(m\hat{ }2·K)) to about 50,000 (W/(m\hat{ }2·K)), about 10 (W/(m\hat{ }2·K)) to about 100,000 (W/(m\hat{ }2·K)), about 10 (W/(m\hat{ }2·K)) to about 110,000 (W/(m\hat{ }2·K)), about 10 (W/(m\hat{ }2·K)) to about 120,000 (W/(m\hat{ }2·K)), about 100 (W/(m\hat{ }2·K)) to about 500 (W/(m\hat{ }2·K)), about 100 (W/(m\hat{ }2·K)) to about 1,000 (W/(m\hat{ }2·K)), about 100 (W/(m\hat{ }2·K)) to about 10,000 (W/(m\hat{ }2·K)), about 100 (W/(m\hat{ }2·K)) to about 25,000 (W/(m\hat{ }2·K)), about 100 (W/(m\hat{ }2·K)) to about 50,000 (W/(m\hat{ }2·K)), about 100 (W/(m\hat{ }2·K)) to about 100,000 (W/(m\hat{ }2·K)), about 100 (W/(m\hat{ }2·K)) to about 110,000 (W/(m\hat{ }2·K)), about 100 (W/(m\hat{ }2·K)) to about 120,000 (W/(m\hat{ }2·K)), about 500 (W/(m\hat{ }2·K)) to about 1,000 (W/(m\hat{ }2·K)), about 500 (W/(m\hat{ }2·K)) to about 10,000 (W/(m\hat{ }2·K)), about 500 (W/(m\hat{ }2·K)) to about 25,000 (W/(m\hat{ }2·K)), about 500 (W/(m\hat{ }2·K)) to about 50,000 (W/(m\hat{ }2·K)), about 500 (W/(m\hat{ }2·K)) to about 100,000 (W/(m\hat{ }2·K)), about 500 (W/(m\hat{ }2·K)) to about 110,000 (W/(m\hat{ }2·K)), about 500 (W/(m\hat{ }2·K)) to about 120,000 (W/(m\hat{ }2·K)), about 1,000 (W/(m\hat{ }2·K)) to about 10,000 (W/(m\hat{ }2·K)), about 1,000 (W/(m\hat{ }2·K)) to about 25,000 (W/(m\hat{ }2·K)), about 1,000 (W/(m\hat{ }2·K)) to about 50,000 (W/(m\hat{ }2·K)), about 1,000 (W/(m\hat{ }2·K)) to about 100,000 (W/(m\hat{ }2·K)), about 1,000 (W/(m\hat{ }2·K)) to about 110,000 (W/(m\hat{ }2·K)), about 1,000 (W/(m\hat{ }2·K)) to about 120,000 (W/(m\hat{ }2·K)), about 10,000 (W/(m\hat{ }2·K)) to about 25,000 (W/(m\hat{ }2·K)), about 10,000 (W/(m\hat{ }2·K)) to about 50,000 (W/(m\hat{ }2·K)), about 10,000 (W/(m\hat{ }2·K)) to about 100,000 (W/(m\hat{ }2·K)), about 10,000 (W/(m\hat{ }2·K)) to about 110,000 (W/(m\hat{ }2·K)), about 10,000 (W/(m\hat{ }2·K)) to about 120,000 (W/(m\hat{ }2·K)), about 25,000 (W/(m\hat{ }2·K)) to about 50,000 (W/(m\hat{ }2·K)), about 25,000 (W/(m\hat{ }2·K)) to about 100,000 (W/(m\hat{ }2·K)), about 25,000 (W/(m\hat{ }2·K)) to about 110,000 (W/(m\hat{ }2·K)), about 25,000 (W/(m\hat{ }2·K)) to about 120,000 (W/(m\hat{ }2·K)), about 50,000 (W/(m\hat{ }2·K)) to about 100,000 (W/(m\hat{ }2·K)), about 50,000 (W/(m\hat{ }2·K)) to about 110,000 (W/(m\hat{ }2·K)), about 50,000 (W/(m\hat{ }2·K)) to about 120,000 (W/(m\hat{ }2·K)), about 100,000 (W/(m\hat{ }2·K)) to about 110,000 (W/(m\hat{ }2·K)), about 100,000 (W/(m\hat{ }2·K)) to about 120,000 (W/(m\hat{ }2·K)), or about 110,000 (W/(m\hat{ }2·K)) to about 120,000 (W/(m\hat{ }2·K)). In some embodiments, the molten salt comprises a heat transfer coefficient of between about 0 (W/(m\hat{ }2·K)), about 1 (W/(m\hat{ }2·K)), about 10 (W/(m\hat{ }2·K)), about 100 (W/(m\hat{ }2·K)), about 500 (W/(m\hat{ }2·K)), about 1,000 (W/(m\hat{ }2·K)), about 10,000 (W/(m\hat{ }2·K)), about 25,000 (W/(m\hat{ }2·K)), about 50,000 (W/(m\hat{ }2·K)), about 100,000 (W/(m\hat{ }2·K)), about 110,000 (W/(m\hat{ }2·K)), or about 120,000 (W/(m\hat{ }2·K)). In some embodiments, the molten salt comprises a heat transfer coefficient of between at least about 0 (W/(m\hat{ }2·K)), about 1 (W/(m\hat{ }2·K)), about 10 (W/(m\hat{ }2·K)), about 100 (W/(m\hat{ }2·K)), about 500 (W/(m\hat{ }2·K)), about 1,000 (W/(m\hat{ }2·K)), about 10,000 (W/(m\hat{ }2·K)), about 25,000 (W/(m\hat{ }2·K)), about 50,000 (W/(m\hat{ }2·K)), about 100,000 (W/(m\hat{ }2·K)), or about 110,000 (W/(m\hat{ }2·K)). In some embodiments, the molten salt comprises a heat transfer coefficient of between at most about 1 (W/(m\hat{ }2·K)), about 10 (W/(m\hat{ }2·K)), about 100 (W/(m\hat{ }2·K)), about 500 (W/(m\hat{ }2·K)), about 1,000 (W/(m\hat{ }2·K)), about 10,000 (W/(m\hat{ }2·K)), about 25,000 (W/(m\hat{ }2·K)), about 50,000 (W/(m\hat{ }2·K)), about 100,000 (W/(m\hat{ }2·K)), about 110,000 (W/(m\hat{ }2·K)), or about 120,000 (W/(m\hat{ }2·K)).

In some embodiments, the intermediate heat transfer fluid comprises a specific heat capacity of between about

$$0.2 ( kJ / ( kg \cdot K ) ) ( \frac{kilojoule}{kilogram \times Kelvin} )$$

to about

$$5. ( kJ / ( kg \cdot K ) ) ( \frac{kilojoule}{kilogram \times Kelvin} )$$

at constant pressure (Cp).

In some embodiments, the intermediate heat transfer fluid comprises a specific heat capacity of between about 0 (kJ/(kg·K)) at constant pressure (Cp) to about 10 (kJ/(kg·K)) at (Cp). In some embodiments, the intermediate heat transfer fluid comprises a specific heat capacity of between about 0 (kJ/(kg·K)) at (Cp) to about 0.1 (kJ/(kg·K)) at (Cp), about 0 (kJ/(kg·K)) at (Cp) to about 0.2 (kJ/(kg·K)) at (Cp), about 0 (kJ/(kg·K)) at (Cp) to about 0.3 (kJ/(kg·K)) at (Cp), about 0 (kJ/(kg·K)) at (Cp) to about 0.5 (kJ/(kg·K)) at (Cp), about 0 (kJ/(kg·K)) at (Cp) to about 1 (kJ/(kg·K)) at (Cp), about 0 (kJ/(kg·K)) at (Cp) to about 2 (kJ/(kg·K)) at (Cp), about 0 (kJ/(kg·K)) at (Cp) to about 3 (kJ/(kg·K)) at (Cp), about 0 (kJ/(kg·K)) at (Cp) to about 5 (kJ/(kg·K)) at (Cp), about 0 (kJ/(kg·K)) at (Cp) to about 7.5 (kJ/(kg·K)) at (Cp), about 0 (kJ/(kg·K)) at (Cp) to about 8 (kJ/(kg·K)) at (Cp), about 0 (kJ/(kg·K)) at (Cp) to about 10 (kJ/(kg·K)) at (Cp), about 0.1 (kJ/(kg·K)) at (Cp) to about 0.2 (kJ/(kg·K)) at (Cp), about 0.1 (kJ/(kg·K)) at (Cp) to about 0.3 (kJ/(kg·K)) at (Cp), about 0.1 (kJ/(kg·K)) at (Cp) to about 0.5 (kJ/(kg·K)) at (Cp), about 0.1 (kJ/(kg·K)) at (Cp) to about 1 (kJ/(kg·K)) at (Cp), about 0.1 (kJ/(kg·K)) at (Cp) to about 2 (kJ/(kg·K)) at (Cp), about 0.1 (kJ/(kg·K)) at (Cp) to about 3 (kJ/(kg·K)) at (Cp), about 0.1 (kJ/(kg·K)) at (Cp) to about 5 (kJ/(kg·K)) at (Cp), about 0.1 (kJ/(kg·K)) at (Cp) to about 7.5 (kJ/(kg·K)) at (Cp), about 0.1 (kJ/(kg·K)) at (Cp) to about 8 (kJ/(kg·K)) at (Cp), about 0.1 (kJ/(kg·K)) at (Cp) to about 10 (kJ/(kg·K)) at (Cp), about 0.2 (kJ/(kg·K)) at (Cp) to about 0.3 (kJ/(kg·K)) at (Cp), about 0.2 (kJ/(kg·K)) at (Cp) to about 0.5 (kJ/(kg·K)) at (Cp), about 0.2 (kJ/(kg·K)) at (Cp) to about 1 (kJ/(kg·K)) at (Cp), about 0.2 (kJ/(kg·K)) at (Cp) to about 2 (kJ/(kg·K)) at (Cp), about 0.2 (kJ/(kg·K)) at (Cp) to about 3 (kJ/(kg·K)) at (Cp), about 0.2 (kJ/(kg·K)) at (Cp) to about 5 (kJ/(kg·K)) at (Cp), about 0.2 (kJ/(kg·K)) at (Cp) to about 7.5 (kJ/(kg·K)) at (Cp), about 0.2 (kJ/(kg·K)) at (Cp) to about 8 (kJ/(kg·K)) at (Cp), about 0.2 (kJ/(kg·K)) at (Cp) to about 10 (kJ/(kg·K)) at (Cp), about 0.3 (kJ/(kg·K)) at (Cp) to about 0.5 (kJ/(kg·K)) at (Cp), about 0.3 (kJ/(kg·K)) at (Cp) to about 1 (kJ/(kg·K)) at (Cp), about 0.3 (kJ/(kg·K)) at (Cp) to about 2 (kJ/(kg·K)) at (Cp), about 0.3 (kJ/(kg·K)) at (Cp) to about 3 (kJ/(kg·K)) at (Cp), about 0.3 (kJ/(kg·K)) at (Cp) to about 5 (kJ/(kg·K)) at (Cp), about 0.3 (kJ/(kg·K)) at (Cp) to about 7.5 (kJ/(kg·K)) at (Cp), about 0.3 (kJ/(kg·K)) at (Cp) to about 8 (kJ/(kg·K)) at (Cp), about 0.3 (kJ/(kg·K)) at (Cp) to about 10 (kJ/(kg·K)) at (Cp), about 0.5 (kJ/(kg·K)) at (Cp) to about 1 (kJ/(kg·K)) at (Cp), about 0.5 (kJ/(kg·K)) at (Cp) to about 2 (kJ/(kg·K)) at (Cp), about 0.5 (kJ/(kg·K)) at (Cp) to about 3 (kJ/(kg·K)) at (Cp), about 0.5 (kJ/(kg·K)) at (Cp) to about 5 (kJ/(kg·K)) at (Cp), about 0.5 (kJ/(kg·K)) at (Cp) to about 7.5 (kJ/(kg·K)) at (Cp), about 0.5 (kJ/(kg·K)) at (Cp) to about 8 (kJ/(kg·K)) at (Cp), about 0.5 (kJ/(kg·K)) at (Cp) to about 10 (kJ/(kg·K)) at (Cp), about 1 (kJ/(kg·K)) at (Cp) to about 2 (kJ/(kg·K)) at (Cp), about 1 (kJ/(kg·K)) at (Cp) to about 3 (kJ/(kg·K)) at (Cp), about 1 (kJ/(kg·K)) at (Cp) to about 5 (kJ/(kg·K)) at (Cp), about 1 (kJ/(kg·K)) at (Cp) to about 7.5 (kJ/(kg·K)) at (Cp), about 1 (kJ/(kg·K)) at (Cp) to about 8 (kJ/(kg·K)) at (Cp), about 1 (kJ/(kg·K)) at (Cp) to about 10 (kJ/(kg·K)) at (Cp), about 2 (kJ/(kg·K)) at (Cp) to about 3 (kJ/(kg·K)) at (Cp), about 2 (kJ/(kg·K)) at (Cp) to about 5 (kJ/(kg·K)) at (Cp), about 2 (kJ/(kg·K)) at (Cp) to about 7.5 (kJ/(kg·K)) at (Cp), about 2 (kJ/(kg·K)) at (Cp) to about 8 (kJ/(kg·K)) at (Cp), about 2 (kJ/(kg·K)) at (Cp) to about 10 (kJ/(kg·K)) at (Cp), about 3 (kJ/(kg·K)) at (Cp) to about 5 (kJ/(kg·K)) at (Cp), about 3 (kJ/(kg·K)) at (Cp) to about 7.5 (kJ/(kg·K)) at (Cp), about 3 (kJ/(kg·K)) at (Cp) to about 8 (kJ/(kg·K)) at (Cp), about 3 (kJ/(kg·K)) at (Cp) to about 10 (kJ/(kg·K)) at (Cp), about 5 (kJ/(kg·K)) at (Cp) to about 7.5 (kJ/(kg·K)) at (Cp), about 5 (kJ/(kg·K)) at (Cp) to about 8 (kJ/(kg·K)) at (Cp), about 5 (kJ/(kg·K)) at (Cp) to about 10 (kJ/(kg·K)) at (Cp), about 7.5 (kJ/(kg·K)) at (Cp) to about 8 (kJ/(kg·K)) at (Cp), about 7.5 (kJ/(kg·K)) at (Cp) to about 10 (kJ/(kg·K)) at (Cp), or about 8 (kJ/(kg·K)) at (Cp) to about 10 (kJ/(kg·K)) at (Cp). In some embodiments, the intermediate heat transfer fluid comprises a specific heat capacity of about 0 (kJ/(kg·K)) at (Cp), about 0.1 (kJ/(kg·K)) at (Cp), about 0.2 (kJ/(kg·K)) at (Cp), about 0.3 (kJ/(kg·K)) at (Cp), about 0.5 (kJ/(kg·K)) at (Cp), about 1 (kJ/(kg·K)) at (Cp), about 2 (kJ/(kg·K)) at (Cp), about 3 (kJ/(kg·K)) at (Cp), about 5 (kJ/(kg·K)) at (Cp), about 7.5 (kJ/(kg·K)) at (Cp), about 8 (kJ/(kg·K)) at (Cp), or about 10 (kJ/(kg·K)) at (Cp). In some embodiments, the intermediate heat transfer fluid comprises a specific heat capacity of at least about 0 (kJ/(kg·K)) at (Cp), about 0.1 (kJ/(kg·K)) at (Cp), about 0.2 (kJ/(kg·K)) at (Cp), about 0.3 (kJ/(kg·K)) at (Cp), about 0.5 (kJ/(kg·K)) at (Cp), about 1 (kJ/(kg·K)) at (Cp), about 2 (kJ/(kg·K)) at (Cp), about 3 (kJ/(kg·K)) at (Cp), about 5 (kJ/(kg·K)) at (Cp), about 7.5 (kJ/(kg·K)) at (Cp), or about 8 (kJ/(kg·K)) at (Cp). In some embodiments, the intermediate heat transfer fluid comprises a specific heat capacity of between at most about 0.1 (kJ/(kg·K)) at (Cp), about 0.2 (kJ/(kg·K)) at (Cp), about 0.3 (kJ/(kg·K)) at (Cp), about 0.5 (kJ/(kg·K)) at (Cp), about 1 (kJ/(kg·K)) at (Cp), about 2 (kJ/(kg·K)) at (Cp), about 3 (kJ/(kg·K)) at (Cp), about 5 (kJ/(kg·K)) at (Cp), about 7.5 (kJ/(kg·K)) at (Cp), about 8 (kJ/(kg·K)) at (Cp), or about 10 (kJ/(kg·K)) at (Cp).

In some embodiments, the molten salt comprises a specific heat capacity of between about

$$0.5 ( kJ / ( kg \cdot K ) ) ( \frac{kilojoule}{kilogram \times Kelvin} )$$

to about

$$5. ( kJ / ( kg \cdot K ) ) ( \frac{kilojoule}{kilogram \times Kelvin} )$$

at constant pressure (Cp).

In some embodiments, the molten salt comprises a specific heat capacity of between about 0 (kJ/(kg·K)) at (Cp) to about 10 (kJ/(kg·K)) at (Cp). In some embodiments, the molten salt comprises a specific heat capacity of between about 0 (kJ/(kg·K)) at (Cp) to about 0.1 (kJ/(kg·K)) at (Cp), about 0 (kJ/(kg·K)) at (Cp) to about 0.2 (kJ/(kg·K)) at (Cp), about 0 (kJ/(kg·K)) at (Cp) to about 0.3 (kJ/(kg·K)) at (Cp), about 0 (kJ/(kg·K)) at (Cp) to about 0.5 (kJ/(kg·K)) at (Cp), about 0 (kJ/(kg·K)) at (Cp) to about 1 (kJ/(kg·K)) at (Cp), about 0 (kJ/(kg·K)) at (Cp) to about 2 (kJ/(kg·K)) at (Cp), about 0 (kJ/(kg·K)) at (Cp) to about 3 (kJ/(kg·K)) at (Cp), about 0 (kJ/(kg·K)) at (Cp) to about 5 (kJ/(kg·K)) at (Cp), about 0 (kJ/(kg·K)) at (Cp) to about 7.5 (kJ/(kg·K)) at (Cp), about 0 (kJ/(kg·K)) at (Cp) to about 8 (kJ/(kg·K)) at (Cp), about 0 (kJ/(kg·K)) at (Cp) to about 10 (kJ/(kg·K)) at (Cp), about 0.1 (kJ/(kg·K)) at (Cp) to about 0.2 (kJ/(kg·K)) at (Cp), about 0.1 (kJ/(kg·K)) at (Cp) to about 0.3 (kJ/(kg·K)) at (Cp), about 0.1 (kJ/(kg·K)) at (Cp) to about 0.5 (kJ/(kg·K)) at (Cp), about 0.1 (kJ/(kg·K)) at (Cp) to about 1 (kJ/(kg·K)) at (Cp), about 0.1 (kJ/(kg·K)) at (Cp) to about 2 (kJ/(kg·K)) at (Cp), about 0.1 (kJ/(kg·K)) at (Cp) to about 3 (kJ/(kg·K)) at (Cp), about 0.1 (kJ/(kg·K)) at (Cp) to about 5 (kJ/(kg·K)) at (Cp), about 0.1 (kJ/(kg·K)) at (Cp) to about 7.5 (kJ/(kg·K)) at (Cp), about 0.1 (kJ/(kg·K)) at (Cp) to about 8 (kJ/(kg·K)) at (Cp), about 0.1 (kJ/(kg·K)) at (Cp) to about 10 (kJ/(kg·K)) at (Cp), about 0.2 (kJ/(kg·K)) at (Cp) to about 0.3 (kJ/(kg·K)) at (Cp), about 0.2 (kJ/(kg·K)) at (Cp) to about 0.5 (kJ/(kg·K)) at (Cp), about 0.2 (kJ/(kg·K)) at (Cp) to about 1 (kJ/(kg·K)) at (Cp), about 0.2 (kJ/(kg·K)) at (Cp) to about 2 (kJ/(kg·K)) at (Cp), about 0.2 (kJ/(kg·K)) at (Cp) to about 3 (kJ/(kg·K)) at (Cp), about 0.2 (kJ/(kg·K)) at (Cp) to about 5 (kJ/(kg·K)) at (Cp), about 0.2 (kJ/(kg·K)) at (Cp) to about 7.5 (kJ/(kg·K)) at (Cp), about 0.2 (kJ/(kg·K)) at (Cp) to about 8 (kJ/(kg·K)) at (Cp), about 0.2 (kJ/(kg·K)) at (Cp) to about 10 (kJ/(kg·K)) at (Cp), about 0.3 (kJ/(kg·K)) at (Cp) to about 0.5 (kJ/(kg·K)) at (Cp), about 0.3 (kJ/(kg·K)) at (Cp) to about 1 (kJ/(kg·K)) at (Cp), about 0.3 (kJ/(kg·K)) at (Cp) to about 2 (kJ/(kg·K)) at (Cp), about 0.3 (kJ/(kg·K)) at (Cp) to about 3 (kJ/(kg·K)) at (Cp), about 0.3 (kJ/(kg·K)) at (Cp) to about 5 (kJ/(kg·K)) at (Cp), about 0.3 (kJ/(kg·K)) at (Cp) to about 7.5 (kJ/(kg·K)) at (Cp), about 0.3 (kJ/(kg·K)) at (Cp) to about 8 (kJ/(kg·K)) at (Cp), about 0.3 (kJ/(kg·K)) at (Cp) to about 10 (kJ/(kg·K)) at (Cp), about 0.5 (kJ/(kg·K)) at (Cp) to about 1 (kJ/(kg·K)) at (Cp), about 0.5 (kJ/(kg·K)) at (Cp) to about 2 (kJ/(kg·K)) at (Cp), about 0.5 (kJ/(kg·K)) at (Cp) to about 3 (kJ/(kg·K)) at (Cp), about 0.5 (kJ/(kg·K)) at (Cp) to about 5 (kJ/(kg·K)) at (Cp), about 0.5 (kJ/(kg·K)) at (Cp) to about 7.5 (kJ/(kg·K)) at (Cp), about 0.5 (kJ/(kg·K)) at (Cp) to about 8 (kJ/(kg·K)) at (Cp), about 0.5 (kJ/(kg·K)) at (Cp) to about 10 (kJ/(kg·K)) at (Cp), about 1 (kJ/(kg·K)) at (Cp) to about 2 (kJ/(kg·K)) at (Cp), about 1 (kJ/(kg·K)) at (Cp) to about 3 (kJ/(kg·K)) at (Cp), about 1 (kJ/(kg·K)) at (Cp) to about 5 (kJ/(kg·K)) at (Cp), about 1 (kJ/(kg·K)) at (Cp) to about 7.5 (kJ/(kg·K)) at (Cp), about 1 (kJ/(kg·K)) at (Cp) to about 8 (kJ/(kg·K)) at (Cp), about 1 (kJ/(kg·K)) at (Cp) to about 10 (kJ/(kg·K)) at (Cp), about 2 (kJ/(kg·K)) at (Cp) to about 3 (kJ/(kg·K)) at (Cp), about 2 (kJ/(kg·K)) at (Cp) to about 5 (kJ/(kg·K)) at (Cp), about 2 (kJ/(kg·K)) at (Cp) to about 7.5 (kJ/(kg·K)) at (Cp), about 2 (kJ/(kg·K)) at (Cp) to about 8 (kJ/(kg·K)) at (Cp), about 2 (kJ/(kg·K)) at (Cp) to about 10 (kJ/(kg·K)) at (Cp), about 3 (kJ/(kg·K)) at (Cp) to about 5 (kJ/(kg·K)) at (Cp), about 3 (kJ/(kg·K)) at (Cp) to about 7.5 (kJ/(kg·K)) at (Cp), about 3 (kJ/(kg·K)) at (Cp) to about 8 (kJ/(kg·K)) at (Cp), about 3 (kJ/(kg·K)) at (Cp) to about 10 (kJ/(kg·K)) at (Cp), about 5 (kJ/(kg·K)) at (Cp) to about 7.5 (kJ/(kg·K)) at (Cp), about 5 (kJ/(kg·K)) at (Cp) to about 8 (kJ/(kg·K)) at (Cp), about 5 (kJ/(kg·K)) at (Cp) to about 10 (kJ/(kg·K)) at (Cp), about 7.5 (kJ/(kg·K)) at (Cp) to about 8 (kJ/(kg·K)) at (Cp), about 7.5 (kJ/(kg·K)) at (Cp) to about 10 (kJ/(kg·K)) at (Cp), or about 8 (kJ/(kg·K)) at (Cp) to about 10 (kJ/(kg·K)) at (Cp). In some embodiments, the molten salt comprises a specific heat capacity of about 0 (kJ/(kg·K)) at (Cp), about 0.1 (kJ/(kg·K)) at (Cp), about 0.2 (kJ/(kg·K)) at (Cp), about 0.3 (kJ/(kg·K)) at (Cp), about 0.5 (kJ/(kg·K)) at (Cp), about 1 (kJ/(kg·K)) at (Cp), about 2 (kJ/(kg·K)) at (Cp), about 3 (kJ/(kg·K)) at (Cp), about 5 (kJ/(kg·K)) at (Cp), about 7.5 (kJ/(kg·K)) at (Cp), about 8 (kJ/(kg·K)) at (Cp), or about 10 (kJ/(kg·K)) at (Cp). In some embodiments, the molten salt comprises a specific heat capacity of between at least about 0 (kJ/(kg·K)) at (Cp), about 0.1 (kJ/(kg·K)) at (Cp), about 0.2 (kJ/(kg·K)) at (Cp), about 0.3 (kJ/(kg·K)) at (Cp), about 0.5 (kJ/(kg·K)) at (Cp), about 1 (kJ/(kg·K)) at (Cp), about 2 (kJ/(kg·K)) at (Cp), about 3 (kJ/(kg·K)) at (Cp), about 5 (kJ/(kg·K)) at (Cp), about 7.5 (kJ/(kg·K)) at (Cp), or about 8 (kJ/(kg·K)) at (Cp). In some embodiments, the molten salt comprises a specific heat capacity of at most about 0.1 (kJ/(kg·K)) at (Cp), about 0.2 (kJ/(kg·K)) at (Cp), about 0.3 (kJ/(kg·K)) at (Cp), about 0.5 (kJ/(kg·K)) at (Cp), about 1 (kJ/(kg·K)) at (Cp), about 2 (kJ/(kg·K)) at (Cp), about 3 (kJ/(kg·K)) at (Cp), about 5 (kJ/(kg·K)) at (Cp), about 7.5 (kJ/(kg·K)) at (Cp), about 8 (kJ/(kg·K)) at (Cp), or about 10 (kJ/(kg·K)) at (Cp).

In some embodiments, the intermediate heat transfer fluid comprises a density of between about

$$0.1 kg / m 3 ( \frac{kilogram}{cubic meters} )$$

to about

$$3000 kg / m 3 ( \frac{kilogram}{cubic meters} ) .$$

In some embodiments, the intermediate heat transfer fluid comprises a density of between about

$$0.1 kg / m 3 ( \frac{kilogram}{cubic meters} )$$

to about

$$2000 kg / m 3 ( \frac{kilogram}{cubic meters} ) .$$

In some embodiments, the intermediate heat transfer fluid comprises a density of between about 0 kg/m3 to about 3,000 kg/m3. In some embodiments, the intermediate heat transfer fluid comprises a density of between about 0 kg/m3 to about 0.1 kg/m3, about 0 kg/m3 to about 0.5 kg/m3, about 0 kg/m3 to about 1 kg/m3, about 0 kg/m3 to about 10 kg/m3, about 0 kg/m3 to about 50 kg/m3, about 0 kg/m3 to about 100 kg/m3, about 0 kg/m3 to about 500 kg/m3, about 0 kg/m3 to about 1,000 kg/m3, about 0 kg/m3 to about 1,500 kg/m3, about 0 kg/m3 to about 2,500 kg/m3, about 0 kg/m3 to about 3,000 kg/m3, about 0.1 kg/m3 to about 0.5 kg/m3, about 0.1 kg/m3 to about 1 kg/m3, about 0.1 kg/m3 to about 10 kg/m3, about 0.1 kg/m3 to about 50 kg/m3, about 0.1 kg/m3 to about 100 kg/m3, about 0.1 kg/m3 to about 500 kg/m3, about 0.1 kg/m3 to about 1,000 kg/m3, about 0.1 kg/m3 to about 1,500 kg/m3, about 0.1 kg/m3 to about 2,500 kg/m3, about 0.1 kg/m3 to about 3,000 kg/m3, about 0.5 kg/m3 to about 1 kg/m3, about 0.5 kg/m3 to about 10 kg/m3, about 0.5 kg/m3 to about 50 kg/m3, about 0.5 kg/m3 to about 100 kg/m3, about 0.5 kg/m3 to about 500 kg/m3, about 0.5 kg/m3 to about 1,000 kg/m3, about 0.5 kg/m3 to about 1,500 kg/m3, about 0.5 kg/m3 to about 2,500 kg/m3, about 0.5 kg/m3 to about 3,000 kg/m3, about 1 kg/m3 to about 10 kg/m3, about 1 kg/m3 to about 50 kg/m3, about 1 kg/m3 to about 100 kg/m3, about 1 kg/m3 to about 500 kg/m3, about 1 kg/m3 to about 1,000 kg/m3, about 1 kg/m3 to about 1,500 kg/m3, about 1 kg/m3 to about 2,500 kg/m3, about 1 kg/m3 to about 3,000 kg/m3, about 10 kg/m3 to about 50 kg/m3, about 10 kg/m3 to about 100 kg/m3, about 10 kg/m3 to about 500 kg/m3, about 10 kg/m3 to about 1,000 kg/m3, about 10 kg/m3 to about 1,500 kg/m3, about 10 kg/m3 to about 2,500 kg/m3, about 10 kg/m3 to about 3,000 kg/m3, about 50 kg/m3 to about 100 kg/m3, about 50 kg/m3 to about 500 kg/m3, about 50 kg/m3 to about 1,000 kg/m3, about 50 kg/m3 to about 1,500 kg/m3, about 50 kg/m3 to about 2,500 kg/m3, about 50 kg/m3 to about 3,000 kg/m3, about 100 kg/m3 to about 500 kg/m3, about 100 kg/m3 to about 1,000 kg/m3, about 100 kg/m3 to about 1,500 kg/m3, about 100 kg/m3 to about 2,500 kg/m3, about 100 kg/m3 to about 3,000 kg/m3, about 500 kg/m3 to about 1,000 kg/m3, about 500 kg/m3 to about 1,500 kg/m3, about 500 kg/m3 to about 2,500 kg/m3, about 500 kg/m3 to about 3,000 kg/m3, about 1,000 kg/m3 to about 1,500 kg/m3, about 1,000 kg/m3 to about 2,500 kg/m3, about 1,000 kg/m3 to about 3,000 kg/m3, about 1,500 kg/m3 to about 2,500 kg/m3, about 1,500 kg/m3 to about 3,000 kg/m3, or about 2,500 kg/m3 to about 3,000 kg/m3. In some embodiments, the intermediate heat transfer fluid comprises a density of 0 kg/m3, about 0.1 kg/m3, about 0.5 kg/m3, about 1 kg/m3, about 10 kg/m3, about 50 kg/m3, about 100 kg/m3, about 500 kg/m3, about 1,000 kg/m3, about 1,500 kg/m3, about 2,500 kg/m3, or about 3,000 kg/m3. In some embodiments, the intermediate heat transfer fluid comprises a density of at least about 0 kg/m3, about 0.1 kg/m3, about 0.5 kg/m3, about 1 kg/m3, about 10 kg/m3, about 50 kg/m3, about 100 kg/m3, about 500 kg/m3, about 1,000 kg/m3, about 1,500 kg/m3, or about 2,500 kg/m3. In some embodiments, the intermediate heat transfer fluid comprises a density of at most about 0.1 kg/m3, about 0.5 kg/m3, about 1 kg/m3, about 10 kg/m3, about 50 kg/m3, about 100 kg/m3, about 500 kg/m3, about 1,000 kg/m3, about 1,500 kg/m3, about 2,500 kg/m3, or about 3,000 kg/m3.

In some embodiments, the molten salt comprises a density of about 500 kg/m3 to about 5000 kg/m3.

In some embodiments, the molten salt comprises a density of between about 0 kg/m3 to about 6,000 kg/m3. In some embodiments, the molten salt comprises a density of between about 0 kg/m3 to about 100 kg/m3, about 0 kg/m3 to about 250 kg/m3, about 0 kg/m3 to about 375 kg/m3, about 0 kg/m3 to about 500 kg/m3, about 0 kg/m3 to about 1,000 kg/m3, about 0 kg/m3 to about 1,500 kg/m3, about 0 kg/m3 to about 2,000 kg/m3, about 0 kg/m3 to about 3,000 kg/m3, about 0 kg/m3 to about 4,000 kg/m3, about 0 kg/m3 to about 5,000 kg/m3, about 0 kg/m3 to about 6,000 kg/m3, about 100 kg/m3 to about 250 kg/m3, about 100 kg/m3 to about 375 kg/m3, about 100 kg/m3 to about 500 kg/m3, about 100 kg/m3 to about 1,000 kg/m3, about 100 kg/m3 to about 1,500 kg/m3, about 100 kg/m3 to about 2,000 kg/m3, about 100 kg/m3 to about 3,000 kg/m3, about 100 kg/m3 to about 4,000 kg/m3, about 100 kg/m3 to about 5,000 kg/m3, about 100 kg/m3 to about 6,000 kg/m3, about 250 kg/m3 to about 375 kg/m3, about 250 kg/m3 to about 500 kg/m3, about 250 kg/m3 to about 1,000 kg/m3, about 250 kg/m3 to about 1,500 kg/m3, about 250 kg/m3 to about 2,000 kg/m3, about 250 kg/m3 to about 3,000 kg/m3, about 250 kg/m3 to about 4,000 kg/m3, about 250 kg/m3 to about 5,000 kg/m3, about 250 kg/m3 to about 6,000 kg/m3, about 375 kg/m3 to about 500 kg/m3, about 375 kg/m3 to about 1,000 kg/m3, about 375 kg/m3 to about 1,500 kg/m3, about 375 kg/m3 to about 2,000 kg/m3, about 375 kg/m3 to about 3,000 kg/m3, about 375 kg/m3 to about 4,000 kg/m3, about 375 kg/m3 to about 5,000 kg/m3, about 375 kg/m3 to about 6,000 kg/m3, about 500 kg/m3 to about 1,000 kg/m3, about 500 kg/m3 to about 1,500 kg/m3, about 500 kg/m3 to about 2,000 kg/m3, about 500 kg/m3 to about 3,000 kg/m3, about 500 kg/m3 to about 4,000 kg/m3, about 500 kg/m3 to about 5,000 kg/m3, about 500 kg/m3 to about 6,000 kg/m3, about 1,000 kg/m3 to about 1,500 kg/m3, about 1,000 kg/m3 to about 2,000 kg/m3, about 1,000 kg/m3 to about 3,000 kg/m3, about 1,000 kg/m3 to about 4,000 kg/m3, about 1,000 kg/m3 to about 5,000 kg/m3, about 1,000 kg/m3 to about 6,000 kg/m3, about 1,500 kg/m3 to about 2,000 kg/m3, about 1,500 kg/m3 to about 3,000 kg/m3, about 1,500 kg/m3 to about 4,000 kg/m3, about 1,500 kg/m3 to about 5,000 kg/m3, about 1,500 kg/m3 to about 6,000 kg/m3, about 2,000 kg/m3 to about 3,000 kg/m3, about 2,000 kg/m3 to about 4,000 kg/m3, about 2,000 kg/m3 to about 5,000 kg/m3, about 2,000 kg/m3 to about 6,000 kg/m3, about 3,000 kg/m3 to about 4,000 kg/m3, about 3,000 kg/m3 to about 5,000 kg/m3, about 3,000 kg/m3 to about 6,000 kg/m3, about 4,000 kg/m3 to about 5,000 kg/m3, about 4,000 kg/m3 to about 6,000 kg/m3, or about 5,000 kg/m3 to about 6,000 kg/m3. In some embodiments, the molten salt comprises a density of about 0 kg/m3, about 100 kg/m3, about 250 kg/m3, about 375 kg/m3, about 500 kg/m3, about 1,000 kg/m3, about 1,500 kg/m3, about 2,000 kg/m3, about 3,000 kg/m3, about 4,000 kg/m3, about 5,000 kg/m3, or about 6,000 kg/m3. In some embodiments, the molten salt comprises a density of at least about 0 kg/m3, about 100 kg/m3, about 250 kg/m3, about 375 kg/m3, about 500 kg/m3, about 1,000 kg/m3, about 1,500 kg/m3, about 2,000 kg/m3, about 3,000 kg/m3, about 4,000 kg/m3, or about 5,000 kg/m3. In some embodiments, the molten salt comprises a density of at most about 100 kg/m3, about 250 kg/m3, about 375 kg/m3, about 500 kg/m3, about 1,000 kg/m3, about 1,500 kg/m3, about 2,000 kg/m3, about 3,000 kg/m3, about 4,000 kg/m3, about 5,000 kg/m3, or about 6,000 kg/m3.

In some embodiments, the intermediate heat transfer fluid comprises a viscosity of between about 0.01 (centipoise) cP to about 0.1 cP.

In some embodiments, the intermediate heat transfer fluid comprises a viscosity of between about 0 cP to about 1 cP. In some embodiments, the intermediate heat transfer fluid comprises a viscosity of between about 0 cP to about 0.005 cP, about 0 cP to about 0.01 cP, about 0 cP to about 0.015 cP, about 0 cP to about 0.02 cP, about 0 cP to about 0.03 cP, about 0 cP to about 0.05 cP, about 0 cP to about 0.1 cP, about 0 cP to about 0.15 cP, about 0 cP to about 0.2 cP, about 0 cP to about 0.5 cP, about 0 cP to about 1 cP, about 0.005 cP to about 0.01 cP, about 0.005 cP to about 0.015 cP, about 0.005 cP to about 0.02 cP, about 0.005 cP to about 0.03 cP, about 0.005 cP to about 0.05 cP, about 0.005 cP to about 0.1 cP, about 0.005 cP to about 0.15 cP, about 0.005 cP to about 0.2 cP, about 0.005 cP to about 0.5 cP, about 0.005 cP to about 1 cP, about 0.01 cP to about 0.015 cP, about 0.01 cP to about 0.02 cP, about 0.01 cP to about 0.03 cP, about 0.01 cP to about 0.05 cP, about 0.01 cP to about 0.1 cP, about 0.01 cP to about 0.15 cP, about 0.01 cP to about 0.2 cP, about 0.01 cP to about 0.5 cP, about 0.01 cP to about 1 cP, about 0.015 cP to about 0.02 cP, about 0.015 cP to about 0.03 cP, about 0.015 cP to about 0.05 cP, about 0.015 cP to about 0.1 cP, about 0.015 cP to about 0.15 cP, about 0.015 cP to about 0.2 cP, about 0.015 cP to about 0.5 cP, about 0.015 cP to about 1 cP, about 0.02 cP to about 0.03 cP, about 0.02 cP to about 0.05 cP, about 0.02 cP to about 0.1 cP, about 0.02 cP to about 0.15 cP, about 0.02 cP to about 0.2 cP, about 0.02 cP to about 0.5 cP, about 0.02 cP to about 1 cP, about 0.03 cP to about 0.05 cP, about 0.03 cP to about 0.1 cP, about 0.03 cP to about 0.15 cP, about 0.03 cP to about 0.2 cP, about 0.03 cP to about 0.5 cP, about 0.03 cP to about 1 cP, about 0.05 cP to about 0.1 cP, about 0.05 cP to about 0.15 cP, about 0.05 cP to about 0.2 cP, about 0.05 cP to about 0.5 cP, about 0.05 cP to about 1 cP, about 0.1 cP to about 0.15 cP, about 0.1 cP to about 0.2 cP, about 0.1 cP to about 0.5 cP, about 0.1 cP to about 1 cP, about 0.15 cP to about 0.2 cP, about 0.15 cP to about 0.5 cP, about 0.15 cP to about 1 cP, about 0.2 cP to about 0.5 cP, about 0.2 cP to about 1 cP, or about 0.5 cP to about 1 cP. In some embodiments, the intermediate heat transfer fluid comprises a viscosity of about 0 cP, about 0.005 cP, about 0.01 cP, about 0.015 cP, about 0.02 cP, about 0.03 cP, about 0.05 cP, about 0.1 cP, about 0.15 cP, about 0.2 cP, about 0.5 cP, or about 1 cP. In some embodiments, the intermediate heat transfer fluid comprises a viscosity of at least about 0 cP, about 0.005 cP, about 0.01 cP, about 0.015 cP, about 0.02 cP, about 0.03 cP, about 0.05 cP, about 0.1 cP, about 0.15 cP, about 0.2 cP, or about 0.5 cP. In some embodiments, the intermediate heat transfer fluid comprises a viscosity of at most about 0.005 cP, about 0.01 cP, about 0.015 cP, about 0.02 cP, about 0.03 cP, about 0.05 cP, about 0.1 cP, about 0.15 cP, about 0.2 cP, about 0.5 cP, or about 1 cP.

In some embodiments, the molten salt comprises a viscosity of between about 1 cP to about 100 cP.

In some embodiments, the molten salt comprises a viscosity of between about 0 cP to about 500 cP. In some embodiments, the molten salt comprises a viscosity of between about 0 cP to about 1 cP, about 0 cP to about 5 cP, about 0 cP to about 10 cP, about 0 cP to about 20 cP, about 0 cP to about 30 cP, about 0 cP to about 40 cP, about 0 cP to about 50 cP, about 0 cP to about 75 cP, about 0 cP to about 100 cP, about 0 cP to about 250 cP, about 0 cP to about 500 cP, about 1 cP to about 5 cP, about 1 cP to about 10 cP, about 1 cP to about 20 cP, about 1 cP to about 30 cP, about 1 cP to about 40 cP, about 1 cP to about 50 cP, about 1 cP to about 75 cP, about 1 cP to about 100 cP, about 1 cP to about 250 cP, about 1 cP to about 500 cP, about 5 cP to about 10 cP, about 5 cP to about 20 cP, about 5 cP to about 30 cP, about 5 cP to about 40 cP, about 5 cP to about 50 cP, about 5 cP to about 75 cP, about 5 cP to about 100 cP, about 5 cP to about 250 cP, about 5 cP to about 500 cP, about 10 cP to about 20 cP, about 10 cP to about 30 cP, about 10 cP to about 40 cP, about 10 cP to about 50 cP, about 10 cP to about 75 cP, about 10 cP to about 100 cP, about 10 cP to about 250 cP, about 10 cP to about 500 cP, about 20 cP to about 30 cP, about 20 cP to about 40 cP, about 20 cP to about 50 cP, about 20 cP to about 75 cP, about 20 cP to about 100 cP, about 20 cP to about 250 cP, about 20 cP to about 500 cP, about 30 cP to about 40 cP, about 30 cP to about 50 cP, about 30 cP to about 75 cP, about 30 cP to about 100 cP, about 30 cP to about 250 cP, about 30 cP to about 500 cP, about 40 cP to about 50 cP, about 40 cP to about 75 cP, about 40 cP to about 100 cP, about 40 cP to about 250 cP, about 40 cP to about 500 cP, about 50 cP to about 75 cP, about 50 cP to about 100 cP, about 50 cP to about 250 cP, about 50 cP to about 500 cP, about 75 cP to about 100 cP, about 75 cP to about 250 cP, about 75 cP to about 500 cP, about 100 cP to about 250 cP, about 100 cP to about 500 cP, or about 250 cP to about 500 cP. In some embodiments, the molten salt comprises a viscosity of about 0 cP, about 1 cP, about 5 cP, about 10 cP, about 20 cP, about 30 cP, about 40 cP, about 50 cP, about 75 cP, about 100 cP, about 250 cP, or about 500 cP. In some embodiments, the molten salt comprises a viscosity of at least about 0 cP, about 1 cP, about 5 cP, about 10 cP, about 20 cP, about 30 cP, about 40 cP, about 50 cP, about 75 cP, about 100 cP, or about 250 cP. In some embodiments, the molten salt comprises a viscosity of at most about 1 cP, about 5 cP, about 10 cP, about 20 cP, about 30 cP, about 40 cP, about 50 cP, about 75 cP, about 100 cP, about 250 cP, or about 500 cP.

In some embodiments, the molten salt comprises a velocity of between about 0.01 m/s to about 2 m/s.

In some embodiments, the molten salt comprises a velocity between about 0 m/s to about 100 m/s. In some embodiments, the molten salt comprises a velocity between about 0 m/s to about 0.01 m/s, about 0 m/s to about 0.05 m/s, about 0 m/s to about 0.1 m/s, about 0 m/s to about 0.5 m/s, about 0 m/s to about 1 m/s, about 0 m/s to about 2 m/s, about 0 m/s to about 3 m/s, about 0 m/s to about 4 m/s, about 0 m/s to about 5 m/s, about 0 m/s to about 10 m/s, about 0 m/s to about 100 m/s, about 0.01 m/s to about 0.05 m/s, about 0.01 m/s to about 0.1 m/s, about 0.01 m/s to about 0.5 m/s, about 0.01 m/s to about 1 m/s, about 0.01 m/s to about 2 m/s, about 0.01 m/s to about 3 m/s, about 0.01 m/s to about 4 m/s, about 0.01 m/s to about 5 m/s, about 0.01 m/s to about 10 m/s, about 0.01 m/s to about 100 m/s, about 0.05 m/s to about 0.1 m/s, about 0.05 m/s to about 0.5 m/s, about 0.05 m/s to about 1 m/s, about 0.05 m/s to about 2 m/s, about 0.05 m/s to about 3 m/s, about 0.05 m/s to about 4 m/s, about 0.05 m/s to about 5 m/s, about 0.05 m/s to about 10 m/s, about 0.05 m/s to about 100 m/s, about 0.1 m/s to about 0.5 m/s, about 0.1 m/s to about 1 m/s, about 0.1 m/s to about 2 m/s, about 0.1 m/s to about 3 m/s, about 0.1 m/s to about 4 m/s, about 0.1 m/s to about 5 m/s, about 0.1 m/s to about 10 m/s, about 0.1 m/s to about 100 m/s, about 0.5 m/s to about 1 m/s, about 0.5 m/s to about 2 m/s, about 0.5 m/s to about 3 m/s, about 0.5 m/s to about 4 m/s, about 0.5 m/s to about 5 m/s, about 0.5 m/s to about 10 m/s, about 0.5 m/s to about 100 m/s, about 1 m/s to about 2 m/s, about 1 m/s to about 3 m/s, about 1 m/s to about 4 m/s, about 1 m/s to about 5 m/s, about 1 m/s to about 10 m/s, about 1 m/s to about 100 m/s, about 2 m/s to about 3 m/s, about 2 m/s to about 4 m/s, about 2 m/s to about 5 m/s, about 2 m/s to about 10 m/s, about 2 m/s to about 100 m/s, about 3 m/s to about 4 m/s, about 3 m/s to about 5 m/s, about 3 m/s to about 10 m/s, about 3 m/s to about 100 m/s, about 4 m/s to about 5 m/s, about 4 m/s to about 10 m/s, about 4 m/s to about 100 m/s, about 5 m/s to about 10 m/s, about 5 m/s to about 100 m/s, or about 10 m/s to about 100 m/s. In some embodiments, the molten salt comprises a velocity of about 0 m/s, about 0.01 m/s, about 0.05 m/s, about 0.1 m/s, about 0.5 m/s, about 1 m/s, about 2 m/s, about 3 m/s, about 4 m/s, about 5 m/s, about 10 m/s, or about 100 m/s. In some embodiments, the molten salt comprises a velocity between at least about 0 m/s, about 0.01 m/s, about 0.05 m/s, about 0.1 m/s, about 0.5 m/s, about 1 m/s, about 2 m/s, about 3 m/s, about 4 m/s, about 5 m/s, or about 10 m/s. In some embodiments, the molten salt comprises a velocity between at most about 0.01 m/s, about 0.05 m/s, about 0.1 m/s, about 0.5 m/s, about 1 m/s, about 2 m/s, about 3 m/s, about 4 m/s, about 5 m/s, about 10 m/s, or about 100 m/s.

In some embodiments, one or more fluids may comprise a velocity between about 0 m/s to about 100 m/s. In some cases, at least one fluid of the one or more fluids may comprise a first stream (e.g., fluid 1), a second stream (e.g., fluid 2) or a third stream (e.g., fluid 3). In some instances, the fluid may comprise a mixture of one or more of the first stream (e.g., fluid 1), a second stream (e.g., fluid 2) or a third stream (e.g., fluid 3). In some instances, at least one fluid of the one or more fluids may comprise a cold fluid. In some instances, at least one fluid of the one or more fluids may comprise a hot fluid. In some instances, at least one fluid of the one or more fluids may comprise an intermediate heat transfer fluid. In some instances, the fluid may comprise a salt. In some instances, the fluid may comprise saturated water. In some instances, the fluid may comprise saturated steam. In some instances, the fluid may comprise saturated water. In some instances, the fluid may comprise CO₂, steam, or flue gas.

In some embodiments, at least one fluid of the one or more fluids may comprise a velocity between about 0 m/s to about 0.01 m/s, about 0 m/s to about 0.05 m/s, about 0 m/s to about 0.1 m/s, about 0 m/s to about 0.5 m/s, about 0 m/s to about 1 m/s, about 0 m/s to about 2 m/s, about 0 m/s to about 3 m/s, about 0 m/s to about 4 m/s, about 0 m/s to about 5 m/s, about 0 m/s to about 10 m/s, about 0 m/s to about 100 m/s, about 0.01 m/s to about 0.05 m/s, about 0.01 m/s to about 0.1 m/s, about 0.01 m/s to about 0.5 m/s, about 0.01 m/s to about 1 m/s, about 0.01 m/s to about 2 m/s, about 0.01 m/s to about 3 m/s, about 0.01 m/s to about 4 m/s, about 0.01 m/s to about 5 m/s, about 0.01 m/s to about 10 m/s, about 0.01 m/s to about 100 m/s, about 0.05 m/s to about 0.1 m/s, about 0.05 m/s to about 0.5 m/s, about 0.05 m/s to about 1 m/s, about 0.05 m/s to about 2 m/s, about 0.05 m/s to about 3 m/s, about 0.05 m/s to about 4 m/s, about 0.05 m/s to about 5 m/s, about 0.05 m/s to about 10 m/s, about 0.05 m/s to about 100 m/s, about 0.1 m/s to about 0.5 m/s, about 0.1 m/s to about 1 m/s, about 0.1 m/s to about 2 m/s, about 0.1 m/s to about 3 m/s, about 0.1 m/s to about 4 m/s, about 0.1 m/s to about 5 m/s, about 0.1 m/s to about 10 m/s, about 0.1 m/s to about 100 m/s, about 0.5 m/s to about 1 m/s, about 0.5 m/s to about 2 m/s, about 0.5 m/s to about 3 m/s, about 0.5 m/s to about 4 m/s, about 0.5 m/s to about 5 m/s, about 0.5 m/s to about 10 m/s, about 0.5 m/s to about 100 m/s, about 1 m/s to about 2 m/s, about 1 m/s to about 3 m/s, about 1 m/s to about 4 m/s, about 1 m/s to about 5 m/s, about 1 m/s to about 10 m/s, about 1 m/s to about 100 m/s, about 2 m/s to about 3 m/s, about 2 m/s to about 4 m/s, about 2 m/s to about 5 m/s, about 2 m/s to about 10 m/s, about 2 m/s to about 100 m/s, about 3 m/s to about 4 m/s, about 3 m/s to about 5 m/s, about 3 m/s to about 10 m/s, about 3 m/s to about 100 m/s, about 4 m/s to about 5 m/s, about 4 m/s to about 10 m/s, about 4 m/s to about 100 m/s, about 5 m/s to about 10 m/s, about 5 m/s to about 100 m/s, or about 10 m/s to about 100 m/s. In some embodiments, the at least one fluid of the one or more fluids may comprise a velocity of about 0 m/s, about 0.01 m/s, about 0.05 m/s, about 0.1 m/s, about 0.5 m/s, about 1 m/s, about 2 m/s, about 3 m/s, about 4 m/s, about 5 m/s, about 10 m/s, or about 100 m/s. In some embodiments, the molten salt comprises a velocity between at least about 0 m/s, about 0.01 m/s, about 0.05 m/s, about 0.1 m/s, about 0.5 m/s, about 1 m/s, about 2 m/s, about 3 m/s, about 4 m/s, about 5 m/s, or about 10 m/s. In some embodiments, the molten salt comprises a velocity between at most about 0.01 m/s, about 0.05 m/s, about 0.1 m/s, about 0.5 m/s, about 1 m/s, about 2 m/s, about 3 m/s, about 4 m/s, about 5 m/s, about 10 m/s, or about 100 m/s.

The systems, methods, and techniques disclosed herein offer improvements over conventional systems and methods by providing in certain embodiments a plurality of configurations for heat recovery from molten salts. In some embodiments, the systems, methods, and techniques disclosed herein may comprise new systems. In some embodiments, the systems, methods, and techniques disclosed herein may be incorporated into existing systems.

In some cases, the systems, methods, and techniques disclosed herein may be incorporated into systems comprising CO₂ compression trains. In some instances, the CO₂ compression trains may be on sites utilizing molten salts (e.g., including molten borates). In some instances, this incorporation facilitates the creation of supercritical CO₂. For example, this incorporation may facilitate the creation of supercritical CO₂ for pipeline export. In further examples, this incorporation may effectively reduce one of the barriers for using pressurized CO₂ as a heat transfer medium.

In some embodiments, the heat transfer systems described herein may be adapted to use any intermediate heat transfer fluid (IHTFs). In some cases, the IHTF may comprise flue gas. In some instances, the flue gas is characterized by its low-pressure combustion gases and relatively low thermal masses and heat transfer coefficients. In some instances, the heat exchanger duty is high. For example, the IHTF may comprise steam or CO₂. In further examples, these examples illustrate the versatile and adaptable nature of the configurations provided.

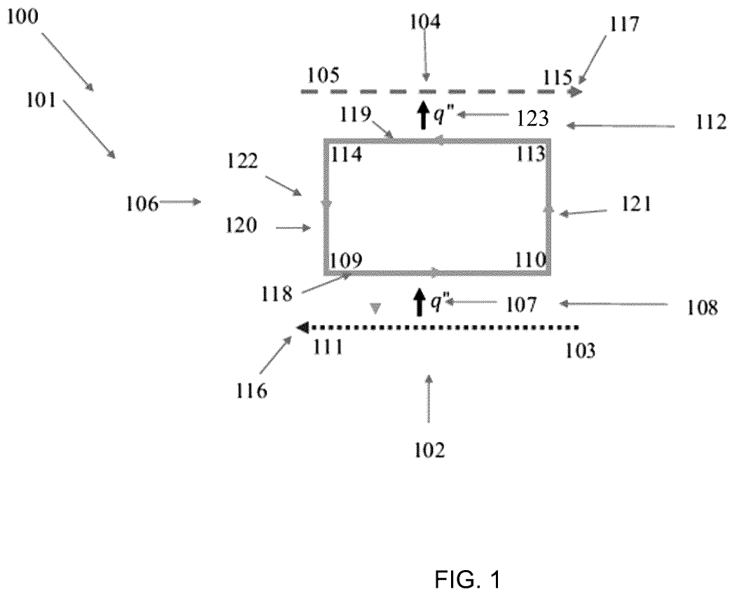

FIG. 1 shows a single stage closed loop configuration for the use of an intermediate heat transfer fluid (e.g., such as fluid 3) to transfer heat from molten borate salts (e.g., such as fluid 1) to a cold fluid (e.g., such as fluid 2), in accordance with some embodiments. 1′ Q symbolizes heat flow in the direction of hot to cold.

In FIG. 1, a heat transfer system (100) is presented. In some embodiments, the heat transfer system (100) may comprise a heat transfer unit (101).

In some cases, the heat transfer unit (101) may comprise a first conduit (102). In some instances, the first conduit (102) may be configured to direct a first stream to the heat transfer unit (101). For example, the first stream may comprise a first temperature at a first conduit inlet (103). In further examples, the first conduit (102) may comprise one or more first conduit inlets (103). In further examples, the first temperature may comprise between about 300° C. to about 1,000° C. In even further examples, the first temperature may comprise between about 200° C. to about 400° C.

In some cases, the heat transfer unit (101) may comprise a second conduit (104). In some instances, the second conduit (104) may be configured to direct a second stream to the heat transfer unit (101). For example, the second stream may comprise a second temperature at second conduit inlet (105). In further examples, second conduit inlet (105) may comprise one or more second conduit inlets (104). In even further examples, the second temperature may comprise between about 100° C. to about 600° C.

In some cases, the heat transfer unit (101) may comprise a third conduit (106). In some instances, the third conduit (106) is configured to receive an intermediate heat transfer fluid (IHTF). For example, the intermediate heat transfer fluid may comprise carbon dioxide (CO₂), steam, flue gas, or a combination thereof.

In some instances, the IHTF may receive a first heat (107) from the first stream. For example, the IHTF may channel at least a part of the first heat (107) to the second stream. In some instances, the IHTF may transfer a first heat to the first stream. For example, the IHTF may direct a portion of the first heat to the first stream.

In some instances, the IHTF may receive a second heat from the second stream. For example, the IHTF may direct a portion of the second heat to the first stream. In some instances, the IHTF may transfer a second heat to the second stream. For example, the IHTF may direct a portion of the second heat to the second stream.

In some instances, the second temperature is less than the first temperature. For example, the second stream at a second conduit inlet (105) may comprise a lower temperature than the first stream at the first conduit inlet (103). In some instances, the second temperature is greater than the first temperature. For example, the second stream at a second conduit inlet (105) may comprise a greater temperature then the first stream at the first conduit inlet (103).

In some cases, the first stream travels in a first direction (116). In some instances, the second stream travels in a second direction (117). For example, the second direction (117) may comprise a direction opposite the first direction (116). In further examples, the second direction (117) may comprise a same direction as the first direction (116).

In further examples, the intermediate heat transfer fluid circulates around the third conduit (106) in a clockwise manner. In other examples, the intermediate heat transfer fluid circulates around the third conduit (106) in a counterclockwise manner.

The heat transfer units (101) provided herein may comprise at least one conduit. In some cases, the at least one conduit may comprise the first conduit (102), the second conduit (104), the third conduit (106), or a combination thereof.

In some embodiments, the at least one conduit may comprise a cross-sectional area comprising a polygonal cross section. In some cases, the polygonal cross section comprises a three-sided polygon (e.g., triangle). In some cases, the polygonal cross section comprises a four-sided polygon (e.g., quadrilateral). In some cases, the polygonal cross section comprises a five-sided polygon (e.g., pentagon). In some cases, the polygonal cross section comprises a six-sided polygon (e.g., hexagon). In some cases, the polygonal cross section comprises an eight-sided polygon (e.g., octagon). In some cases, the polygonal cross section comprises a nine-sided polygon (e.g., nonagon). In some cases, the polygonal cross section comprises a ten-sided polygon (e.g., decagon). In some cases, the polygonal cross section comprises an eleven-sided polygon (e.g., hendecagon). In some cases, the polygonal cross section comprises a twelve-sided polygon (e.g., dodecagon). In some cases, the polygonal cross section comprises a thirteen-sided polygon. In some cases, the polygonal cross section comprises a fourteen-sided polygon. In some cases, the polygonal cross section comprises a fifteen-sided polygon. In some cases, the polygonal cross section comprises a sixteen-sided polygon. In some cases, the polygonal cross section comprises a seventeen-sided polygon. In some cases, the polygonal cross section comprises an eighteen-sided polygon. In some cases, the polygonal cross section comprises a nineteen-sided polygon. In some cases, the polygonal cross section comprises a twenty-sided polygon (e.g., icosagon). In some instances, the assortment of polygonal cross-sections reflects the system's ability to accommodate diverse spatial constraints.

In some embodiments, the at least one conduit may comprise one or more sides. In some embodiments, the at least one conduit may comprise the third conduit (106). In some embodiments, the at least one conduit may comprise the second conduit (104). In some embodiments, the at least one conduit may comprise the first conduit (102).

In some cases, the at least one conduit may comprise one or more sides. In some cases, the at least one conduit may comprise the third conduit (106). In some cases, the third conduit (106) may comprise a first side (118) and a second side (119). In some instances, the first side (118) may be a side opposite the second side (119). For example, the first side (118) may comprise the portion of the third conduit (106) closest to the first conduit (102). In further examples, the second side (119) may comprise a portion of the third conduit (106) closest to the second conduit (104). In some cases, the third conduit (106) may comprise a third side (120) and a fourth side (121). In some instances, the third side (120) may be a side opposite the fourth side (121). For example, the third side (120) may connect the first side (118) to the second side (119). In further examples, the fourth side (121) may connect the first side (118) to the second side (119).

In some embodiments, the at least one conduit may comprise one or more corners. In some embodiments, the at least one conduit may comprise the third conduit (106). In some embodiments, the at least one conduit may comprise the second conduit (104). In some embodiments, the at least one conduit may comprise the first conduit (102).

In some cases, the at least one conduit may comprise the third conduit (106). In some instances, the third conduit (106) may comprise four corners. In some instances, at least one corner of the four corners may define an outlet or inlet of one or more heat transfer zones. In some instances, each corner of the four corners may define an outlet or inlet of one or more heat transfer zones. In some instances, at least one corner may comprise a connection between the one or more sides. In some instances, each corner may comprise a connection between the one or more sides. In some instances, the first corner (114) may comprise a connection between the third side (120) and the first side (118). In some instances, the second corner (109) may comprise a connection between the third side (120) and the first side (118). In some instances, the third corner (110) may comprise a connection between the first side (118) and the fourth side (121). In some instances, the fourth corner (113) may comprise a connection between the fourth side (121) and the second side (119).

The heat transfer system (100) may comprise a plurality of heat transfer zones. In some cases, the heat transfer unit (101) may comprise at least one heat transfer zone of the plurality of heat transfer zones. In some cases, the heat transfer unit (101) may comprise each heat transfer zone of the plurality of heat transfer zones.

In some cases, a heat transfer zone comprises a heat transport space between one or more conduits. In some instances, the plurality of heat transfer zones may comprise about 1, about 2, about 3, about 4, about 5, about 10, about 15, about 20, about 25, about 30, about 35, about 40, about 45, about 50, about 55, about 60, about 65, about 70, about 75, about 80, about 85, about 90, about 95, about 100, or any number in between about 1 to about 100, or more heat transfer zones.

In some embodiments, the first stream travels from a first conduit inlet (103) to a first conduit outlet (111). For instance, the distance between the first conduit inlet (103) to the first conduit outlet (111) may be spanned in a configuration where the first conduit (102) is parallel to the third conduit (106).

In some cases, the heat transfer zone may such as the distance where the first conduit (102) is running parallel to the third conduit (106). In some instances, the parallel configuration may facilitate efficient heat exchange between the conduits. For example, the parallel configuration may facilitate efficient heat exchange between the conduits may comprise a substantially consistent spacing.

In other instances, the first conduit (102) may be arranged in a coiled, serpentine, or spiral pattern around the third conduit (106). For example, this alternative layout may increase the surface area for heat exchange (e.g., improving heat transfer).

In some embodiments, the first conduit (102) may be placed concentrically within or outside the third conduit (106). For example, this arrangement may permit radial heat transfer. In further examples, this arrangement may increase a surface area for heat exchange. In even further examples, this arrangement may increase a surface area for heat exchange by between about 1× to about 100×, any number in between about 1× and about 100×, or greater than 100× (e.g., as compared to heat exchangers where the first conduit (102) is not placed concentrically within or outside the third conduit (106)).

In some cases, the first conduit (102) and the third conduit (106) may intersect perpendicularly. In some cases, the first conduit (102) and the third conduit (106) may intersect at an acute angle in a cross-flow configuration. In some instances, the first conduit (102) and the third conduit (106) may intersect perpendicularly or at an acute angle in a cross-flow arrangement. For example, this arrangement may facilitate heat transfer at the points of intersection.

In some embodiments, the conduits may be arranged in any manner. In some cases, the variety in conduit arrangements provide numerous options to optimize the heat transfer process. In some instances, the conduits may be adapted based on the specific requirements of the system. For example, the diverse configurations may influence factors such as the rate of heat transfer, system size, and cost. In further examples, the diverse configurations offer flexible solutions for a range of applications.

The heat transfer system (100) may comprise a first heat transfer zone (108). In some cases, the heat transfer unit (101) may comprise the first heat transfer zone (108). In some cases, the first heat transfer zone (108) comprises a space where the first conduit (102) and the third conduit (106) are in thermal contact. In some instances, the first heat transfer zone (108) comprises a portion of the third conduit (106). For example, the first heat transfer zone (108) comprises a portion of the third conduit (106) in closest proximity to the first conduit (102). In further examples, the heat transfer unit (101) comprises the portion of the third conduit (106) in closest proximity to the first conduit (102).

In some instances, the first heat transfer zone (108) comprises a portion of the first conduit (102). For example, the first heat transfer zone (108) comprises a portion of the first conduit (102) in closest proximity to the third conduit (106). In further examples, the heat transfer unit (101) comprises the portion of the first conduit (102) in closest proximity to the third conduit (106).

In some instances, the first stream travels from a first conduit inlet (103) to a first conduit outlet (111). For example, a distance between the first conduit inlet (103) to a first conduit outlet (111) may comprise a distance where the first conduit (102) is parallel to the third conduit (106). In further examples, the first heat transfer zone (108) may comprise the distance where the first conduit (102) is parallel to the third conduit (106).

In some instances, the first conduit (102) transfers a first heat (107) to the third conduit (106). In some instances, the first stream releases the first heat (107) at the first heat transfer zone (108). For example, the third stream receives the first heat (107) at the first heat transfer zone (108).

In some instances, the first conduit receives a first heat from the third conduit. In some instances, the third stream releases the first heat at the first heat transfer zone. For example, the first stream receives the first heat at the first heat transfer zone.

In some cases, the second corner (109) may comprise a first heat transfer zone (108) entrance. In some instances, the second corner (109) may comprise a first heat transfer zone (108) entrance for the third conduit (106). In some instances, a portion of the first conduit parallel to the second corner (109) may comprise a first a first heat transfer zone exit (111) for the first conduit (102).

In some instances, the IHTF may comprise a fifth temperature at the second corner (109). In other instances, the IHTF may comprise a fifth temperature before reaching the second corner (109). For example, the intermediate heat transfer fluid may comprise the fifth temperature before entering the first heat transfer zone (108). In further examples, the fifth temperature may comprise between about 100° C. to about 600° C.

In some instances, the first stream may comprise a first temperature at a first conduit first heat transfer zone entrance (103). For example, the first temperature may comprise between about 300° C. to about 1000° C., any temperature in between about 300° C. to about 1000° C. In further examples, the first temperature may comprise greater than about 1000° C. In further examples, the first temperature may comprise less than about 300° C.

In some instances, the first stream may comprise a third temperature at a first conduit first heat transfer zone exit (111). For example, the third temperature may comprise a temperature less than the first temperature. In further examples, the third temperature may comprise between about 100° C. to about 1000° C.

In some cases, the third corner (110) may comprise a first heat transfer zone exit (110). In some instances, the third corner (110) may comprise a first heat transfer zone exit (110) for the third conduit (106). In some instances, a portion of the first conduit (102) parallel to the third corner (110) may comprise a first conduit first heat transfer zone entrance (103).

In some cases, the third stream may comprise a sixth temperature at the third corner (110). In some instances, the intermediate heat transfer fluid may comprise a sixth temperature before exiting the first heat transfer zone (108). In other instances, the intermediate heat transfer fluid may comprise a sixth temperature after exiting the first heat transfer zone (108). For example, the sixth temperature may be higher than the fifth temperature. In further examples, the six temperature may comprise between about 100° C. to about 600° C. In even further examples, the sixth temperature may comprise between about 200° C. to about 600° C. In even further examples, the sixth temperature may comprise less than about 200° C. In even further examples, the sixth temperature may comprise greater than about 600° C.

The heat transfer system (100) may comprise a second heat transfer zone (112). In some cases, the heat transfer unit (101) may comprise the second heat transfer zone (112). In some cases, the second heat transfer zone (112) may comprise a space where the third conduit (106) and the second conduit (104) are in thermal contact. In some instances, the second heat transfer zone (112) comprises a portion of the third conduit (106). For example, the second heat transfer zone (108) comprises a portion of the third conduit (106) in closest proximity to the second conduit (104). In some instances, the second heat transfer zone (112) comprises a portion of the second conduit (104). For example, the second heat transfer zone (112) comprises a portion of the second conduit (104) in closest proximity to the third conduit (106).

In some instances, the second stream travels from a second conduit inlet (105) to a second conduit outlet (115). For example, a distance between the second conduit inlet (105) to the second conduit outlet (115) may comprise a distance where the second conduit (102) is parallel to the third conduit (106). In further examples, the second heat transfer zone (112) may comprise the distance where the second conduit (104) is parallel to the third conduit (106).

In some instances, the third conduit (106) transfers a second heat (123) to the second conduit (104). In some instances, the IHTF stream releases the second heat (123) at the second heat transfer zone (112) For example, the second stream receives the second heat (123) at the second heat transfer zone (112).

In some cases, the fourth corner (113) may comprise a second heat transfer zone (112) entrance. In some instances, the fourth corner (113) may comprise a second heat transfer zone (112) entrance for the third stream in the third conduit (106). In some instances, the third stream may comprise a seventh temperature at the fourth corner (113). In some instances, the third stream may comprise a seventh temperature before reaching the fourth corner (113). For example, the intermediate heat transfer fluid may comprise the seventh temperature before entering the second heat transfer zone (112). In further examples, the intermediate heat transfer fluid may comprise the seventh temperature after entering the second heat transfer zone (112). For example, the seventh temperature may comprise between about 100° C. to about 600° C.

In some cases, the first corner (114) may comprise a second heat transfer zone (112) exit. In some instances, the first corner (114) may comprise a second heat transfer zone (112) exit for the third stream in the third conduit (106). In some instances, the third stream may comprise an eighth temperature at the first corner (114). In other instances, the intermediate heat transfer fluid may comprise the eighth temperature before exiting the second heat transfer zone (112). In some instances, the intermediate heat transfer fluid may comprise the eighth temperature after exiting the second heat transfer zone (112). In further examples, the seventh temperature is greater than the eighth temperature. For example, the eighth temperature may comprise between about 100° C. to about 600° C., or more.

In some cases, the second stream may comprise a second temperature at a second heat transfer zone entrance (105). In some instances, the second temperature may comprise between about 100° C. to about 1000° C. For example, the second stream at the second temperature may comprise saturated water.

In some cases, the second stream may comprise a fourth temperature at a second heat transfer zone exit (115). In some instances, the fourth temperature may be greater than the second temperature. For example, the fourth temperature may comprise between about 100° C. to about 1000° C. In further examples, the second stream at the fourth temperature comprises saturated steam.

In some cases, first stream travels in a first direction (116). In some cases, the second stream travels in a second direction (117). In some instances, the second direction (117) is a direction opposite the first direction (116). In some instances, the second direction (117) is a same direction as the first direction (116). For example, the first direction may comprise left to right, right to left, up and down, down, and up, diagonal, or any combination thereof. In further examples, the first direction (116) and second direction (117) may comprise variations such as clockwise or counterclockwise circular movement, spiraling inwards or outwards, or zigzagging. In further examples, the first direction (116) and second direction (117) may comprise variations such as random directions based on certain conditions or parameters. For example, the first direction (116) and second direction (117) may be determined by environmental factors, preset algorithms, or user inputs. For example, the first direction (116) and second direction (117) may be determined by other interactive elements.

In some embodiments, the first stream may travel in a first direction (116). In some cases, the direction may be influenced by several factors. For example, the direction may be influenced by the design of the system, gravitational forces, fluid properties, or operational parameters. In some cases, the first direction may such as a variety of possibilities such as left to right, right to left, up and down, down and up, or diagonal. In some instances, these directional choices offer versatility in designing and adapting the heat exchange system based on spatial constraints, desired flow characteristics, and heat transfer requirements.

In some cases, the second stream may travel in a second direction (117). In some instances, the second direction, such as the first, is dependent on a variety of considerations that ensure optimal heat exchange and fluid flow within the system. In some instances, the second direction (117) may be opposite to the first direction (116). For example, this configuration, often known as countercurrent or counterflow, has the advantage of maintaining a high temperature difference between the two streams throughout the heat exchange process, potentially leading to more efficient heat transfer. In some embodiments, the second direction (117) may be in the same direction as the first direction (116). In this scenario, known as concurrent or parallel flow, the two streams enter the heat exchanger from the same end and move in the same direction. For example, this configuration may be used when the goal is to bring the two streams to a similar temperature.

In some cases, the IHTF travels in a third direction (122). In some instances, the third direction (122) comprises a clockwise direction. For example, the IHTF may travel around the third conduit (106) in a clockwise direction. In some instances, the third direction (122) comprises a counterclockwise direction. For example, the IHTF may travel around the third conduit (106) in a counterclockwise direction. In some instances, the third direction (122) may comprise a diagonal or angular direction. For example, the IHTF may travel across the third conduit (106) in a diagonal or angular direction. In some cases, the third direction (122) may comprise a zigzag or random path. In further examples, the IHTF may move along the third conduit (106) in a zigzag or unpredictable pattern.

The systems, methods, and techniques disclosed herein offer improvements over conventional systems and methods by providing in certain embodiments the utilize heat transfer units configured to provide multiple heating and cooling stages to further fine tune the temperature difference between the heat stream (e.g., fluid 1) and the IHTF (e.g., fluid 3). In some cases, the IHTF comprises an optimized inlet temperature configured for sequential heating and cooling stages (e.g., via the heat transfer unit) until the full duty is removed from the molten salt.

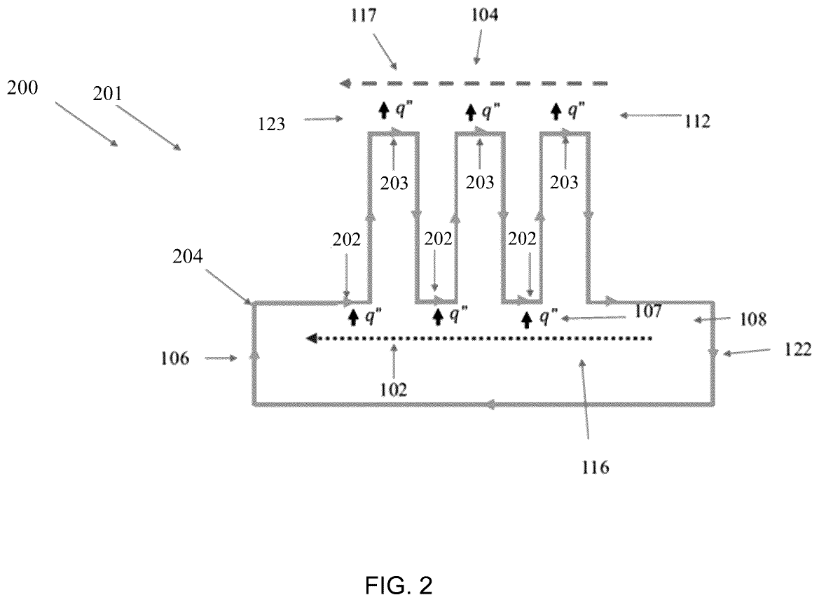

FIG. 2 shows a multistage closed loop configuration for the use of an intermediate heat transfer fluid (e.g., such as fluid 3) to transfer heat from molten borate salts (e.g., such as fluid 1) to a cold fluid (e.g., such as fluid 2), in accordance with some embodiments. 1′ Q symbolizes heat flow in the direction of hot to cold.

In FIG. 2, a heat transfer system (200) is presented. In some embodiments, the heat transfer system (200) may comprise a heat transfer unit (201).

In the example of FIG. 2, the IHTF travels around the third conduit (106) in a clockwise direction (122). Further in FIG. 2, the second stream travels through the second conduit (104) in a second direction (117). Moreover, the second direction (117) comprises right to left direction (117). Further, the first stream travels through the first conduit (102) in a first direction (116). Moreover, the first direction (116) comprises right to left direction (116). Further in FIG. 2, first direction (116) aligns with the second direction (117).

In addition, in FIG. 2, the first conduit (102) is encased by the third conduit (106). Moreover, in FIG. 2, the third conduit comprises a third conduit recirculation section (204). For example, the third conduit recirculation section (204) may comprise a plurality of third conduit sides encasing the first conduit (102). In further examples, the third conduit recirculation section (204) may comprise a plurality of third conduit sides parallel to the first conduit (102).

Furthermore, in some embodiments, the first conduit (102) and the third conduit (106) may be parallel to each other (e.g., creating a side-by-side arrangement). In some cases, the horizontal adjacency may provide an efficient heat transfer path and enhance the operational flexibility of the system. In some instances, the third conduit (106) comprises the recirculation section (204), which may consist of multiple sides that are parallel to and encase the first conduit (102), facilitating optimal heat transfer and fluid movement.

Further, the third conduit recirculation section (204) may comprise one or more proximal positions (202) to the first conduit (102). For example, in FIG. 2, the one or more proximal positions (202) comprises a third conduit section in closest proximity to the first conduit (102). Moreover, the one or more proximal positions (202) may comprise third conduit sections horizontally adjacent to one or more second conduit proximal positions (203). Further, in FIG. 2, the third conduit (106) alternates between a proximal position (202) to the first conduit (102), and a proximal position (203) to the second conduit (104).

In some cases, the alternation of the third conduit (106) between a proximal position to the first conduit (202) and a proximal position to the second conduit (203) maximizes the temperature difference between the intermediate heat transfer fluid and the second stream. In some cases, the temperature difference between the intermediate heat transfer fluid and the second stream ranges from 0° C. to 500° C.

In some cases, the alternation of the third conduit (106) between a proximal position to the first conduit (202) and a proximal position to the second conduit (203) creates a plurality of heat transfer zones. In some instances, the heat transfer unit (201) comprises a plurality of first heat transfer zones (108). For example, the first conduit (102) and third conduit (106) are in thermal contact at the plurality of first conduit proximal positions (202). Moreover, in FIG. 2, as the third conduit (106) encases the first conduit (102) substantially all heat emanated from the first conduit (102) transfers to the third conduit (106). In some instances, the first stream releases the first heat (107) at the plurality of first heat transfer zones (108). For example, the third stream receives the first heat (107) at each of the plurality of first heat transfer zones (108).

In some instances, the first stream receives the first heat at the plurality of first heat transfer zones. For example, the third stream transfers the first heat at each of the plurality of first heat transfer zones.

In some instances, the heat transfer unit (201) comprises a plurality of second heat transfer zones (112). For example, the third conduit (106) and second conduit (104) are in thermal contact at a plurality of second conduit proximal positions (203). In some instances, the third conduit (106) transfers a second heat (123) to the second conduit (104). In some instances, the third stream releases the second heat (123) at the plurality of second heat transfer zones (112). For example, the second stream receives the second heat (123) at each of the plurality of second heat transfer zones (112).

In some cases, the intermediate fluid (e.g., such as fluid 3) is used in one heating and cooling stage. In some cases, the intermediate fluid (e.g., such as fluid 3) is used in more than one heating and cooling stage. In some cases, the intermediate fluid (e.g., such as fluid 3) is used in about 2, about 5, about 10, about 15, about 50, or about 100 heating and cooling stages, or any number in between about 2 to about 100 heating and cooling stages, or greater than about 100 heating and cooling stages.

In one aspect, provided herein is a once-through configuration that utilizes fluids exported from a system as intermediate fluids. In some cases, the once-through configuration may be used alone or in combination with a closed loop configuration. In some instances, the once-through configuration enhances an overall system efficiency and simplifying design considerations. In an aspect, provided herein is a once through configuration utilizing fluids exported from a system as intermediate fluids, avoiding the use of a loop.

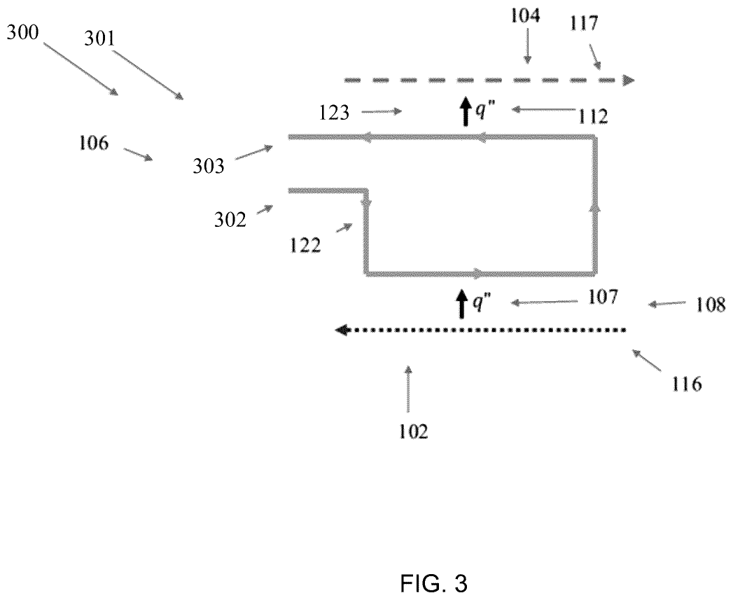

FIG. 3 shows a first single stage once through configurations, for the use of an intermediate heat transfer fluid (e.g., such as fluid 3) to transfer heat from molten borate salts (e.g., such as fluid 1) to a cold fluid (e.g., such as fluid 2), in accordance with some embodiments. 1′ Q symbolizes heat flow in the direction of hot to cold.

In FIG. 3, a heat transfer system (300) is presented. In some embodiments, the heat transfer system (300) may comprise a heat transfer unit (301).

In the example of FIG. 3, the IHTF travels around the third conduit (106) in a clockwise direction (122). Further in FIG. 3, the second stream travels through the second conduit (104) in a second direction (117). Moreover, the second direction (117) comprises a left to right direction (117). Further, the first stream travels through the first conduit (102) in a first direction (116). Moreover, the first direction (116) comprises a right to left direction (116). Further in FIG. 3, the first direction (116) is a direction opposite the second direction (117).

Further in FIG. 3, the third stream enters the third conduit (102) at a third conduit inlet (302). Moreover, the third conduit inlet (102) is positioned in between the first heat transfer zone (108) and the second heat transfer zone (112). Further, the third conduit inlet (302) is positioned more proximally to the second heat transfer zone (112) than the first heat transfer zone (108). In some embodiments, the third conduit inlet (302) is positioned more proximally to the first heat transfer zone (108) than the second heat transfer zone (112).

In some instances, the third conduit inlet (302) is positioned more proximally to the second heat transfer zone (112) than the first heat transfer zone (108). For example, this positioning may help facilitate the direct flow of the third stream towards the second heat transfer zone (112), enhancing the heat exchange efficiency at this zone (e.g., in scenarios where the second heat transfer zone requires higher heat exchange rates).

In some embodiments, the third conduit inlet (302) may be located more proximally to the first heat transfer zone (108) than the second heat transfer zone (112). In some instances, this positioning allows the third stream to interact with the first heat transfer zone (108) first, thereby providing an improved heat transfer rate where it may be necessary (e.g., such as in applications requiring rapid initial heating or cooling).

In some cases, the third conduit inlet (302) may also be centrally positioned between the first and second heat transfer zones (108 and 112 respectively). In some instances, this configuration may ensure an even distribution of the third stream towards both heat transfer zones.

In some instances, the third conduit inlet (302) may be adjustable or movable. For example, this may allow for dynamic positioning based on the real-time heat transfer requirements of the system, providing optimal heat exchange for varying operational scenarios.

In some embodiments, the third conduit (102) may comprise one or more inlets. In some cases, the one or more inlets to the third conduit (102) may be positioned proximally to one or more heat transfer zones. In some instances, the one or more inlets to the third conduit (102) may be positioned proximally to the one or more heat transfer zones may increase a surface area for heat transfer at the one or more heat transfer zones. For example, the surface area for heat transfer may increase by 1× to about 100× or more as compared to heat transfer unit configurations where the inlets to the third conduit (102) are not positioned proximally to one or more heat transfer zones.

In other cases, these various positioning options for the third conduit inlet (302) offer increased flexibility and control over the heat transfer process. In some instances, this adaptability allows for improved performance and efficiency in a wide range of applications.

Further in FIG. 3, the third stream exits the third conduit (102) at a third conduit exit (303). Moreover, the third stream exits the second heat transfer zone (112) via the third conduit exit (303). Further, the third stream is directed away from the heat transfer unit (301). For example, the third stream may travel to a unit separate from the heat transfer unit (301).

In some instances, the third stream may be directed to a storage tank before returning to the heat transfer unit (301). For example, this arrangement allows for storage of the fluid for later use, provides a buffer to manage fluctuations in fluid demand, and may enable conditioning of the fluid (e.g., such as cooling or heating) before it re-enters the heat transfer unit (301).

In some embodiments, the third stream may not return to the heat transfer unit (301) and thus is never recycled. In some instances, this scenario may be applicable when the third stream is either a waste product meant for disposal, or a valuable product intended for further processing or use in another part of the system.

In some cases, the third stream, after leaving the heat transfer unit (301), may be directed to another heat transfer unit for further heating or cooling. In some instances, this configuration may be beneficial when multi-stage heating or cooling is required.

In some instances, the third stream may be directly returned to the heat transfer unit (301) without any storage or additional processing. For example, this may be advantageous in continuous processes where the fluid is continually circulated through the system.

In some embodiments, the third stream may be directed to a purification or separation unit before returning to the heat transfer unit (301). For example, this may occur when third stream accumulates impurities during the heat transfer process that need to be removed.

In other cases, the third stream may be discharged to the environment as exhaust. In some instances, this may occur in scenarios when the third stream contains waste products from the process.

In some cases, the first stream is cooled and directed towards the CO₂ capture stage for further processing. In some instances, directing the first stream towards the CO₂ capture stage mechanism aids in the capture and sequestration of CO₂ (e.g., playing a crucial role in mitigating greenhouse gas emissions).

In some cases, the IHTF is directed to a process that utilizes superheated steam. In some instances, on the operational needs of the process, different stages of the third stream may be mixed with the IHTF. For example, staged mixing allows for precise control over the volume and temperature of the superheated steam, enabling different amounts to be extracted as needed for various processes. In further examples, by this means, the system may efficiently handle and direct different streams, ensuring optimal operation in different stages of the thermal process and offering flexibility and precision in controlling output.

In other instances, these various paths for the third stream after exiting the heat transfer unit (301) provide significant flexibility, allowing the design to be customized according to specific process requirements, environmental considerations, and economic factors.

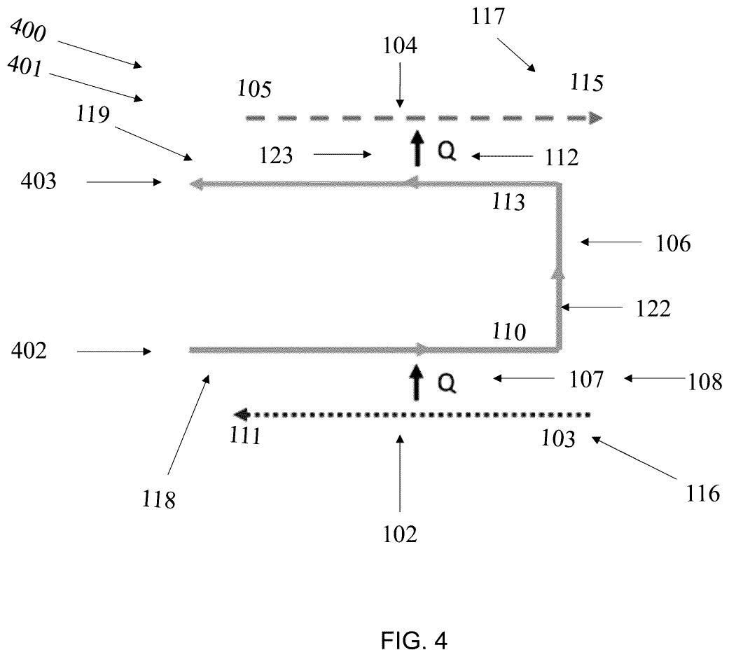

FIG. 4 shows a second single stage once through configurations, for the use of an intermediate heat transfer fluid (e.g., such as fluid 3) to transfer heat from molten borate salts (e.g., such as fluid 1) to a cold fluid (e. g, such as fluid 2), in accordance with some embodiments. 1′ Q symbolizes heat flow in the direction of hot to cold.

In FIG. 4, a heat transfer system (400) is presented. In some embodiments, the heat transfer system (400) may comprise a heat transfer unit (401).

In the example of FIG. 4, the third conduit (106) comprises a third conduit inlet (402), third corner (110), fourth corner (113), and a third conduit outlet (403).

In the example of FIG. 4, the third stream enters the third conduit (106) at a third conduit inlet (402). Further, the third conduit inlet (402) is positioned more proximally to the first conduit (102) than to the second conduit (104).

In FIG. 4, the first heat transfer zone (108) comprises the third conduit first side (118). Further, the third conduit first side (118) is substantially parallel to the first conduit (102). Further, the first heat transfer zone (108) comprises the third conduit inlet (402). For example, the third conduit inlet (402) comprises a third conduit (106) first heat transfer zone (108) entrance. For example, the third conduit inlet (402) is substantially parallel to the first conduit outlet (111). Moreover, the intermediate heat transfer fluid at the third conduit inlet (402) comprises the fifth temperature before receiving the first heat (107) at the first heat transfer zone (108). Further, the first heat transfer zone (108) comprises the third corner (110). For example, the third corner (110) comprises a third conduit (106) first heat transfer zone exit. For example, the third corner (110) is substantially parallel to the first conduit inlet (103). Moreover, the intermediate heat transfer fluid at the third corner (110) comprises the sixth temperature after receiving the first heat (107) at the first heat transfer zone (108).

Further, in FIG. 4, the second heat transfer zone (112) comprises the third conduit second side (119). Further, in FIG. 4, the second heat transfer zone (112) comprises the second conduit (104). For example, the third conduit second side (119) may be in proximity to the second conduit (104). Further, the second heat transfer zone (112) may comprise the third conduit outlet (403). For example, the third conduit outlet (403) comprises a third conduit (106) second heat transfer zone (112) exit. Moreover, the second stream at the second conduit inlet (105) comprises the second temperature before receiving the second heat (123) at the second heat transfer zone (112).

Further, the second heat transfer zone (112) comprises the fourth corner (113). For example, the fourth corner (113) comprises a third conduit (106) second heat transfer zone entrance. Moreover, the intermediate heat transfer fluid at the fourth corner (113) comprises the seventh temperature before releasing the second heat (123) at the second heat transfer zone (112).

In the example of FIG. 4, the third stream exits the third conduit (106) at a third conduit exit (403). Further, the third stream is directed away from the heat transfer unit (401). For example, the third stream may travel to a unit separate from the heat transfer unit (401). In further examples, the third stream is directed to a storage tank prior to returning to the heat transfer unit (401). In other examples, the fourth stream does not return to the heat transfer unit (401) (e.g., is never recycled).

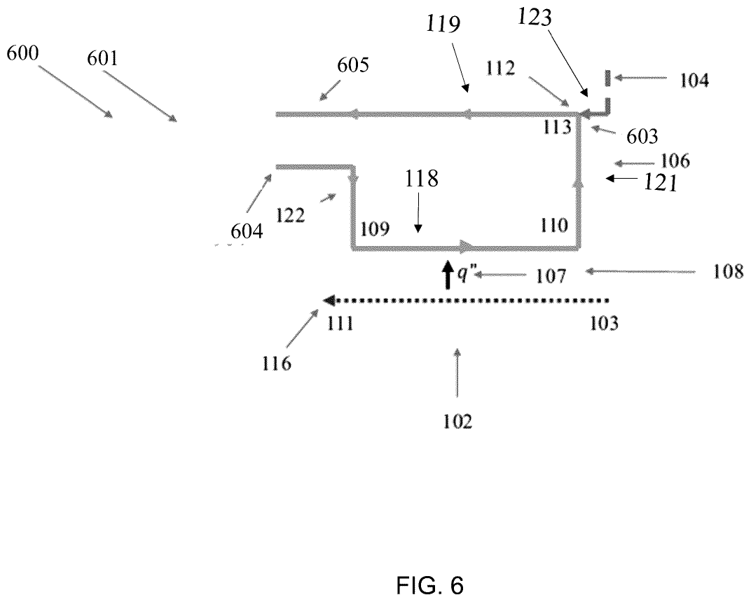

FIG. 6 shows a first single stage once through configurations, whereby Fluid 3 and Fluid 2 are mixed following recovery of the heat from the molten borate salts (Fluid 1), in accordance with some embodiments. 1′ Q symbolizes heat flow in the direction of hot to cold.

In some embodiments, an example of the configuration of FIG. 6 is the injection of saturated water into superheated steam to de-superheat the steam. In some cases, this process effectively moderates the temperature of the steam, ensuring it does not exceed a particular value and thus maintaining system safety and efficiency.

In some cases, a cool gas stream may be introduced into a hot gas stream to control the temperature. In some instances, the cool gas stream may be introduced into a hot gas stream in a combustion processes. For example, the cool gas stream may be introduced into a hot gas stream in a process where the temperature of the exhaust gases needs to be regulated.

In some instances, a cold fluid, into a superheated gas to rapidly cool it. For example, the cold fluid may comprise a cryogenic liquid, such as liquid nitrogen or liquid helium. In further examples, the superheated gas may comprise steam, carbon dioxide, or other industrial process gases.

In some instances, a refrigerant may be injected into a hot fluid in a heat pump or refrigeration system. For example, the refrigerant may comprise substances such as hydrofluorocarbons (HFCs), chlorofluorocarbons (CFCs), or natural refrigerants such as ammonia or carbon dioxide. In further examples, the hot fluid may comprise heated water, heated air, or other thermally elevated fluids used within the system.

In some instances, a catalyst may be introduced into a reaction medium. For example, examples, the catalyst may be configured to control temperature of the reaction medium. In further examples, example, the catalyst may be configured to control the rate of reaction. For example the catalyst may increasing it significantly by lowering the activation energy required for the reaction to proceed.

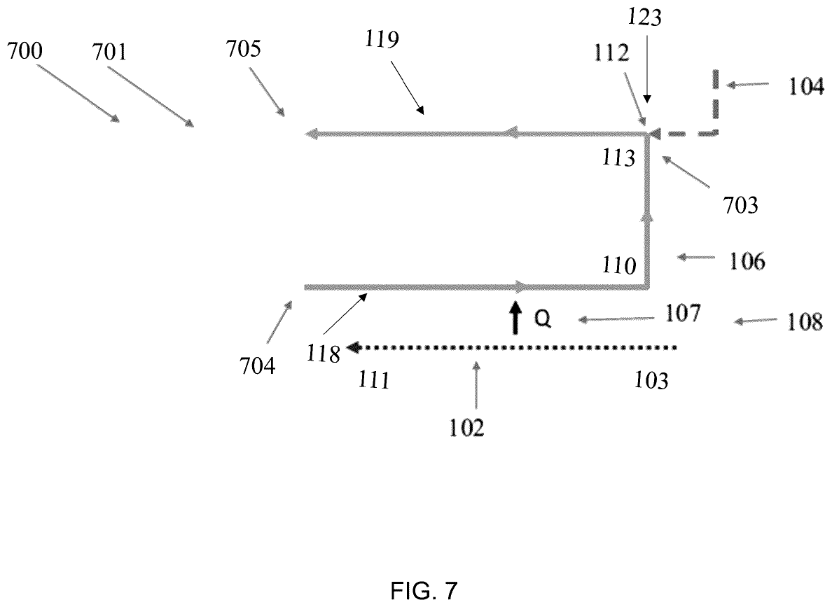

In other instances, these varied examples demonstrate the flexible application of the configuration described in FIG. 6 or FIG. 7. For example, the injection of a second fluid into a first fluid may be configured to regulate temperature and reaction rate.

In FIG. 6, a heat transfer system (600) is presented. In some embodiments, the heat transfer system may comprise a heat transfer unit (601).

In the example of FIG. 6, the third conduit (106) comprises the second corner (109), third corner (110), fourth corner (113), and a third conduit exit (606).

In the example of FIG. 6, the IHTF travels around the third conduit (106) in a clockwise direction (122). In some instances, the third conduit (106) comprises a fluidic communication with the second conduit (104). Further, as shown in FIG. 6, the second conduit (104) and the third conduit (106) are in fluidic communication via one or more connection points (603).

Further, the first stream travels through the first conduit (102) in a first direction (116). Moreover, the first direction (116) comprises a right to left direction (116).

Further in FIG. 6, the third stream enters the third conduit at a third conduit inlet (604). Moreover, the third conduit entrance (604) is positioned in between the first heat transfer zone (108) and the second heat transfer zone (112). Further, the third conduit inlet (604) is positioned more proximally to the second heat transfer zone (112) than the first heat transfer zone (108). In further examples, the third conduit entrance (604) is positioned more proximally to the first heat transfer zone (108) than the second heat transfer zone (112). Furthermore, in FIG. 6, the second heat transfer zone (112) comprises the one or more connection points (603). For example, the second heat transfer zone (112) may comprises one connection point (603).

In some embodiments, the intermediate heat transfer fluid comprises a fifth temperature at a third conduit inlet (604). In some cases, the intermediate heat transfer fluid comprises at the fifth temperature comprises saturated steam. In some instances, the intermediate heat transfer fluid comprises the fifth temperature at the second corner (109). For example, the second corner (109) may comprise a third conduit first heat transfer zone entrance.

In some embodiments, the intermediate heat transfer fluid comprises a sixth temperature at a third corner (110). In some cases, the first stream releases the first heat (107) at the first heat transfer zone (108). In some instances, the third stream receives the first heat (107) at the first heat transfer zone (108). For example, the intermediate heat transfer fluid at the third corner (110) may comprise superheated steam after receiving the first heat (107) at the first heat transfer zone (108). In further examples, the third stream may comprise superheated stream after exiting the first heat transfer zone (108).

In some cases, the first stream receives the first heat at the first heat transfer zone. In some instances, the third stream transfers the first heat at the first heat transfer zone.

In some cases, the third stream travels from a first heat transfer zone (108) to a second heat transfer zone (112). In some instances, the path between the first heat transfer zone (108) to a second heat transfer zone (112) comprises the third conduit fourth side (121).

In some embodiments, the intermediate heat transfer fluid comprises a seventh temperature at a fourth corner (113). In some cases, the second heat transfer zone (112) comprises the one or more connection points (603). In some instances, the one or more connection points (603) comprises one connection point (603). In further examples, the one connection point (603) connects the second conduit (104) to the third conduit (106). Further, the second conduit (104) directs the second stream in a same direction as the third conduit (106) directs the third stream.

Further, in FIG. 6, the second heat transfer zone (112) further comprises the third conduit second side (119). For example, the third conduit second side (119) may be connected to the second conduit (104) via the connection point (603). Further, the second heat transfer zone (112) may comprise the third conduit outlet (605). For example, the third conduit outlet (605) comprises a third conduit (106) second heat transfer zone (112) exit. Moreover, the second stream at the one or more connection points (603) comprises the second temperature before receiving the second heat (123) at the second heat transfer zone (112).

Further, the second heat transfer zone (112) comprises the fourth corner (113). For example, the fourth corner (113) comprises a third conduit (106) second heat transfer zone entrance. For example, the fourth corner (113) is fluidically connected to the second conduit (104) via the connection (603). Moreover, the intermediate heat transfer fluid at the fourth corner (113) comprises the seventh temperature before releasing the second heat (123) at the second heat transfer zone (112).

Moreover, the second stream and the intermediate heat transfer fluid mix at the one or more connection points (603) to create a fourth stream. Further, the fourth stream comprises a second stream-intermediate heat transfer fluid mixture. Further, the fourth stream comprises a ninth temperature. For example, the ninth temperature may comprise a temperature less than the seventh temperature. In further examples, the ninth temperature may comprise a temperature greater than the second temperature.

In the example of FIG. 6, the fourth stream exits the third conduit (106) at a third conduit exit (605). Further, the fourth stream is directed away from the heat transfer unit (601). For example, the fourth stream may travel to a unit separate from the heat transfer unit (601). In further examples, the fourth stream is directed to a storage tank prior to returning to the heat transfer unit (601). In other examples, the fourth stream does not return to the heat transfer unit (601) (e.g., is never recycled).

In some instances, the mixture of the second stream and the intermediate heat transfer fluid may reside within the third conduit (106). In other, the mixture of the second stream and the intermediate heat transfer fluid may reside within the second conduit (104).

FIG. 7 shows a second single stage once through configurations, whereby Fluid 3 and Fluid 2 are mixed following recovery of the heat from the molten borate salts (Fluid 1), in accordance with some embodiments. 1′ Q symbolizes heat flow in the direction of hot to cold.

In some embodiments, an example of the configuration of FIG. 7 is the injection of saturated water into superheated steam to de-superheat the steam.

A heat transfer system (700) is presented (in FIG. 7). In some embodiments, the heat transfer system (700) may comprise a heat transfer unit (701). In the example of FIG. 7, the third conduit (106) comprises a third conduit inlet (704), third corner (110), fourth corner (113), and a third conduit outlet (705). In the example of FIG. 7, the third stream enters the third conduit (106) at a third conduit inlet (704). Further, the third conduit inlet (704) is positioned more proximally to the first conduit (102) than to the second conduit (104).

In FIG. 7, the first heat transfer zone (108) comprises the third conduit first side (118). Further, the third conduit first side (118) is substantially parallel to the first conduit (102). Further, the first heat transfer zone (108) comprises the third conduit inlet (704). For example, the third conduit inlet (704) comprises a third conduit (106) first heat transfer zone (108) entrance. For example, the third conduit inlet (704) is substantially parallel to the first conduit outlet (111). Moreover, the intermediate heat transfer fluid at the third conduit inlet (704) comprises the fifth temperature before receiving the first heat (107) at the first heat transfer zone (108). Further, the first heat transfer zone (108) comprises the third corner (110). For example, the third corner (110) comprises a third conduit (106) first heat transfer zone exit. For example, the third corner (110) is substantially parallel to the first conduit inlet (103). Moreover, the intermediate heat transfer fluid at the third corner (110) comprises the sixth temperature after receiving the first heat (107) at the first heat transfer zone (108).

In FIG. 7, the second heat transfer zone (112) comprises the one or more connection points (703). For example, in FIG. 7, the second heat transfer zone (112) comprises one connection point (703). In further examples, the one connection point (703) connects the second conduit (104) to the third conduit (106). Further, the second conduit (104) directs the second stream in a same direction as the third conduit (106) directs the third stream.

Further, in FIG. 7, the second heat transfer zone (112) further comprises the third conduit second side (119). For example, the third conduit second side (119) may be connected to the second conduit (104) via the connection point (703). Further, the second heat transfer zone (112) may comprise the third conduit outlet (705). For example, the third conduit outlet (705) comprises a third conduit (106) second heat transfer zone (112) exit. Moreover, the second stream at the one or more connection points (703) comprises the second temperature before receiving the second heat (123) at the second heat transfer zone (112).

Further, the second heat transfer zone (112) comprises the fourth corner (113). For example, the fourth corner (113) comprises a third conduit (106) second heat transfer zone entrance. For example, the fourth corner (113) is fluidically connected to the second conduit (104) via the connection (703). Moreover, the intermediate heat transfer fluid at the fourth corner (113) comprises the seventh temperature before releasing the second heat (123) at the second heat transfer zone (112).

Moreover, the second stream and the intermediate heat transfer fluid mix at the one or more connection points (703) to create a fourth stream. Further, the fourth stream comprises a second stream-intermediate heat transfer fluid mixture. Further, the fourth stream comprises a ninth temperature. For example, the ninth temperature may comprise a temperature less than the seventh temperature. In further examples, the ninth temperature may comprise a temperature greater than the second temperature.

In the example of FIG. 7, the fourth stream exits the third conduit (106) at a third conduit exit (705). Further, the fourth stream is directed away from the heat transfer unit (701). For example, the fourth stream may travel to a unit separate from the heat transfer unit (701). In further examples, the fourth stream is directed to a storage tank prior to returning to the heat transfer unit (701). In other examples, the fourth stream does not return to the heat transfer unit (701) (e.g., is never recycled).

The systems, methods, and techniques disclosed herein may be configured to optimize the temperature gradient within the heat exchange process. In some embodiments, the systems, methods, and techniques disclosed herein are configured to optimize the temperature difference within the heat exchange process by utilizing multiple stages of heating and cooling to accomplish the required duty.

In some cases, the systems, methods, and techniques disclosed herein utilizes the use of multiple stages of heating and cooling to complete the required duty (e.g., also improving thermal control and system performance).

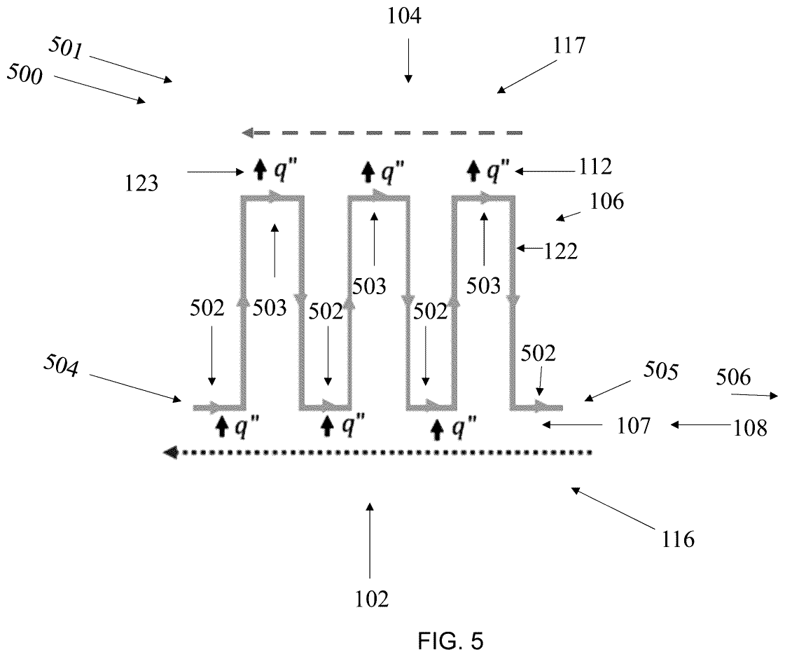

FIG. 5 shows a multistage once through configuration for the use of an intermediate heat transfer fluid (e.g., such as fluid 3) to transfer heat from molten borate salts (e.g., such as fluid 1) to a cold fluid (e.g., such as fluid 2), in accordance with some embodiments. 1′ Q symbolizes heat flow in the direction of hot to cold.

In FIG. 5, a heat transfer system (500) is presented. In some embodiments, the heat transfer system (500) may comprise a heat transfer unit (501).

In some embodiments, the third conduit (106) alternates in position between being proximal to the first conduit (102) at a plurality of locations (502) and proximal to the second conduit (104) at a plurality of locations (503). For example, in FIG. 5, the third conduit (106) is proximal to the first conduit (102) at four locations (502). Moreover, in FIG. 5, the third conduit (106) is proximal to the second conduit (104) at three locations (503).

In some embodiments, the design of the heat transfer unit (501) in FIG. 5 is configured for optimal temperature differences ranging between 0° C. and 500° C., between the IHTF and the second stream.

In some embodiments, the third stream departs from the third conduit exit (505). In some cases, the third stream comprises supercritical CO2, steam, combustion flue gas, or a combination thereof. In some instances, the third stream comprises supercritical CO2, steam, combustion flue gas, or a combination thereof after passing through each of the third conduit locations (503) proximal to the second conduit (104). In some instances, the third stream comprises supercritical CO2, steam, combustion flue gas, or a combination thereof after passing through each of the third conduit locations (502) proximal to the first conduit (104).

In some embodiments, the third conduit exit (505) directs the third stream to a separate path (506), away from the heat transfer unit (501). In some instances, the third stream may travel to a separate unit or a storage tank via the separate path (506). In some instances, the third stream may travel to a separate unit or a storage tank via the separate path (506) prior to returning to the heat transfer unit (501). In some instances, the third stream may not return at all to the heat transfer unit (501).

The heat transfer unit (501) may comprise a plurality of first heat transfer zones (108) where the first conduit (102) and the third conduit (106) are in thermal contact. In some instances, the plurality of first heat transfer zones (108) may comprise the plurality of locations (507).

Moreover, the heat transfer unit (501) may comprise a plurality of second heat transfer zones (112). For example, the plurality of second heat transfer zones may comprise the plurality of locations (503).

In some instances, the IHTF may receive a first heat (107) from the first stream. For example, the IHTF may channel at least a part of the first heat (107) to the second stream. In further examples, the IHTF may receive a plurality of first heat (107) from the first stream at each of the plurality of locations (502). In some instances, the IHTF may receive a second heat (123) from the second stream.

In some instances, the IHTF may transfer a first heat to the first stream. For example, the first stream may channel at least a part of the first heat to the second stream. In further examples, the first stream may receive a plurality of first heat from the IHTF at each of the plurality of locations. In some instances, the IHTF may transfer a second heat to the second stream. In some instances, the IHTF may receive a second heat from the second stream.

In some instances, the third conduit (106) transfers a second heat (123) to the second conduit (104). For example, the IHTF stream may releases the second heat (123) at the second heat transfer zone (112). In further examples, the second stream receives the second heat (123) at the second heat transfer zone (112). In further examples, the second stream may receive the plurality of second heat (123) from the third stream at each of the plurality of locations (503).

In some instances, the second stream comprises saturated water. For example, the second stream may comprise saturated water at a second conduit inlet (105). In further examples, the second stream may comprise saturated water at a second heat transfer zone (112) entrance. In some instances, the second stream receives the second heat (123). For example, the second stream may comprise saturated stream at a second conduit outlet (115). In further examples, the second stream may comprise saturated stream at a second heat transfer zone (112) exit.

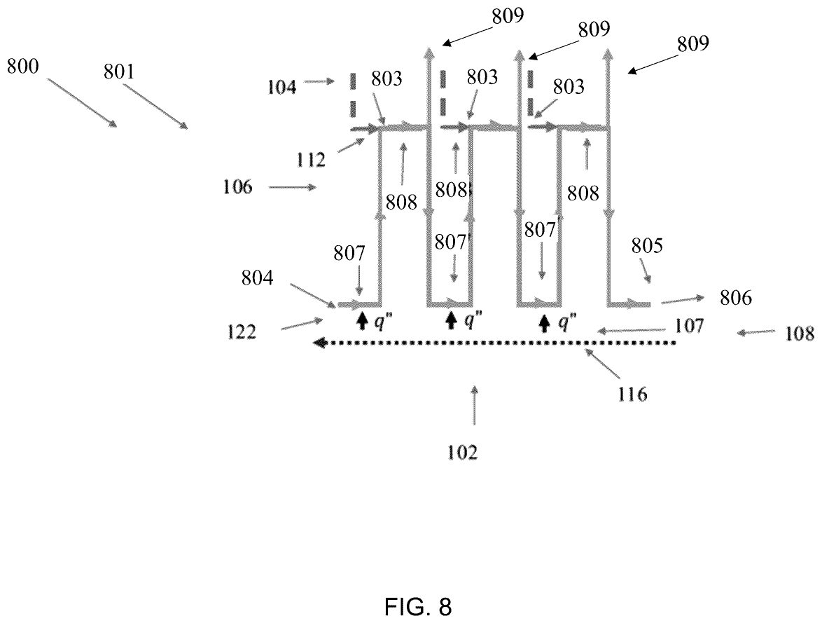

FIG. 8 shows a multistage once through configuration whereby Fluid 3 and Fluid 2 are mixed following recovery of the heat from the molten borate salts (Fluid 1), in accordance with some embodiments.

In some embodiments, an example of the configuration of FIG. 8 is the injection of saturated water into superheated steam to de-superheat the steam. For example, de-superheating the steam may stabilize the temperature of the steam, maintaining safety and operational efficiency.

In another example of the FIG. 8 configuration may comprise the addition of a cooling agent into an overheated chemical reaction to control the chemical reaction rate and prevent thermal runaway (e.g., for exothermic reactions that produce a considerable amount of heat).

In some instances, a further exemplification of the FIG. 8 setup may comprise the injection of a cooler gas into a hot exhaust stream to reduce its temperature. For example, this may be in industries such as power generation or automotive, where the temperature of exhaust gases needs to be controlled to meet environmental regulations.

In some embodiments, a further exemplification of the FIG. 8 setup may comprise the incorporation of a low-temperature coolant into a high-temperature hydraulic fluid system to control the fluid's operating temperature. In some instances, this may increase the longevity of the hydraulic system and maintain its efficiency.

In some instances, injection-based cooling may be applied across numerous fields, optimizing temperature control, improving process safety, and enhancing system efficiency.

In the example of FIG. 8, a heat transfer system (800) is depicted, comprising a heat transfer unit (801). In some embodiments, the IHTF circulates around the third conduit (106) from the third conduit inlet (804) to the third conduit outlet (805) in a third direction (122), from left (804) to right (805). In some cases, the third conduit (106) is in fluidic communication with the second conduit (104) at one or more connection points (803).

Additionally, in FIG. 8, the first stream proceeds through the first conduit (102) in a first direction (116), from right to left. In some cases, the first direction (116) is opposite to the second direction (117).

The third conduit (106) may comprise the one or more connection points (803) to the second conduit (104). In some cases, the one or more connection points (803) permit fluidic communication between the third conduit (106) and the second conduit (104). For example, in FIG. 8, the third conduit comprises three connection points (803). In further examples, the second stream mixes with the third stream at each of the one or more connection points (803).

In some embodiments, the third conduit (106) alternates in position between being proximal to the first conduit (102) at a plurality of locations (807) and proximal to the second conduit (104) at a plurality of locations (808). For example, in FIG. 8, the third conduit (106) is proximal to the first conduit (102) at three locations (807). Moreover, in FIG. 8, the third conduit (106) is proximal to the second conduit (104) at three locations (808). Further, the one or more connections (803) connect the second conduit (104) to the third conduit locations (808) proximal to the second conduit (104).

Further, the second conduit directs the second stream in a same direction (117) as the third conduit directs (122) the third stream.

Further, the configuration in FIG. 8 of the heat transfer unit (801) in FIG. 8 may be configured for optimal temperature differences ranging between 0° C. and 500° C., between the IHTF and the second stream. In some cases, the third stream, departs from the third conduit exit (805). In some instances, the third stream comprises superheated steam. In some instances, the third stream comprises superheated steam after passing through each of the third conduit one or more connection points (803). In some instances, the third stream comprises superheated steam after passing through at least one of the third conduit one or more connection points (803).

In some instances, the third stream comprises superheated steam after receiving at least one first heat (107). For example, the third stream comprises superheated steam after receiving each of the three least first heats (107). In some instances, the third stream comprises superheated steam after departing the first heat transfer zone (108).

In some embodiments, the third conduit exit (805) directs the third stream to a separate path (806). In some cases, the separate path (806) comprises a path away from the heat transfer unit (801). In some instances, the separate path (806) comprises a path away from the third conduit (106). In some instances, the third stream may travel to a separate unit or a storage tank prior to its return to the heat transfer unit (801). In some instances, the third stream may not return at all to the heat transfer unit.

In some embodiments, the heat transfer unit (801) may comprise a plurality of first heat transfer zones (108) where the first conduit (102) and the third conduit (106) are in thermal contact. Moreover, the heat transfer unit (801) may comprise a plurality of second heat transfer zones (112). For example, the plurality of second heat transfer zones (112) may comprise the one or more connections (803). In further examples, the plurality of second heat transfer zones (112) may comprise each of the connections (803). For example, the plurality of second heat transfer zones (102) may comprise three connections (803).

In some embodiments, the second stream combines with the IHTF within the heat transfer unit (801). In some cases, the second stream combines with the IHTF at each of the one or more connections (803). In some instances, the second stream combines with the IHTF in the third conduit (106). In some instances, the second stream combines with the IHTF in the second conduit (104).

In some instances, the second stream combines with the IHTF to form a fourth stream. For example, the fourth stream may comprise a second stream-IHTF mixture. In further examples, the second stream-IHTF mixture may comprise a saturated steam-saturated water mixture. In some configurations, second stream-IHTF mixture is directed to a unit separate from the heat transfer unit (801).

In some embodiments, the heat transfer unit (801) is configured to export or exhaust the first stream, the second stream, or a combination thereof. In some cases, the heat transfer unit (801) is configured to export or exhaust the intermediate heat transfer fluid stream (IHTF). In some cases, the heat transfer unit (801) comprises a plurality of exhaust ports (809). In some instances, the third conduit (106) comprises the plurality of exhaust ports (809). For example, the third conduit (106) may comprise three exhaust ports (809). In further examples, the heat transfer unit (801) may comprise at least one exhaust port for each of the one or more connections (803).

In some embodiments, the heat transfer unit (801) is designed to expel the first stream (805), the second stream, or a combination thereof. In some cases, the heat transfer unit (801) is designed to expel the first stream (805), the intermediate heat transfer fluid stream. Further, the third stream may be directed away from the heat transfer unit (801). For example, the third stream may travel to a unit separate from the heat transfer unit (801). In further examples, the third stream is directed to a storage tank prior to returning to the heat transfer unit (801). In other examples, the third stream does not return to the heat transfer unit (801) (e.g., is never recycled).

In some cases, the heat transfer system (800) is configured to comprises exhausting or exporting the third stream following use in first stream heat recovery at temperatures between about 100° C. and about 600° C.

### Bypass Line

The systems, methods, and techniques disclosed herein offer improvements over conventional systems and methods by providing in certain embodiments the utilize of a bypass line configuration.

In another aspect, provided herein is a process with a bypass line for the hot fluid (e.g., such as fluid 1) to raise the heat transfer coefficient relative to the cold fluid (e.g., such as fluid 2) (effectively using higher velocity molten salt as an intermediate fluid (e.g., such as fluid 3)).

In some cases, when a bypass line is used, changes in velocity may occur without affecting the required duty of the heat exchanger. In the bypass line configuration, high temperature molten borate may be mixed prior to entering the heat exchanger with lower temperature molten borate that has just passed through the heat exchanger. In some instances, an equivalent amount of flow to the high temperature molten borate may be diverted after leaving the heat exchanger to the remaining plant's operations, with the majority of flow being recycled through the heat exchanger. In some cases, the duty of the heat exchanger is set by the temperature and flow of the initial hot salt stream prior to mixing, despite much higher mass flows being present within the heat exchanger itself. In some cases, the increased velocity has the effect of increasing the heat transfer coefficient on the salt side thereby shifting the wall temperature closer to that of the molten borates. In addition, the influence of turbulence and agitation on freezing dynamics may be beneficial in reducing the extent of freezing.

In another aspect, provided herein is a process that such ass a bypass line for the hot fluid (referred to here as Fluid 1). In some cases, the process configuration is designed to augment the heat transfer coefficient in relation to the cold fluid (e.g., such as fluid 2). In some cases, the process configuration effectively uses a higher velocity molten salt as an intermediate fluid (e.g., Fluid 3). In some instances, the process may provide numerous benefits, such as increased heat transfer efficiency and higher operational fluid velocities.

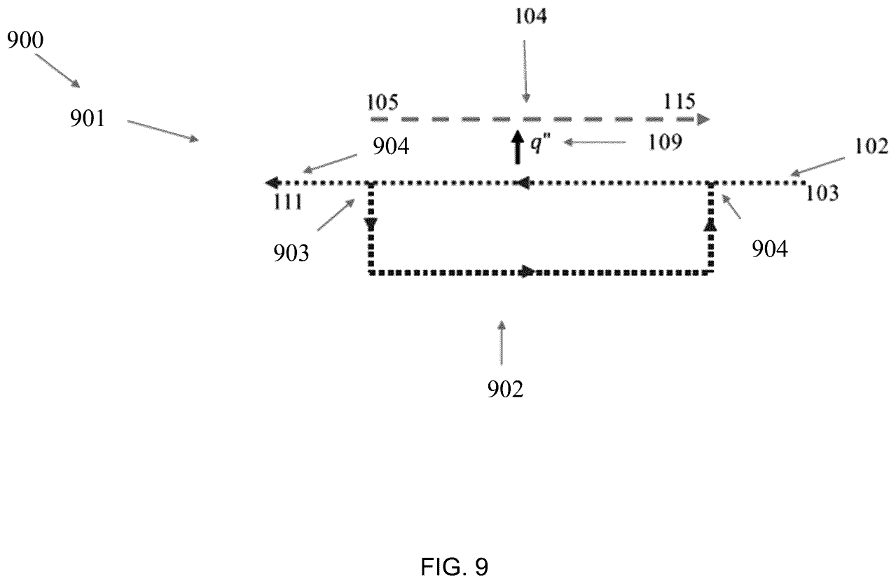

FIG. 9 shows a bypass line configuration where the Fluid 1 velocity through the primary heat exchanger has been increased without altering the duty, in accordance with some embodiments. ↓Q symbolizes heat flow in the direction of hot to cold.

In some embodiments, a heat transfer system may comprise at least one heat transfer unit comprising the configuration in FIG. 9. In some cases, the heat transfer system may comprise at least one heat transfer unit comprising the configuration in FIG. 9 in combination with one or more heat transfer units comprising configurations in any one of FIG. 1-FIG. 8. For example, a heat transfer system may comprise pairing a unit from FIG. 9 with one from FIG. 1, or even combining multiple units from FIG. 2 through FIG. 8. In further examples, the combinations are not strictly limited to the configurations shown in FIG. 1-FIG. 9; any suitable configuration or arrangement of heat transfer units may be utilized.

In FIG. 9, a heat transfer system (900) is presented. In some embodiments, the heat transfer system may comprise a heat transfer unit (901).

In some cases, the heat transfer unit (901) may comprise a first conduit (102) configured to direct a first stream at a first temperature. In some cases, the first stream comprises the first temperature at the first conduit inlet (103). In some instances, the first stream comprises a molten salt.

In some cases, the heat transfer units (901) may comprise a second conduit (104) configured to direct a second stream at a second temperature. In some instances, the second stream comprises the second temperature at a second conduit inlet (105). For example, the second temperature may be less than the first temperature.

In some cases, the heat transfer units (901) may comprise a recycle conduit (902). In some instances, the recycle conduit (902) is fluidically connected to the first conduit (102). For example, the recycle conduit (902) comprises a recycle conduit inlet (903) configured to divert at least a portion of the first stream from the first conduit (102). In further examples, the recycle conduit (902) comprises a recycle conduit outlet (904) configured to return the diverted stream to the first conduit (102). In further examples, the diverted stream comprises a higher temperature when returned to the first conduit (102) than when it was diverted from the first conduit (102). For example, the recycle conduit may receive heat from another unit. In further examples, the recycle conduit may receive heat from a variety of sources.

In some embodiments, heat may be supplied from an external heating system, such as a boiler or furnace. In some cases, this may be beneficial in scenarios where additional heating of the diverted stream is required to meet specific heat transfer requirements.

In some cases, heat may also be supplied from an associated industrial process. In some instances, waste heat from other parts of the facility may be efficiently captured and used to heat the diverted stream, promoting energy efficiency and sustainability within the overall operation.

In some instances, heat may be obtained from renewable energy sources. For example, the renewable energy source may comprise one or more solar thermal collectors, geothermal sources, or heat produced by wind turbines.

In some embodiments, the heat may be received from a co-located power generation plant. In some instances, the waste heat produced by such a plant, typically lost to the environment, may instead be used to heat the diverted stream, boosting the overall energy efficiency of the facility.

In some cases, heat may be provided by an exothermic chemical reaction. For example, in chemical processing facilities, certain reactions release a significant amount of heat that may be harnessed to heat the diverted stream.

In some instances, the examples provided suggest various potential sources for heat input into the recycle conduit. For example, the choice of heat source will depend on factors such as the specific heat requirements of the system, the availability and cost of heat sources, and environmental considerations.

In further examples, the diverted stream comprises a lower temperature when returned to the first conduit (102) than when it was diverted from the first conduit (102). For example, the recycle conduit may provide heat to another unit. In further examples, the recycle conduit may provide heat to a variety of units such as an associated process heating system, a power generation unit, a distillation or evaporation unit, a building or facility's heating system, a heat pump, or a refrigeration or cooling system.

In some cases, the first heat transfer zone (108) comprises a space where the first conduit (102) and the second conduit (104) are in thermal contact. In some instances, the first heat transfer zone (108) comprises a portion of the first conduit (102). For example, the first heat transfer zone (108) comprises a portion of the first conduit (102) in closest proximity to the second conduit (104). In some instances, the first heat transfer zone (108) comprises a portion of the second conduit (104). For example, the first heat transfer zone (108) comprises a portion of the second conduit (104) in closest proximity to the first conduit (102).

In some embodiments, the first conduit (102) is configured to increase a mass flow through the heat transfer unit (901) by up to about 1000× compared to the flow of the first stream entering the heat transfer unit (901). In some cases, the first conduit (102) may be configured to amplify the mass flow through the heat transfer unit (901) by varying degrees, such as about Ox, 50×, 100×, 150×, 200×, 250×, 300×, 350×, 400×, 450×, 500×, 550×, 600×, 650×, 700×, 750×, 800×, 850×, 900×, 950×, up to about 1000× compared to the flow of the first stream entering the heat transfer unit (901).

In some cases, the first stream in the first conduit (102) is configured to raise a heat transfer coefficient relative to the second stream in the second conduit (104). In some instances, the first stream in the first conduit (102) is configured to raise a heat transfer coefficient relative to the second stream in the second conduit (104) by varying degrees such as about 1%, 4%, 7%, 1, 13%, 16%, 19%, 22%, 25%, 28%, 31%, 34%, 37%, 40%, 43%, 46%, 49%, 52%, 55%, 58%, 61%, 64%, 67%, 70%, 73%, 76%, 79%, 82%, 85%, 88%, 91%, 94%, up to about 100%.

In some instances, the velocity of the first stream increases as it moves towards the exit of the first heat transfer zone (108) without altering duty

In some cases, a bypass line for Fluid 1 is used to raise the Fluid 1 mass flow through the heat exchanger. In some instances, the bypass line may raise the Fluid 1 mass flow through the heat exchanger by more than 1.01×, 5×, 10×, 100×, 500×, up to 1000×, compared to the Fluid 1 flow coming into the heat exchanger.

In some embodiments, the first stream and the second stream mix. In some cases, the mixing the first stream and the second stream occurs after a recovery of heat from the intermediate heat transfer fluid. In some cases, a heat transfer coefficient on the second stream (e.g., coolant) is reduced by between about 5 to about 99.9% when compared to direct heat transfer. In some instances, the heat transfer coefficient on the second stream, such as a coolant, may be reduced by varying degrees such as about 5%, 8%, 11%, 14%, 17%, 20%, 23%, 26%, 29%, 32%, 35%, 38%4, 41%, 44%, 47%, 50%, 53%, 56%, 59%, 62%, 65%, 68%, 71%, 74%, 77%, 80%, 83%, 86%, 89%, 92%, 95%, 98%, up to about 99.9% when compared to direct heat transfer.

In some embodiments, a pressure drop through the heat transfer unit comprises less than 25 bar. In some embodiments, the pressure drop through the heat transfer unit may range in 1 bar increments such as less than 1 bar, 2 bar, 3 bar, 4 bar, 5 bar, 6 bar, 7 bar, 8 bar, 9 bar, 10 bar, 11 bar, 12 bar, 13 bar, 14 bar, 15 bar, 16 bar, 17 bar, 18 bar, 19 bar, 20 bar, 21 bar, 22 bar, 23 bar, 24 bar, up to less than 25 bar.

In some embodiments, the steam comprises a sweep gas to drive desorption. In some embodiments, the second stream and the first stream do not make physical contact.

The systems, methods, and techniques disclosed herein offer improvements over conventional systems and methods by providing in certain embodiments systems and methods configured to direct (i) a first stream at a first temperature through a first conduit and (ii) a second stream at a second temperature through a second conduit, wherein the first stream comprises a molten salt, and wherein the second temperature is less than the first temperature; transferring heat from (i) the first stream to the second stream, or (ii) the second stream to the first stream using an intermediate heat transfer fluid in thermal communication with the first stream and the second stream, wherein the intermediate heat transfer fluid comprises carbon dioxide (CO2), steam, or a flue gas, or a combination thereof.

In some cases, the first stream at a first temperature is directed through a first conduit. In some instances, the second stream at a second temperature is directed through a second conduit. In some instances, the first stream comprises a molten salt. In some instances, the second temperature is less than the first temperature. In some instances, heat is transferred from the first stream to the second stream, or from the second stream to the first stream. For example, the transfer may occur through an intermediate heat transfer fluid. In further examples, the intermediate heat transfer fluid is in thermal communication with both the first stream and the second stream. In some instances, the intermediate heat transfer fluid comprises carbon dioxide (CO₂), steam, flue gas, or a combination thereof.

### Molten Salt Streams

The carbon capture system may use a molten salt. The molten salt may comprise a molten borate salt. The borate salt may comprise a formula of AₓB₁₋ₓO_{1.5-x}. In such formulas, “A” refers to an alkali metal, “B” refers to boron, “0” refers to oxygen, and “x” is a value between 0 and 1.

In some embodiments, “x” is a number between 0 and 1. In some embodiments, “x” is about 0.4, 0.45, 0.5, 0.55, 0.6, 0.65, 0.7, 0.75, 0.8, 0.85, 0.9, 0.91, 0.92, 0.93, 0.94, 0.95, 0.96, 0.97, 0.98, or 0.99. In some embodiments, “x” is a number between about 0.25 and about 0.98. In some embodiments, “x” is a number between about 0.3 and about 0.95. In some embodiments, “x” is a number between about 0.5 and about 0.95. In some embodiments, “x” is a number between about 0.6 and about 0.9. In some embodiments “x” is about 0.75.

In some embodiments, “A” comprises alkali metal. An alkali metal may be lithium (Li), sodium (Na), potassium (K), rubidium (Rb), cesium (Cs), or francium (Fr). In some embodiments, “A” is lithium. In some embodiments, “A” is sodium. In some embodiments, “A” is potassium. In some embodiments, “A” is rubidium. In some embodiments, “A” is cesium. In some embodiments, “A” is francium. In some embodiments, “A” may comprise an alkaline earth metal. An alkali earth metal may be beryllium (Be), strontium (Sr), calcium (Ca), magnesium (Mg), barium (Ba), or radium (Ra). In some embodiments, “A” may be any cation comprising a positive charge of +1. In some embodiments, “A” may comprise a transition metal with a +1 charge (e.g., copper, silver, or any other transition metal). In some embodiments “A” may comprise a transition metal. A transition metal may be scandium (Sc), yttrium (Y), lanthanum (La), actinium (Ac), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), manganese (Mn), technetium (Tc), rhenium (Re), bohrium (Bh), iron (Fe), ruthenium (Ru), osmium (Os), hassium (Hs), cobalt (Co), rhodium (Rh), iridium (Ir), meitnerium (Mt), nickel (Ni), palladium (Pd), platinum (Pt), darmstadtium (Ds), copper (Cu), silver (Ag), gold (Au), roentgenium (Rg), zinc (Zn), cadmium (Cd), mercury (Hg), or copernicium (Cn). In some embodiments, the borate salt may comprise a mixture of metals. A may comprise a mixture of alkali metals, alkaline earth metals, transition metals, or any combination thereof. For example the formula for the borate salt may comprise (A¹_{y}A²_{1-y})ₓB_{1.5-x}, where A¹ and A² are each a separate “A” as described herein, “y” is a number between 0 and 1, and “x” is a number between 0 and 1. In some embodiments, a borate salt may comprise a mixture of lithium and sodium. In some embodiments A¹ is lithium and A² is sodium. In some embodiments A¹ is lithium, A² is sodium, y is 0.4, and x is 0.75. In some embodiments A¹ is lithium, A² is sodium, y is 0.5, and x is 0.75. In some embodiments A¹ is lithium, A² is sodium, y is 0.33, and x is 0.75. In some embodiments, the borate salt may comprise a composition of Na_{0.75}B_{0.25}O_{0.75}, (Li_{0.5}Na_{0.5})_{0.75}B_{0.25}O_{0.75}, (Li_{0.4}Na_{0.6})_{0.75}B_{0.25}O_{0.75}, (Li_{0.3}Na_{0.7})_{0.75}B_{0.25}O_{0.75}, (Li_{0.2}Na_{0.8})_{0.75}B_{0.25}O_{0.75}, (Li_{0.1}Na_{0.9})_{0.75}B_{0.25}O_{0.75}, (Li_{0.33}Na_{0.33}K_{0.33})_{0.75}B_{0.25}O_{0.75}, (Li_{0.4}Na_{0.5}K_{0.1})_{0.75}B_{0.25}O_{0.75}, (Li_{0.7}Na_{0.3})_{0.5}B_{0.5}O_{1.0}, (Li_{0.5}Na_{0.5})_{0.83}B_{0.17}O_{0.67}, (Li_{0.7}Na_{0.3})_{0.83}B_{0.17}O_{0.67}, or (Li_{0.3}Na_{0.7})_{0.83}B_{0.17}O_{0.67}.

In some embodiments, a borate salt may comprise an impurity or a contaminant. For example, the impurity may comprise Iron (Fe), Chromium (Cr), Nickel (Ni), Manganese (Mn), Molybdenum (Mo), Cobalt (Co), Vanadium (V), Copper (Cu), Zinc (Zn), Aluminum (Al), Titanium (Ti), Cadmium (Cd), Mercury (Hg), Potassium (K), Magnesium (Mg), Silicon (Si), Phosphorus (P), and Sulfur (S), or any other contaminants. A quantity of an impurity in the borate salt may be at most about 30 weight percent (wt %), 20 wt %, 10 wt %, 5 wt %, 2 wt %, 1 wt %, 0.5 wt %, 0.1 wt %, 0.08 wt %, 0.05 wt %, 0.01 wt %, 0.005 wt %, 0.001 wt %, or less.

In some embodiments, a borate salt comprising the formula A_{0.75}B_{0.25}O_{0.75} may be represented as A₃BO₃. In some embodiments, a borate salt comprising the formula A_{0.5}B_{0.5}O_{1.0} may be represented as ABO₂. In some embodiments, a borate salt comprising the formula A_{0.83}B_{0.17}O_{0.67} may be represented as A₅BO₄.

In some embodiments, the system further comprises an introduction of additives to the first stream configured to alter a thermal property. In some cases, the thermal property comprises heat capacity, density, viscosity, thermal conductivity, or a combination thereof. In some embodiments, the additive comprises a nanoparticle. In some cases, the nanoparticle comprises one or more of graphite, oxides, or carbides. In some embodiments, the intermediate heat transfer fluid comprises a pressure of between about 0.1 bar absolute to about 400 bar absolute. In some cases, the intermediate heat transfer fluid comprises a pressure of about 300 bar absolute. In some embodiments, the molten salt comprises formula AxB1−x O1.5−x. In some embodiments, X is between 0 and 1. In some embodiments, a comprises an alkali metal. In some embodiments, the molten salt comprises formula (Aly A21−y)x B1−x O1.5−x. In some embodiments, the molten salt comprises a formula A3BO3.In some embodiments, the molten salt comprises formula A5BO4. In some embodiments, the molten salt comprises an impurity/contaminant. In some cases, the impurity/contaminant may comprise one or more halides, metal oxides, oxygen containing anions (e.g., nitrates, sulfates, silicates, phosphates).

### Computer Systems

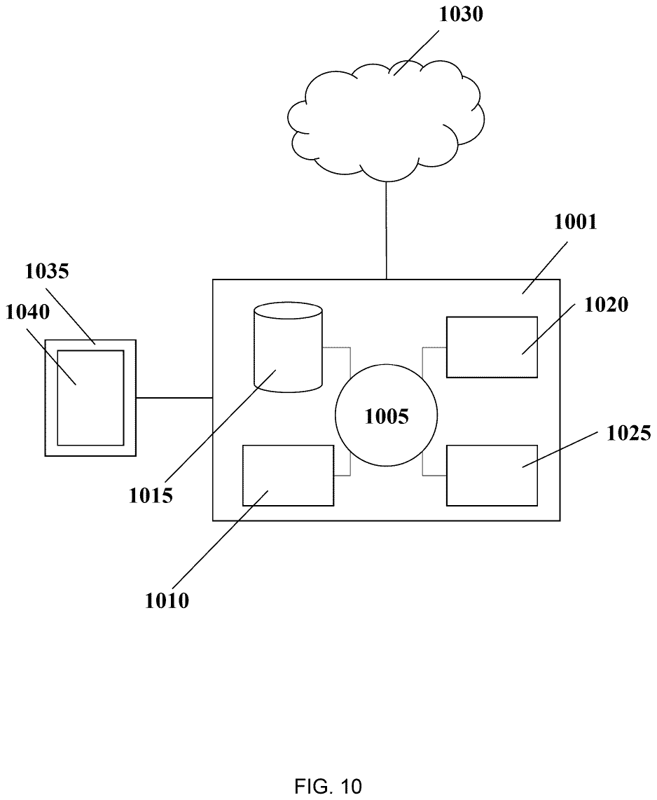

The present disclosure provides computer systems that are programmed to implement methods of the disclosure. FIG. 10 shows a computer system 1001 that is programmed or otherwise configured to regulate and monitor the heat transfer in a heat transfer system as per the given specifications. The computer system 1001 may regulate various aspects of the heat transfer and control operations of the present disclosure, such as, for example, the direction and control of heat flow between the first and second streams via the intermediate heat transfer fluid. The computer system 1001 may be an electronic device of a user or a computer system that is remotely located with respect to the electronic device. The electronic device may be a mobile electronic device.

The computer system 1001 such ass a central processing unit (CPU, also “processor” and “computer processor” herein) 1005, which may be a single core or multi core processor, or a plurality of processors for parallel processing. The computer system 1001 also such ass memory or memory location 1010 (e.g., random-access memory, read-only memory, flash memory), electronic storage unit 1015 (e.g., hard disk), communication interface 1020 (e.g., network adapter) for communicating with one or more other systems, and peripheral devices 1025, such as cache, other memory, data storage and/or electronic display adapters. The memory 1010, storage unit 1015, interface 1020 and peripheral devices 1025 are in communication with the CPU 1005 through a communication bus (solid lines), such as a motherboard. The storage unit 1015 may be a data storage unit (or data repository) for storing data. The computer system 1001 may be operatively coupled to a computer network (“network”) 1030 with the aid of the communication interface 1020. The network 1030 may be the Internet, an internet and/or extranet, or an intranet and/or extranet that is in communication with the Internet. The network 1030 in some cases is a telecommunication and/or data network. The network 1030 may such as one or more computer servers, which may enable distributed computing, such as cloud computing. The network 1030, in some cases with the aid of the computer system 1001, may implement a peer-to-peer network, which may enable devices coupled to the computer system 1001 to behave as a client or a server.

The CPU 1005 may execute a sequence of machine-readable instructions, which may be embodied in a program or software. The instructions may be stored in a memory location, such as the memory 1010. The instructions may be directed to the CPU 1005, which may subsequently program or otherwise configure the CPU 1005 to implement methods of the present disclosure. Examples of operations performed by the CPU 1005 may such as fetch, decode, execute, and writeback.

The CPU 1005 may be part of a circuit, such as an integrated circuit. One or more other components of the system 1001 may be such as in the circuit. In some cases, the circuit is an application specific integrated circuit (ASIC).

The storage unit 1015 may store files, such as drivers, libraries, and saved programs. The storage unit 1015 may store user data, e.g., user preferences and user programs. The computer system 1001 in some cases may such as one or more additional data storage units that are external to the computer system 1001, such as located on a remote server that is in communication with the computer system 1001 through an intranet or the Internet.

The computer system 1001 may communicate with one or more remote computer systems through the network 1030. For instance, the computer system 1001 may communicate with a remote computer system of a user (e.g., an engineer overseeing the operation of the heat transfer system). Examples of remote computer systems such as personal computers (e.g., portable PC), slate or tablet PC's (e.g., Apple®iPad, Samsung® Galaxy Tab), telephones, Smart phones (e.g., Apple®iPhone, Android-enabled device, Blackberry®), or personal digital assistants. The user may access the computer system 1001 via the network 1030.

Methods as described herein may be implemented by way of machine (e.g., computer processor) executable code stored on an electronic storage location of the computer system 1001, such as, for example, on the memory 1010 or electronic storage unit 1015. The machine executable or machine readable code may be provided in the form of software. During use, the code may be executed by the processor 1005. In some cases, the code may be retrieved from the storage unit 1015 and stored on the memory 1010 for ready access by the processor 1005. In some situations, the electronic storage unit 1015 may be precluded, and machine-executable instructions are stored on memory 1010.

The code may be pre-compiled and configured for use with a machine having a processer adapted to execute the code, or may be compiled during runtime. The code may be supplied in a programming language that may be selected to enable the code to execute in a pre-compiled or as-compiled fashion.

Aspects of the systems and methods provided herein, such as the computer system 1001, may be embodied in programming. Various aspects of the technology may be thought of as “products” or “articles of manufacture” typically in the form of machine (or processor) executable code and/or associated data that is carried on or embodied in a type of machine readable medium. Machine-executable code may be stored on an electronic storage unit, such as memory (e.g., read-only memory, random-access memory, flash memory) or a hard disk. “Storage” type media may such as any or all of the tangible memory of the computers, processors, or such as, or associated modules thereof, such as various semiconductor memories, tape drives, disk drives and such as, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements such ass optical, electrical, and electromagnetic waves, such as used across physical interfaces between local devices, through wired and optical landline networks and over various air-links. The physical elements that carry such waves, such as wired or wireless links, optical links, or such as, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media such as, for example, optical or magnetic disks, such as any of the storage devices in any computer(s) or such as, such as may be used to implement the databases, etc. shown in the drawings. Volatile storage media such as dynamic memory, such as main memory of such a computer platform. Tangible transmission media such as coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore such as for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1001 may such as or be in communication with an electronic display 1035 that comprises a user interface (UI) 1040 for providing, for example, real-time temperature readings, flow directions, and other critical data related to the operation of the heat transfer system. Examples of UI's such as, without limitation, a graphical user interface (GUI) and web-based user interface.

Methods and systems of the present disclosure may be implemented by way of one or more algorithms. An algorithm may be implemented by way of software upon execution by the central processing unit 1005. The algorithm may, for example, calculate and adjust the optimal heat flow between the first and second streams by regulating the intermediate heat transfer fluid. It may monitor the temperature variations and make necessary adjustments to ensure efficient heat transfer, ensuring that the system operates within the desired parameters

While certain embodiments have been shown and described herein, it will be obvious to those skilled in the art that such embodiments are provided by way of example only. Numerous variations, changes, and substitutions will now occur to those skilled in the art without departing from the systems and methods described herein. It may be understood that various alternatives to the embodiments described herein may be utilized. It is intended that the following claims define the scope of protection claimed and that methods and structures within the scope of these claims and their equivalents be covered thereby.

1.-79. (canceled)

80. A heat transfer system, comprising:
a heat transfer unit;
a first conduit configured to direct a first stream at a first temperature to said heat transfer unit, wherein said first stream comprises a molten salt;
a second conduit configured to direct a second stream at a second temperature to said heat transfer unit; and
a third conduit configured to receive an intermediate heat transfer fluid, wherein said intermediate heat transfer fluid is configured to: (i) receive a first heat from said first stream and direct at least a portion of said first heat to said second stream, or (ii) receive a second heat from said second stream and direct at least a portion of said second heat to said first stream, and wherein said intermediate heat transfer fluid comprises carbon dioxide (CO₂), steam, or a flue gas, or a combination thereof.

81. The system of claim 80, wherein said molten salt comprises molten borate.

82. The system of claim 80, wherein said first temperature is from about 300° C. to about 1,000° C.

83. The system of claim 80, wherein said second temperature is from about 100° C. to about 600° C.

84. The system of claim 80, wherein said first stream transfers said first heat to said intermediate heat transfer fluid at a first heat transfer zone of said heat transfer unit, wherein in said first heat transfer zone, said first conduit and said third conduit are in thermal contact.

85. The system of claim 84, wherein prior to entering said first heat transfer zone, said intermediate heat transfer fluid is at a third temperature from about 100° C. to about 600° C.

86. The system of claim 80, wherein said second stream comprises saturated water.

87. The system of claim 80, wherein said intermediate heat transfer fluid transfers said first heat to said second stream at a second heat transfer zone of said heat transfer unit, wherein in said second heat transfer zone, said second conduit and said third conduit are in thermal contact.

88. The system of claim 80, wherein said first stream travels in a first direction and said second stream travels in a second direction.

89. The system of claim 88, wherein said second direction is a direction opposite to said first direction.

90. The system of claim 80, wherein said intermediate heat transfer fluid travels around said third conduit in a clockwise or counterclockwise direction.

91. The system of claim 88, wherein said second direction is a same direction as said first direction.

92. The system of claim 80, wherein said third conduit alternates between a proximal position to said first conduit and a proximal position to said second conduit.

93. The system of claim 80, wherein said third conduit alternation between a proximal position to said first conduit and a proximal position to said second conduit optimizes a temperature difference between said intermediate heat transfer fluid and said second stream.

94. The system of claim 93, wherein said temperature difference between said intermediate heat transfer fluid and said second stream is from about 0° C. to about 500° C.

95. The system of claim 80, wherein said second conduit and said third conduit are in fluidic communication via one or more connection points.

96. The system of claim 95, wherein said second stream and said intermediate heat transfer fluid are configured to mix at said one or more connection points to create a second stream-intermediate heat transfer fluid mixture.

97. The system of claim 96, wherein said second stream-intermediate heat transfer fluid mixture comprises a saturated steam-saturated water mixture.

98. The system of claim 80, further comprising an additional heat transfer unit configured to export or exhaust said first steam, said second stream, said third stream, or a combination thereof.

99. The system of claim 80, wherein said second stream and said first stream do not make physical contact.
